(19) United States
(12) Patent Application Publication
(10) Pub. No.: US 2026/0004054 A1
(43) Pub. Date: Jan. 1, 2026

(54) SYSTEM, APPARATUS, NON-TRANSITORY COMPUTER-READABLE MEDIUM, AND METHOD FOR AUTOMATICALLY GENERATING RESPONSES TO REQUESTS FOR INFORMATION USING ARTIFICIAL INTELLIGENCE

(71) Applicant: LTLW, INC., Los Angeles, CA (US)

(72) Inventors: James LEE, La Canada, CA (US); Purvank PATEL, Malden, MA (US)

(73) Assignee: LTLW, INC., Los Angeles, CA (US)

(21) Appl. No.: 19/317,197

(22) Filed: Sep. 3, 2025

Related U.S. Application Data
(63) Continuation of application No. 17/533,130, filed on Nov. 23, 2021, now Pat. No. 12,430,495.
(60) Provisional application No. 63/238,582, filed on Aug. 30, 2021.

(51) Int. Cl. G06F 40/166; G06F 16/332; G06F 16/3332; G06F 40/40

(52) U.S. Cl. CPC G06F 40/166; G06F 16/3322; G06F 16/3335; G06F 40/40

(57) ABSTRACT

A document response production method, the method including: receiving, as input, a document with requests for information, wherein each request for information is a text string; displaying a user interface on the display, the user interface simultaneously displaying a document viewer area, a virtual assistant area, and a text editor area; displaying the received document in the document viewer area; receiving, as input, a selected request for information from among the requests for information; displaying, in the virtual assistant area, one or more automatically selected recommended responses to the selected request for information, and displaying, in the virtual assistant area, one or more other selectable potential responses; based on the selected request for information, automatically generating or suggesting a text string response to the selected request for information; and displaying the text string response in the text editor area.

### CROSS-REFERENCE TO RELATED APPLICATIONS

This application is a continuation of U.S. application Ser. No. 17/533,130, filed Nov. 23, 2021, which is related to provisional application Ser. No. 63/238,582 filed on Aug. 30, 2021, the entire contents of each is incorporated by reference herein.

### BACKGROUND

### Technical Field

The present disclosure relates to information processing devices, systems, and methods, and more specifically to a system, apparatus, non-transitory computer-readable medium, and method for automatically generating responses to requests for information (for example, in a non-limiting embodiment, generating responses to requests for production regarding discovery in a legal matter) using artificial intelligence and machine learning (“AI/ML”) techniques. Current methods for producing responses to legal documents are based on: (1) using templates or (2) locating and obtaining samples of prior responses and then cutting, copying, and pasting those responses or (3) creating document responses from scratch or (4) a combination of any of these or other approaches. This has several drawbacks as the wrong template or exemplar samples could be used for a particular situation, the template or exemplar samples could become outdated without the user knowing, there can be inconsistency among attorneys and staff as there is a lack of uniformity across an organization such as a law firm by people using different templates or exemplar samples. As the user must make modifications to language in the template or exemplar samples to adapt it to the current matter, errors can easily be introduced. Also, as the user is manually changing the template or exemplar samples, it is a time intensive and tedious endeavor. Further, this process several different programs and windows are open at the same time to toggle between the current document being produced, samples of previously existing documents and templates, and other resources needed to complete the document such as webpages or document management systems containing other resource materials. consumes a large amount of computer memory resources and other computer resource as SUMMARY

According to an aspect of the present disclosure, a new information processing device, system, and method is described that includes automatically generating and/or suggesting responses to requests for information (for example, in a non-limiting embodiment, generating responses to requests for production regarding discovery in a legal matter) using artificial intelligence and machine learning (“AI/ML”) techniques. The automatically generated or suggested responses (whether an objection or request for information or answer) are displayed in a user interface and can be edited using a text editor.

A document response production method executing on a computing device including processing circuitry, a display screen, and a non-transitory computer-readable medium storing executable instructions which when executed by the processing circuitry perform the method. The method includes: receiving, as input, a document with a plurality of requests for information, wherein each request for information is a text string; displaying, by the processing circuitry, a user interface on the display screen, the user interface simultaneously displaying a document viewer area, a virtual assistant area, and a text editor area; displaying the received document in the document viewer area; receiving, as input, a selected request for information from among the plurality of requests for information; displaying, in the virtual assistant area, one or more automatically selected recommended responses to the selected request for information, and displaying, in the virtual assistant area, one or more other selectable potential responses; based on the selected request for information, automatically generating a text string response to the selected request for information; and displaying the text string response in the text editor area, wherein the text string response is modifiable by user input.

A non-transitory computer-readable storage medium storing thereon executable instructions which when executed by processing circuitry causes the processing circuitry to perform a document response production method. The document response production method including: receiving, as input, a document with a plurality of requests for information, wherein each request for information is a text string; displaying a user interface on a display screen, the user interface simultaneously displaying a document viewer area, a virtual assistant area, and a text editor area; displaying the received document in the document viewer area; wherein the AI/ML engine has been trained by analyzing a plurality of historical documents with requests for information and corresponding response objections to those requests, receiving, as input, a selected request for information from among the plurality of requests for information; displaying, in the virtual assistant area, one or more automatically selected recommended responses to the selected request for information, and displaying, in the virtual assistant area, one or more other selectable potential responses; based on the selected request for information, automatically generating a text string response to the selected request for information; and displaying the text string response in the text editor area, wherein the text string response is modifiable by user input.

A document response production method, the method including: receiving, as input, a document with a plurality of requests for information, wherein each request for information is a text string; performing data preparation on the document; processing the document with the performed data preparation with an AI and ML engine by breaking down a request for information of the plurality of requests for information into tokens in which each token is a word, wherein the AI and ML engine has been trained by analyzing a plurality of historical documents with requests for information and corresponding response documents with responses to the requests for information; analyzing, by the AI and ML engine, the request for information from the document by applying both a semantic Deep Learning Transformer Based Model and at least one Feature-Based Dimension Machine Learning model; generating a composite similarity score for similarity of the request for information from the document to a request for information in the plurality of historical documents based on the analyzing; and producing a suggested response or responses to the request for information based on a ranked order of similarity scores.

A non-transitory computer-readable storage medium storing thereon executable instructions which when executed by processing circuitry causes the processing circuitry to perform a document response production method. The document response production method including: receiving, as input, a document with a plurality of requests for information, wherein each request for information is a text string; performing data preparation on the document; processing the document with the performed data preparation with an AI and ML engine by breaking down a request for information of the plurality of requests for information into tokens in which each token is a word, wherein the AI and ML engine has been trained by analyzing a plurality of historical documents with requests for information and corresponding response documents with responses to the requests for information; analyzing, by the AI and ML engine, the request for information from the document by applying both a semantic Deep Learning Transformer Based Model and at least one Feature-Based Dimension Machine Learning model; generating a composite similarity score for similarity of the request for information from the document to a request for information in the plurality of historical documents based on the analyzing; and producing a suggested response or responses to the request for information based on a ranked order of similarity scores.

A system for performing production of a response document, including: processing circuitry; and a non-transitory computer-readable storage medium storing thereon executable instructions which when executed by the processing circuitry causes the processing circuitry to: receive, as input, a document with a plurality of requests for information or user initiated data query, wherein each request for information is a text string; perform data preparation on the document; process the document with the performed data preparation with an AI and ML engine by breaking down a request for information of the plurality of requests for information into tokens in which each token is a word, wherein the AI and ML engine has been trained by analyzing a plurality of historical documents with requests for information and corresponding response documents with responses to the requests for information; analyze, by the AI and ML engine, the request for information from the document by applying both a semantic Deep Learning Transformer Based Model and at least one Feature-Based Dimension Machine Learning model; generate a composite similarity score for similarity of the request for information from the document to a request for information in the plurality of historical documents based on the analyzing; and produce a suggested response or responses to the request for information based on a ranked order of similarity scores.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1AA-1F illustrate a graphical user interface in accordance with exemplary embodiments.

FIGS. 2AA-2GB illustrate a graphical user interface in accordance with exemplary embodiments.

FIGS. 3A-3K illustrate a flow diagram illustrating a document response production method in accordance with exemplary embodiments.

FIG. 4 is a diagram illustrating different parts of a graphical user interface in accordance with exemplary embodiments.

FIGS. 5A-5I illustrate computation of similarity scores in accordance with exemplary embodiments.

FIGS. 6A-6H illustrate computation of similarity scores in accordance with exemplary embodiments.

FIGS. 7A-7I illustrate computation of similarity scores in accordance with exemplary embodiments.

FIGS. 8A-8J illustrate computation of similarity scores in accordance with exemplary embodiments.

FIGS. 9A-9G illustrate computation of similarity scores in accordance with exemplary embodiments.

FIGS. 10A-10I illustrate computation of similarity scores in accordance with exemplary embodiments.

FIG. 11 is a flow diagram illustrating a document response production method in accordance with exemplary embodiments.

FIG. 12 is a flow diagram illustrating a document response production method in accordance with exemplary embodiments.

FIG. 13 is a block diagram of a computer-based system on which embodiments of the present system may be implemented.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The methods and systems described herein may be implemented using computer programming or engineering techniques including computer software, firmware, hardware or any combination or subset thereof.

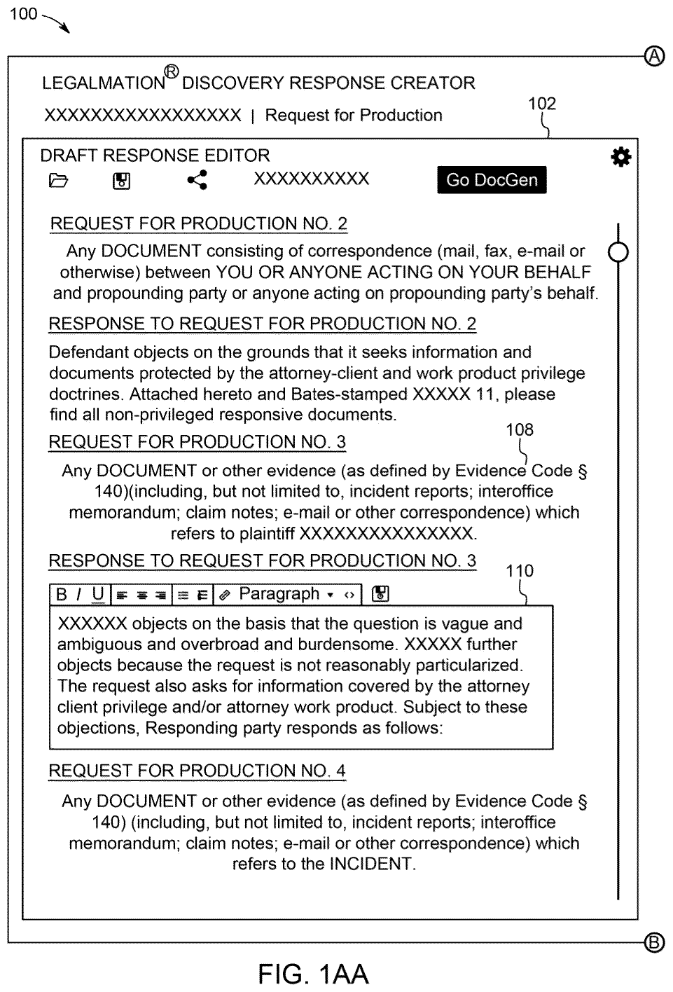

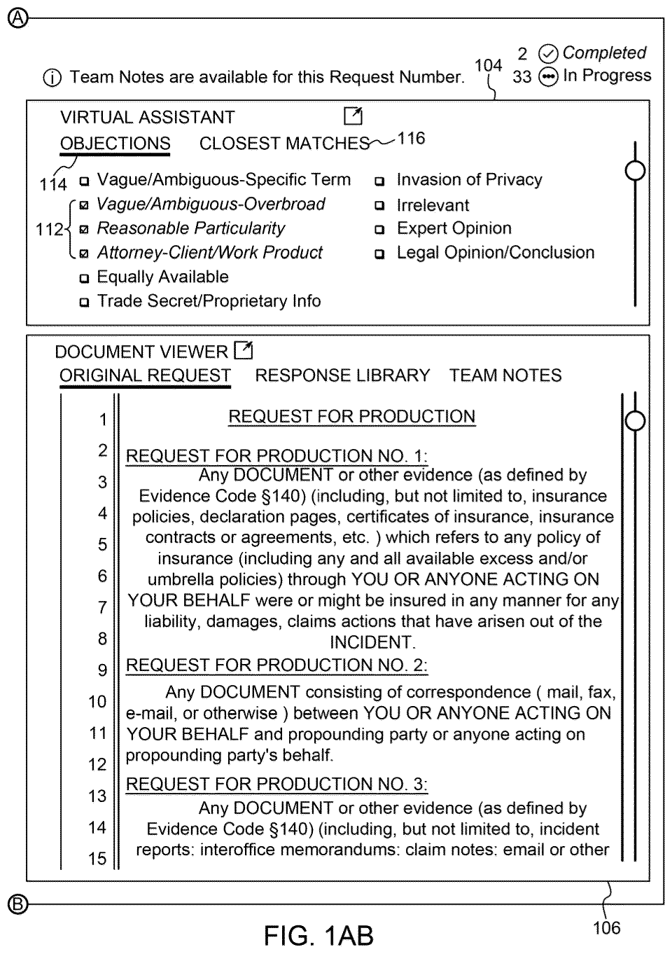

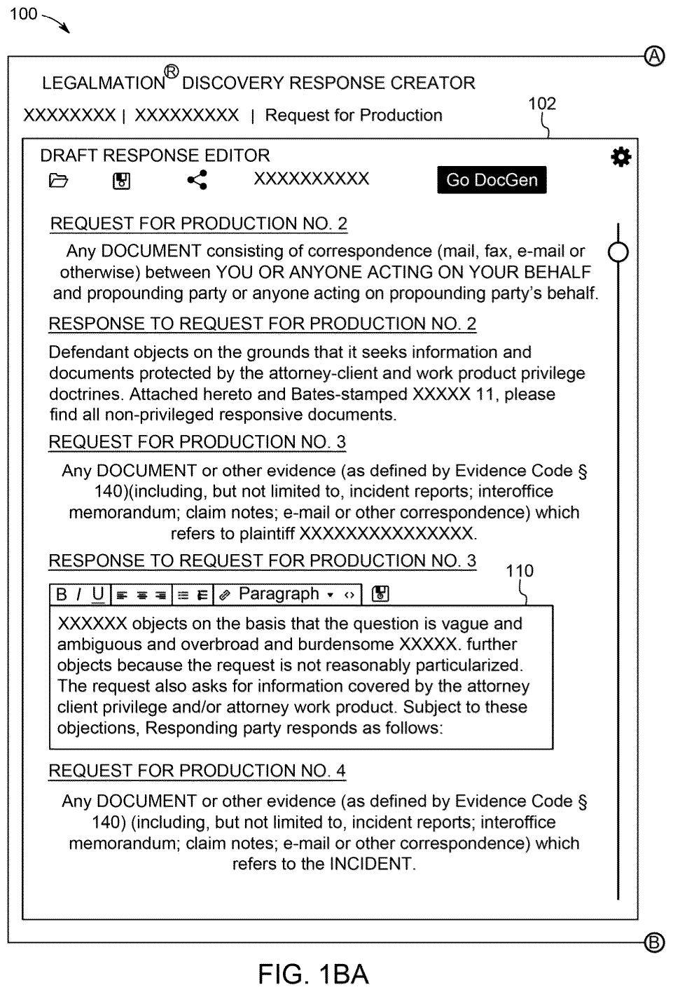

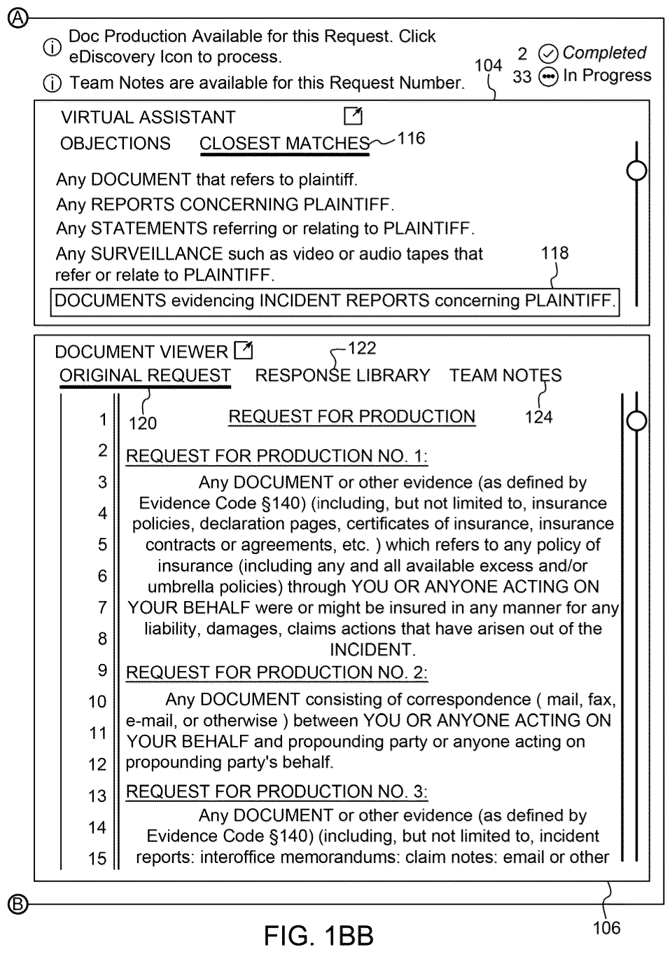

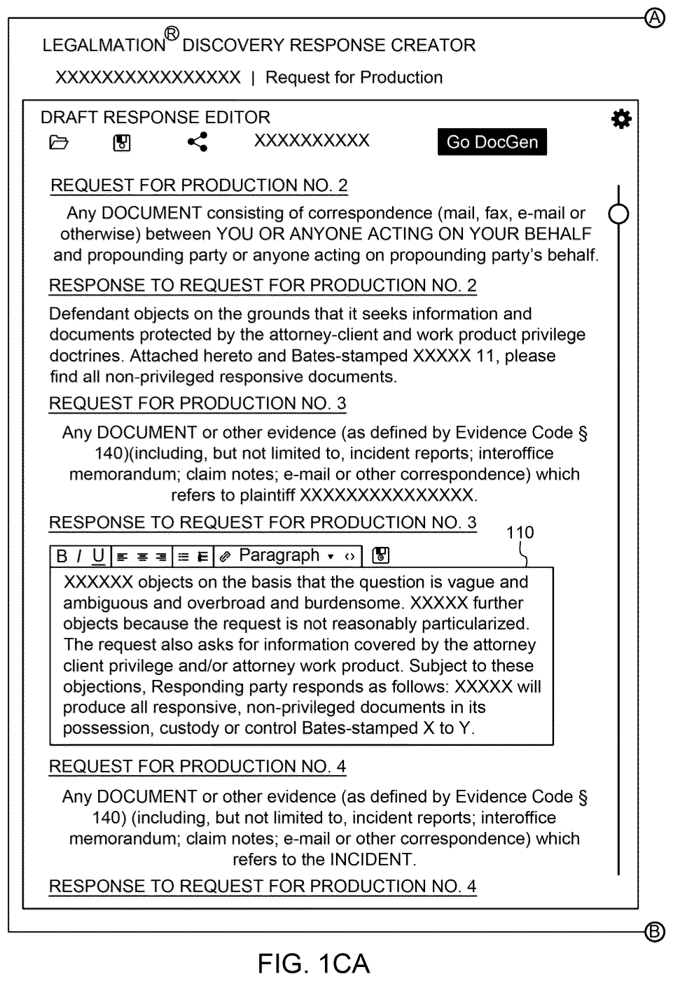

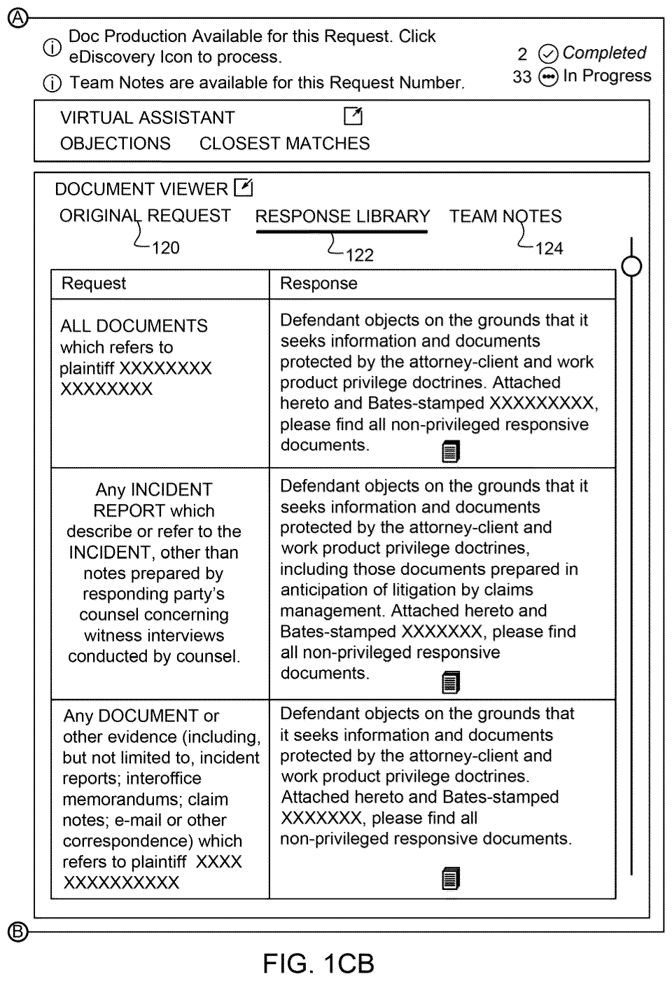

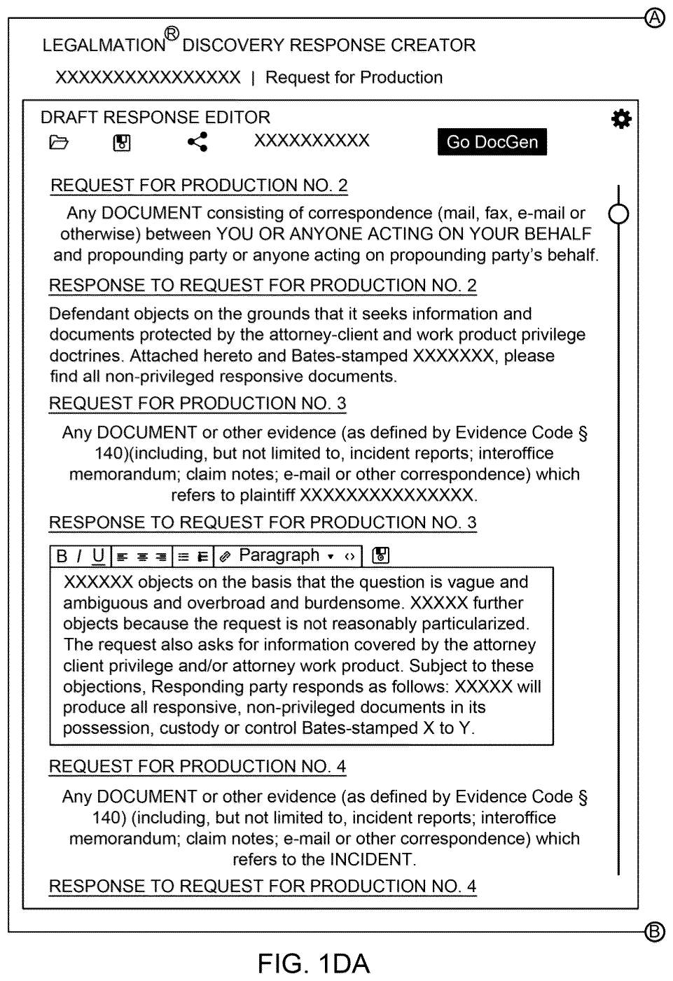

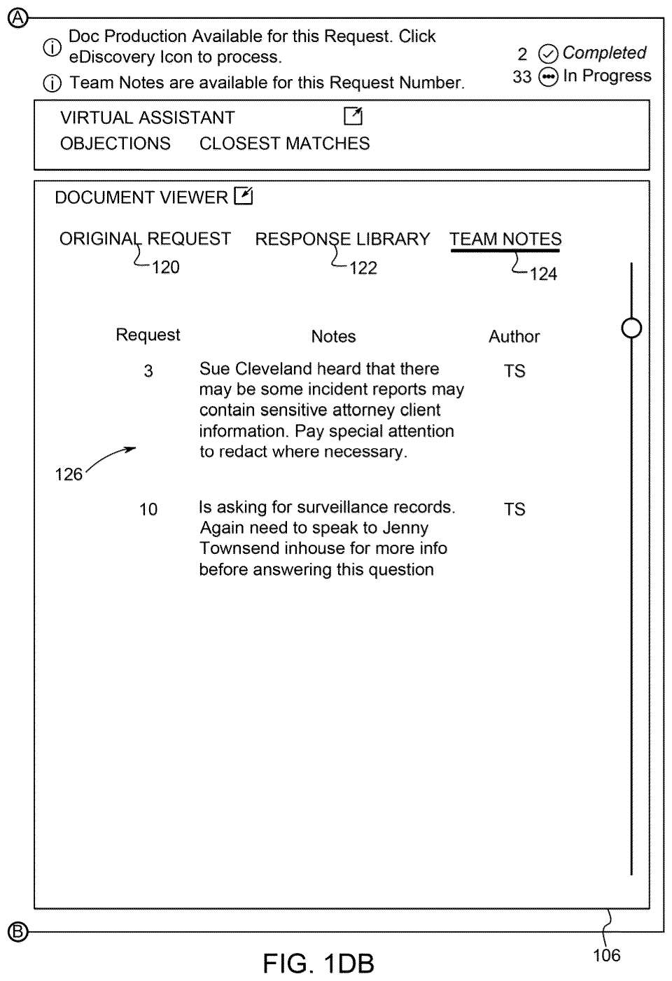

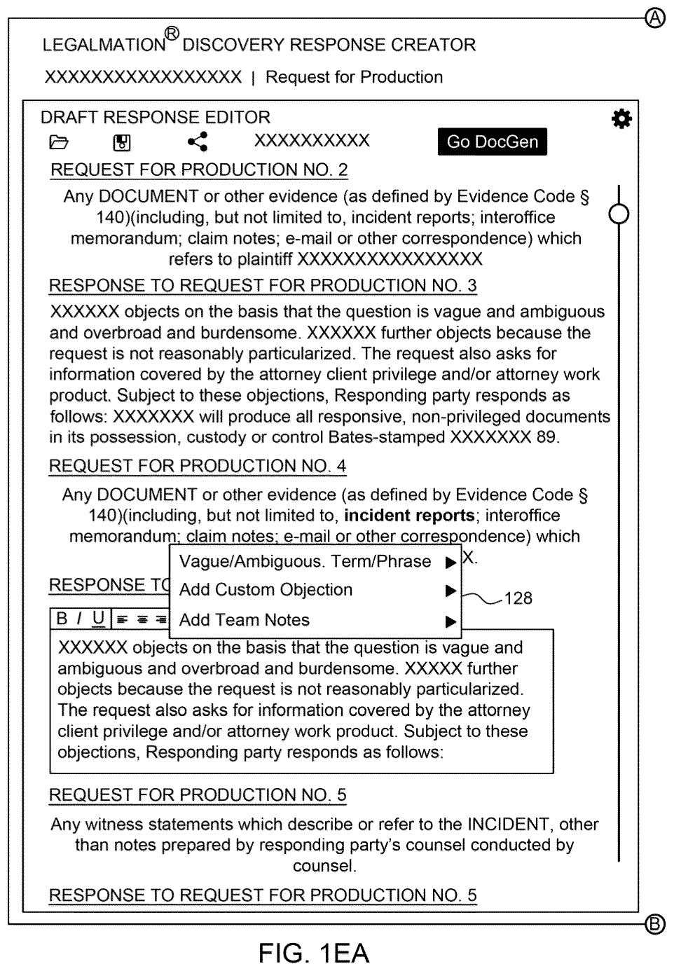

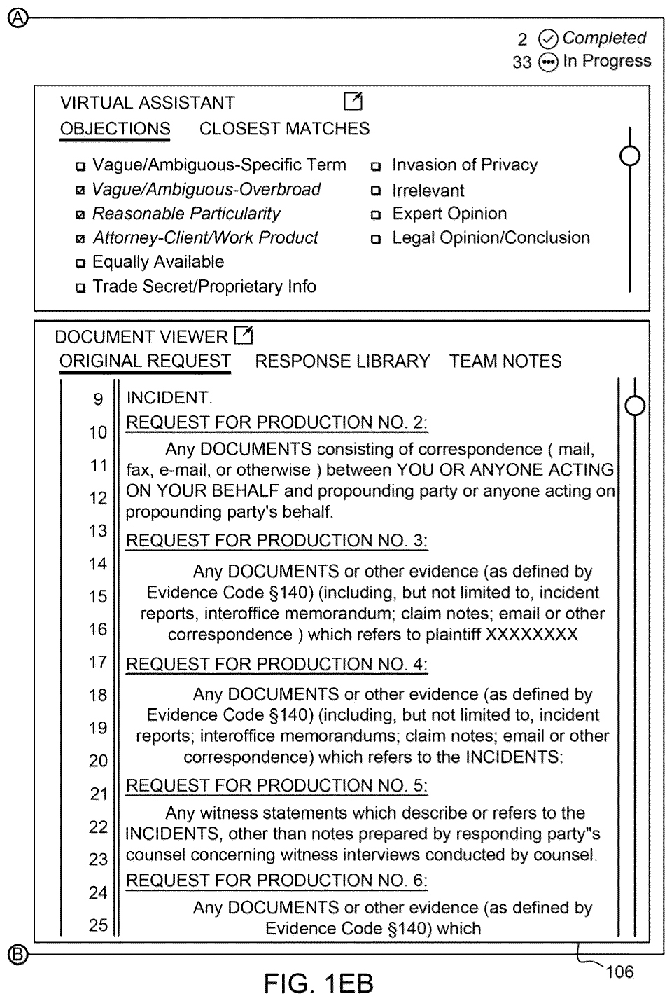

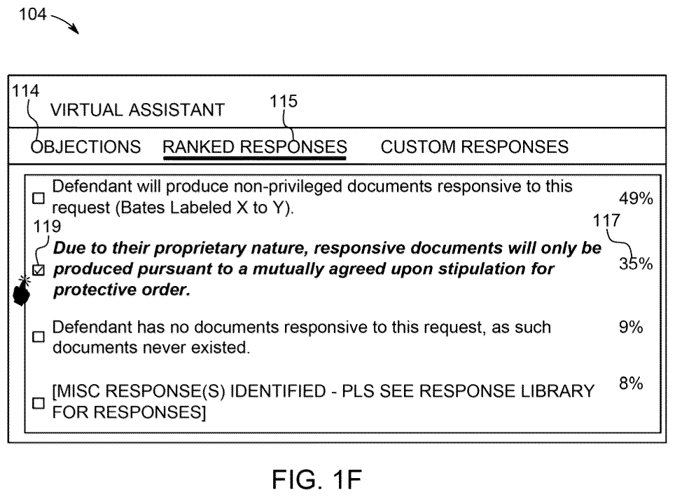

FIGS. 1AA-1F illustrate a graphical user interface (GUI) 100 in accordance with exemplary embodiments. The GUI 100 is used for a document response production method executing on a computing device (e.g., computer 805) including processing circuitry (e.g., processor 835), a display screen (e.g., display 870), and a non-transitory computer-readable medium (e.g., memory 840, non-volatile storage 845, etc.) storing executable instructions (e.g., computer program 848) which when executed by the processing circuitry perform the method. In an exemplary embodiment, the document is a request for production, subpoena, an interrogatory, a demand letter, or a complaint for a legal proceeding. However, the document is not limited to these examples and could be another legal document or a non-legal document. The GUI 100 is first used to upload the document (e.g., discovery request, etc.). After the steps described in detail below are performed, the GUI 100 will facilitate the automatic creation of a response document that replies to the document that was uploaded. For example, if the document that is uploaded is an interrogatory, the document that is automatically produced using the GUI 100 is a response to the interrogatory.

Before the document is uploaded, the jurisdiction of the legal proceeding is selected (e.g., California, etc.), and the document is uploaded, for example, by dragging and dropping the file into a box displayed by the GUI 100 or by browsing the computer files on the computing device. After the document is uploaded, the practice area is selected (e.g., employment, personal injury, etc.). Alternatively, the jurisdiction and practice area could be determined by the following AI/ML process. The document is then processed by various software engines (including using artificial intelligence and machine learning (“AI/ML”) engine that will be discussed in further detail below). After the document is processed, a verification page is displayed by the GUI (100) in which the user can verify various fields that are automatically populated based on information in the document such as, for example, Matter ID, jurisdiction, plaintiff name(s), defendant name(s), parties, law firm information, opposing counsel information, attorney information, etc.

After the fields have been verified, the screen shown in FIGS. 1AA-1AB is displayed. FIG. 1AA shows the left side of the screen, and FIG. 1AB shows the right side of the same screen. This applies to several of the following figures, such as FIGS. 1BA and 1BB. On this screen, the user is prompted to fill out responses and objections to each individual request that was detected by the system. On this page, there are three main sections/areas of the GUI 100: a document viewer area 106, a virtual assistant area 104, and a text editor area 102. The document viewer area 106 is where a user can review the document uploaded via an “Original Request” tab 120, as well as a response library 122 and team notes 124. At the top right of the screen, an “In Progress” counter is displayed that shows the user how many requests they have responded to, as well as how many requests the user is still in the process of responding to. Clicking on any of the requests for production (e.g., Request for Production No. 3, 108) or in the edit box beneath each request, within the text editor area 102 will open that request and allow you to generate and edit a response to it in the text box 110. The user can enter the response text manually, or they can use the virtual assistant in the virtual assistant area 104 to automatically enter suggested objections 112 for this response. As an example, in FIG. 1AA, Request for Production No. 3 is a request for “Any DOCUMENT or other evidence (as defined by Evidence Code § 140) (including, but not limited to, incident reports; interoffice memorandum; claim notes; e-mail or other correspondence) which refers to plaintiff.”

The virtual assistant area 104 includes an “Objections” tab 114 and a “Closest Matches” tab 116. Under the “Objections” tab 114 of the virtual assistant area 104, the AI/ML engine will suggest which objections could be included for the request the user is currently working on, based on its interpretation of the original request text. These suggestions are highlighted (for example, in green) and checked automatically. However, the user can uncheck or check any objections that they deem applicable. As the objections are checked, the standard corresponding text will automatically appear in the text box 110 for the response that the user is currently editing. In FIG. 1AB, the suggested objections are “Vague/Ambiguous-Overbroad,”

“Reasonable Particularity,” and “Attorney-Client/Work Product.” The standard corresponding text for these three suggested objections states “CLIENT NAME objects on the basis that the question is vague and ambiguous and overbroad and burdensome. CLIENT NAME further objects because the request is not reasonably particularized. The request also asks for information covered by the attorney client privilege and/or attorney work product. Subject to these objections, Responding party responds as follows:.”

In FIGS. 1BA-1BB, in addition to these standard objections, the system will also suggest a number of requests that it has determined may be similar to the one the user is currently working on under the “Closest Matches” tab 116. Selecting one of these options 118 will add response text modelled on the response text the user's law firm has previously used for the closest-matching request that is selected by the user. In an exemplary embodiment, as shown in FIG. 1F, a “Ranked Responses” tab 115 can be displayed next to the “Objections” tab 114, and when the user clicks on this tab, a percentage 117 is displayed next a corresponding suggested response. The percentage can indicate the amount of the time the particular response is selected based on an analysis of the historical responses to similar request types. A response is selected by the user selecting the check box 119 next to the response. In FIG. 1CB, under the “Response Library” tab 122 of the Document Viewer section, the user can view all closest matching requests and their respective responses that pertain to the request currently being worked on. This allows the user to view all closest matching requests, suggested by the AI/ML engine, in one place without having to select each individually. If preferred, the user can also copy the response text from this section, and paste it into the text box 110, rather than generating an AI/ML response. A user can also insert any custom responses that they have created by selecting a “Custom Responses” tab that can be displayed next to the “Closest Matches” tab 116.

Once the user has finished adding and editing the responses that they wish to include for the request they are working on, the text is saved by clicking the “save response” button to the top right of the text box 110. This will save the selected response as “Completed,” and automatically move the user to the next request (e.g., “Request for Production No. 4”). The user can also add a “team note” 126 to each response by clicking on the “Team Notes” tab 124. This will open a pop-up window where the user can notate the selected response. See FIG. 1DB. In FIG. 1EA, words in the request are highlighted (“incident report”) and a shortcut menu 128 is displayed that allows the user to perform various functions such as add custom objection, and add team notes. Once the user has entered text and saved each individual response, a “GO” button at the bottom of the GUI 100 will turn orange, and the user will be able to click on it to generate their output (response document).

In an exemplary embodiment, the document response production method includes receiving, as input, a document with a plurality of requests for information, wherein each request for information is a text string. As seen in FIGS. 1AA-1AB, the text string is a plurality of words, numbers, symbols, etc. in one or more sentences. The graphical user interface 100 is displayed on the display screen by the processing circuitry. As seen in FIGS. 1AA-1AB, the graphical user interface 100 simultaneously displays the document viewer area 106, the virtual assistant area 104, and the text editor area 102 on one display screen. The received document is displayed in the document viewer area 106. The method also includes receiving, as input, a selected request for information from among the plurality of requests for information (e.g., “Request for Production No. 3”). The method also includes displaying, in the virtual assistant area 104, one or more automatically selected recommended grounds for objection to the selected request for information (e.g., the three highlighted objections 112 in FIG. 1AB), and displaying, in the virtual assistant area 104, one or more other selectable potential grounds for objection (the other listed objection in FIG. 1AB that are not selected). Based on the selected request for information and the selected recommended grounds for objection, a text string response is automatically generated (by, for example, the AI/ML engine) to the selected request for information. The method includes displaying the text string response in the text editor area 102 (specifically, in the text box 110). The text string response is modifiable by user input. In a non-limiting embodiment, the text string response is automatically generated by the AI/ML engine. In a non-limiting embodiment, the one or more automatically selected recommended ranked and suggested grounds for objection are determined by the AI/ML engine. Other examples of non-limiting embodiments include the AI/ML engine providing: (i) ranked and suggested responses to an interrogatory request; (ii) ranked and suggested response to requests for production; (iii) ranked and suggested responses to issues found in a demand letter; (iv) ranked and suggested responses to subpoena inquiries such as likely account information to the subject account holder; (iv) ranked and suggested responses to allegations from a lawsuit or administrative claim, (v) ranked and suggested responses to insurance coverage demands; (vi) ranked and suggested responses to customer complaints; and (v) ranked and suggested responses to public record requests. In a non-limiting embodiment, the method includes receiving a user save operation input; and saving, in the non-transitory computer-readable medium (e.g., memory 840) or another non-transitory computer-readable medium, the text string response. In a non-limiting embodiment, the method also includes producing a response document including the text string response. For example, the response document is created after clicking on the “GO” button. In a non-limiting embodiment, the method includes displaying the response document on the display screen (e.g., display 870); and printing, with a printer (inkjet printer, laser printer, etc.), the response document. In an exemplary embodiment, the system can rank responses and display, for example in the virtual assistant area 104 (as shown in FIG. 1F), percentages of what which response types historically have happened (for example, “will produce” (79%), “will not produce—stand on objections” (11%), “will produce after P.O.” (5%), “unable to produce—docs do not exist” (5%)). This percentage can be expressed as a frequency of occurrence or confidence percentage based on similarity score of similar requests for information or other algorithm at the user's preference.

In a non-limiting embodiment, a non-transitory computer-readable storage medium stores thereon executable instructions which when executed by processing circuitry causes the processing circuitry to perform the document response production methods described herein.

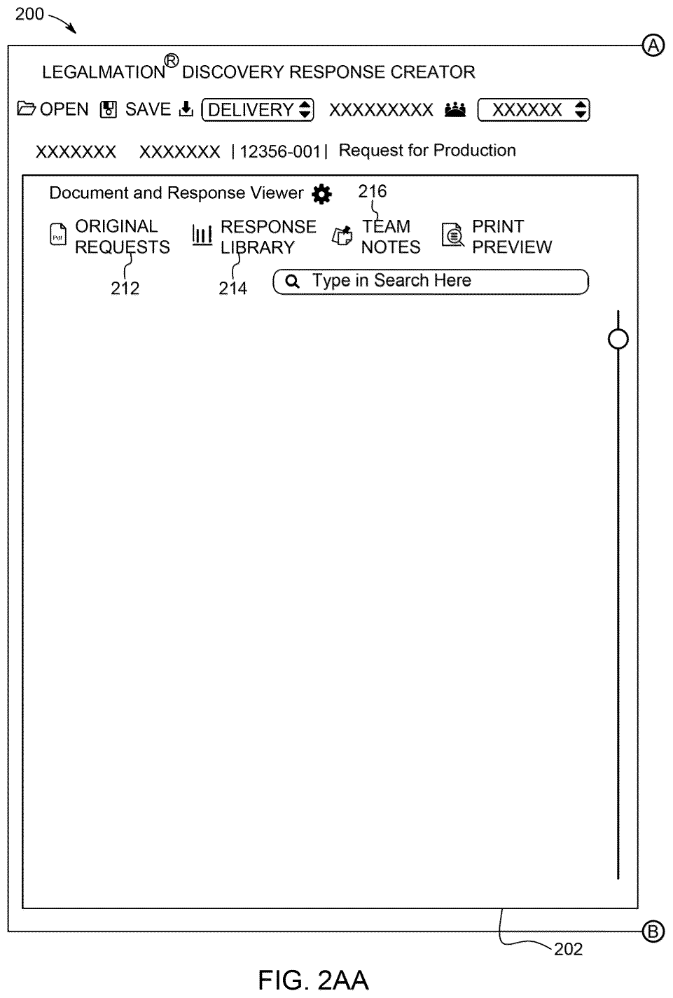

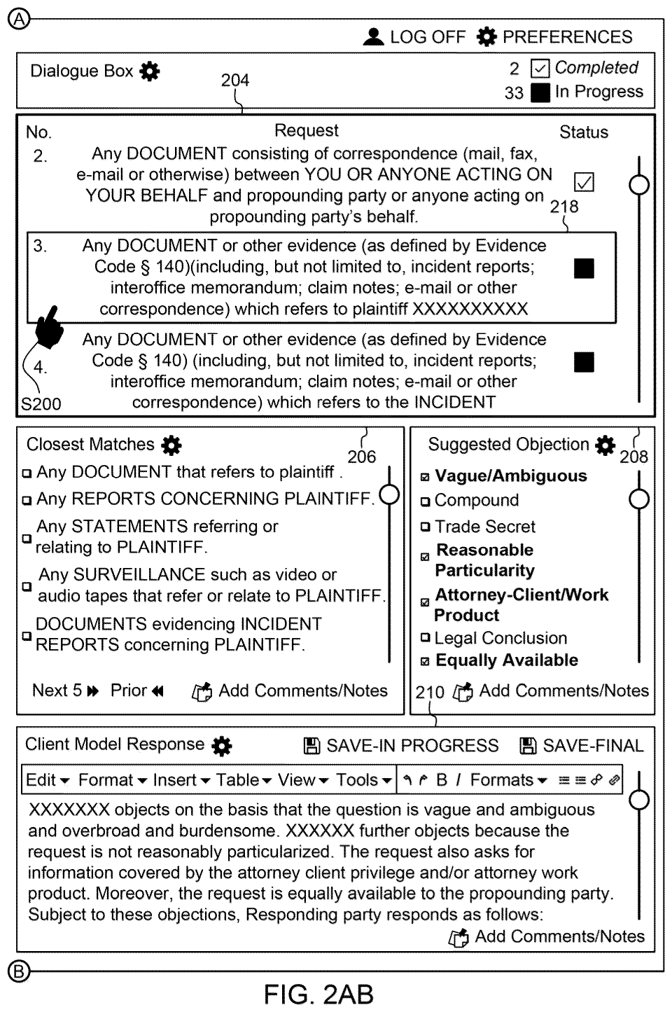

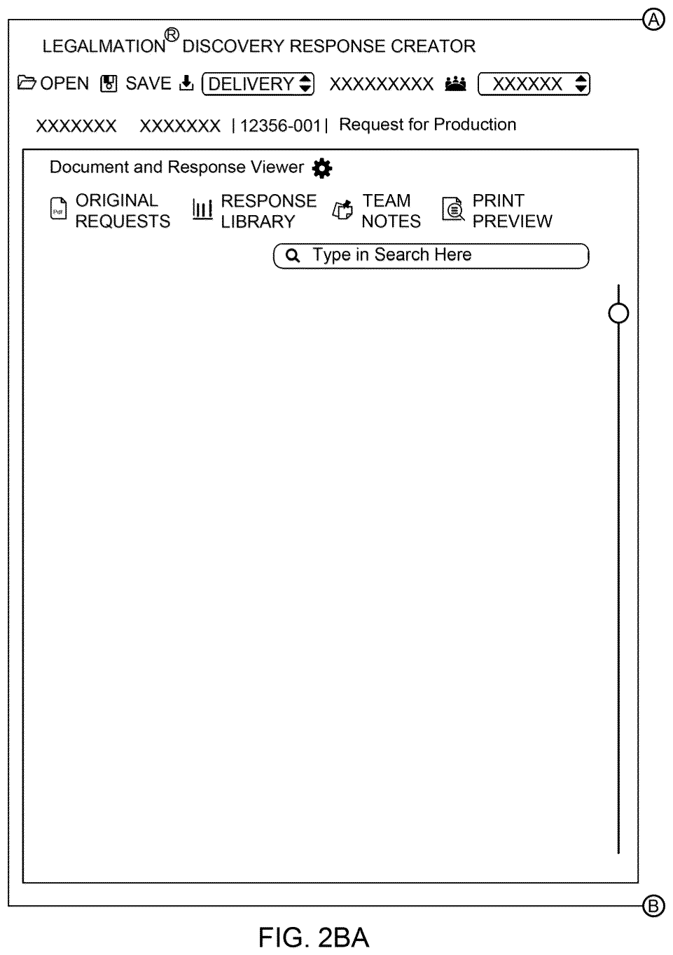

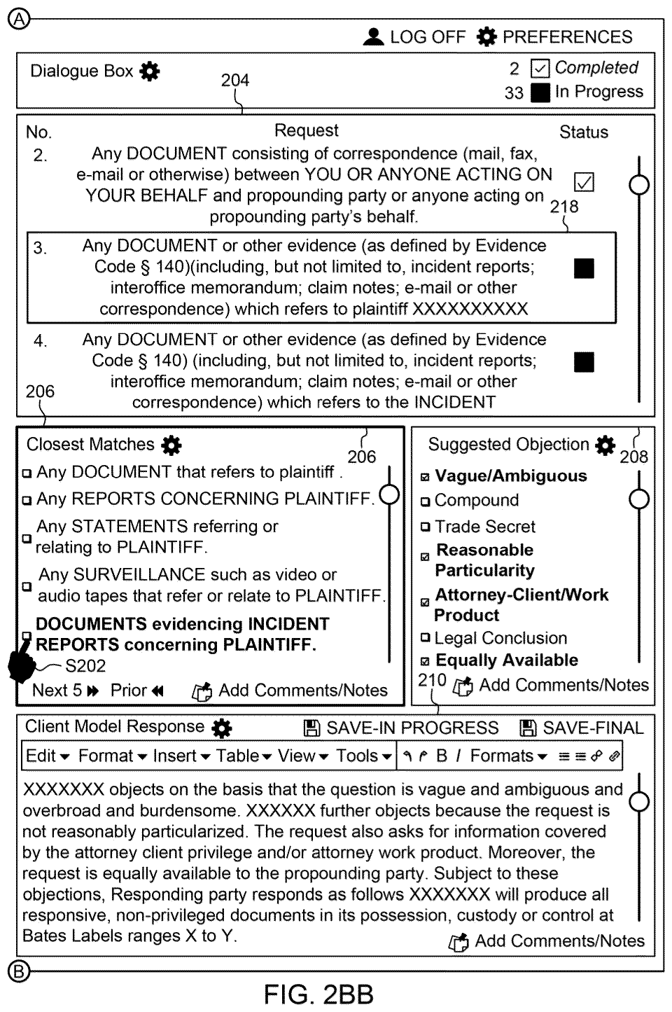

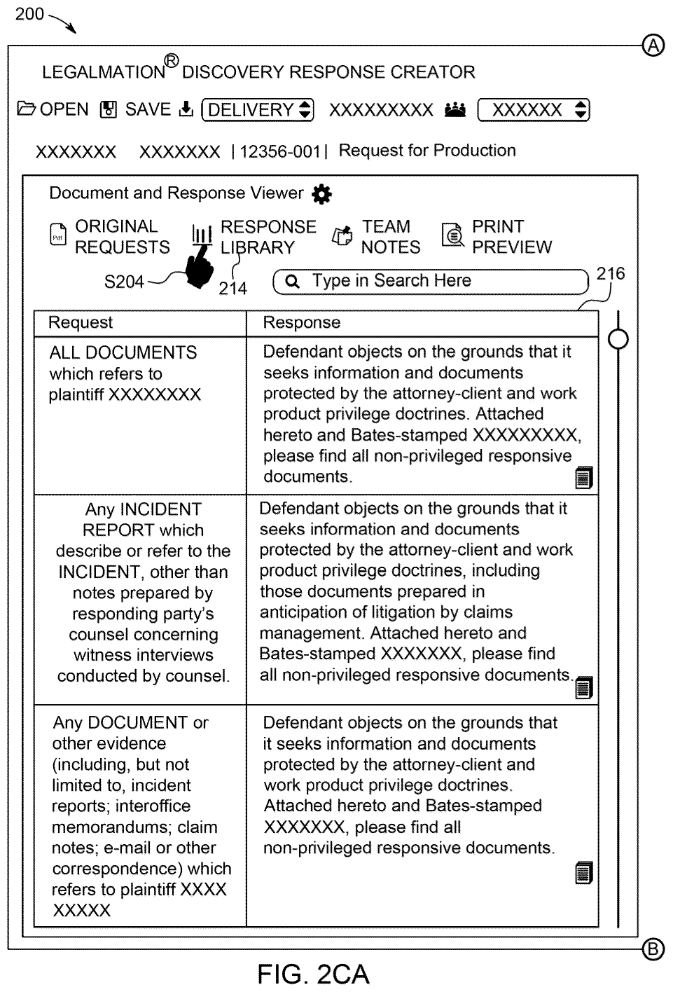

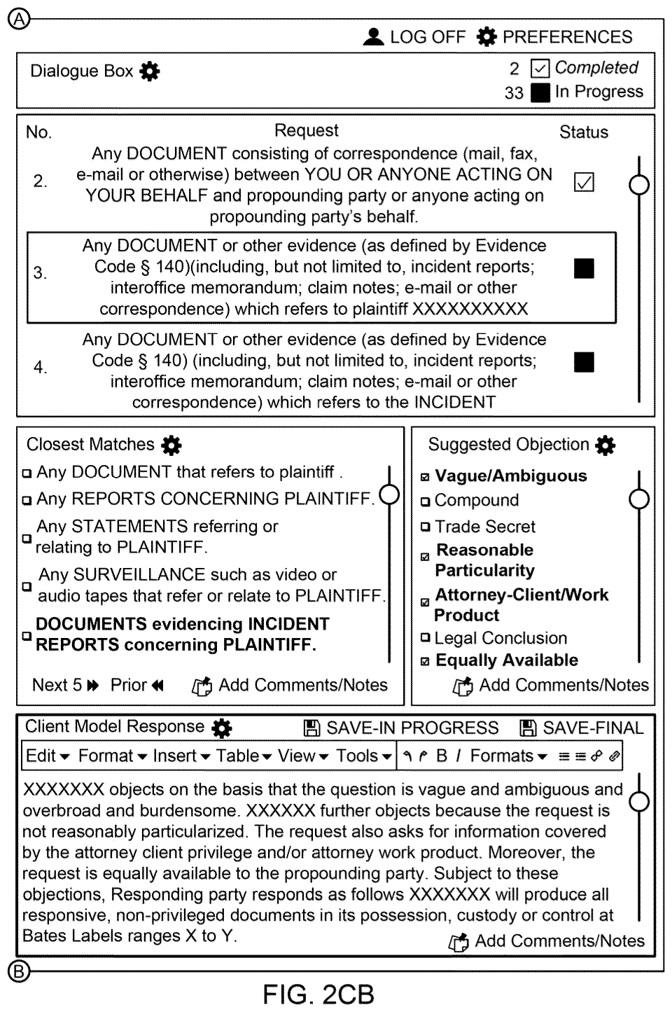

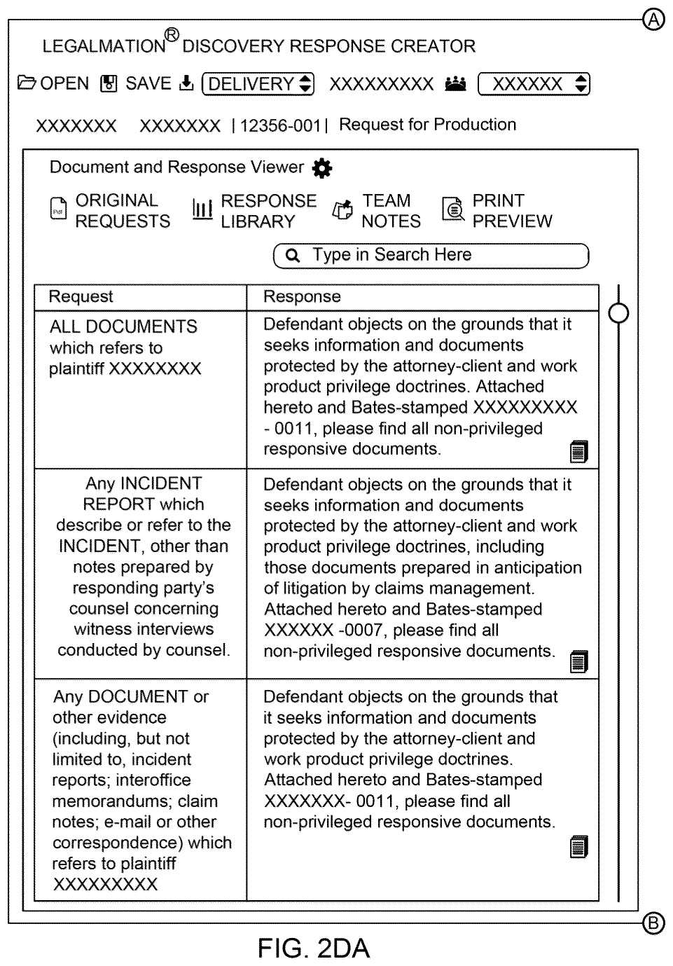

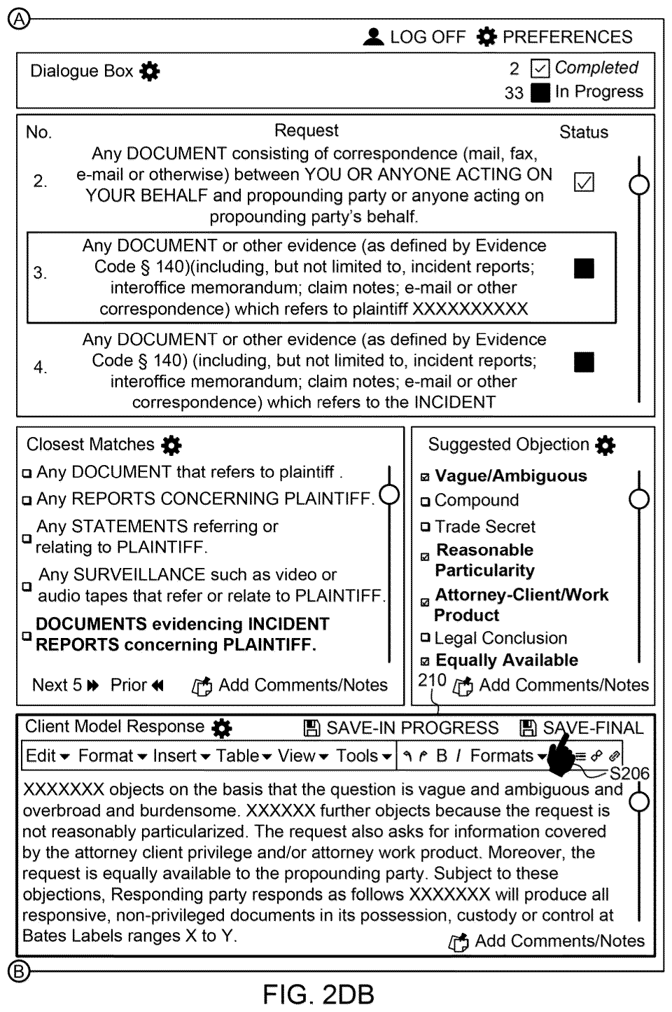

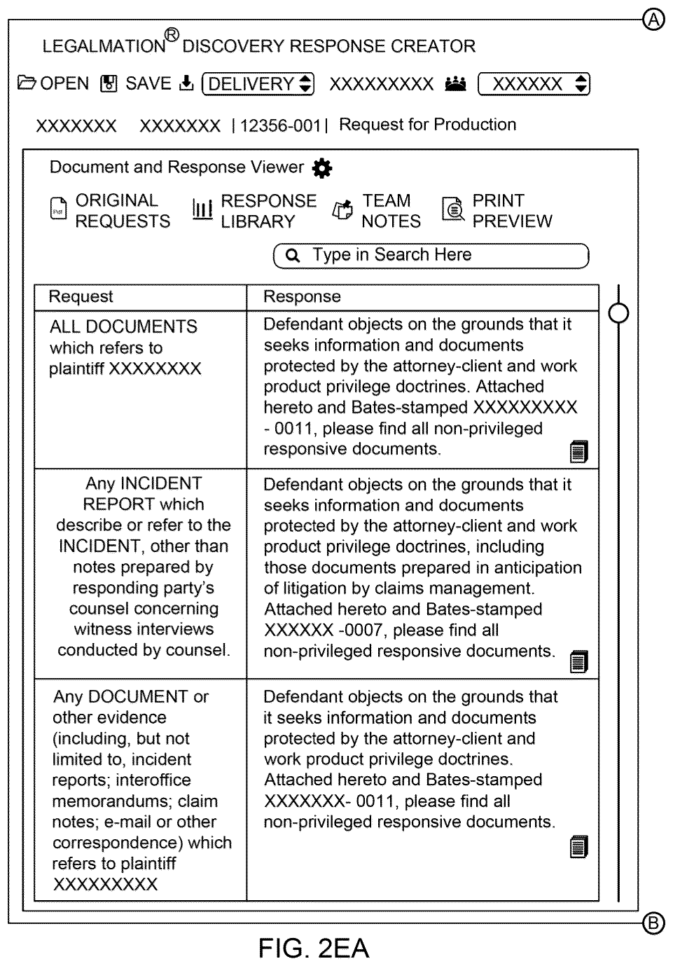

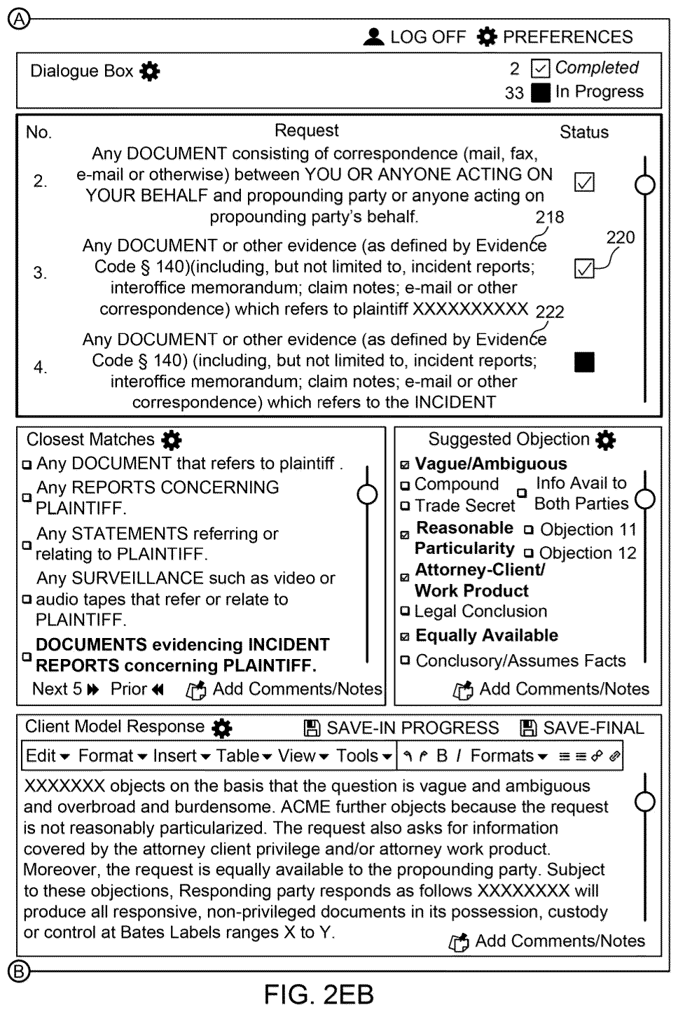

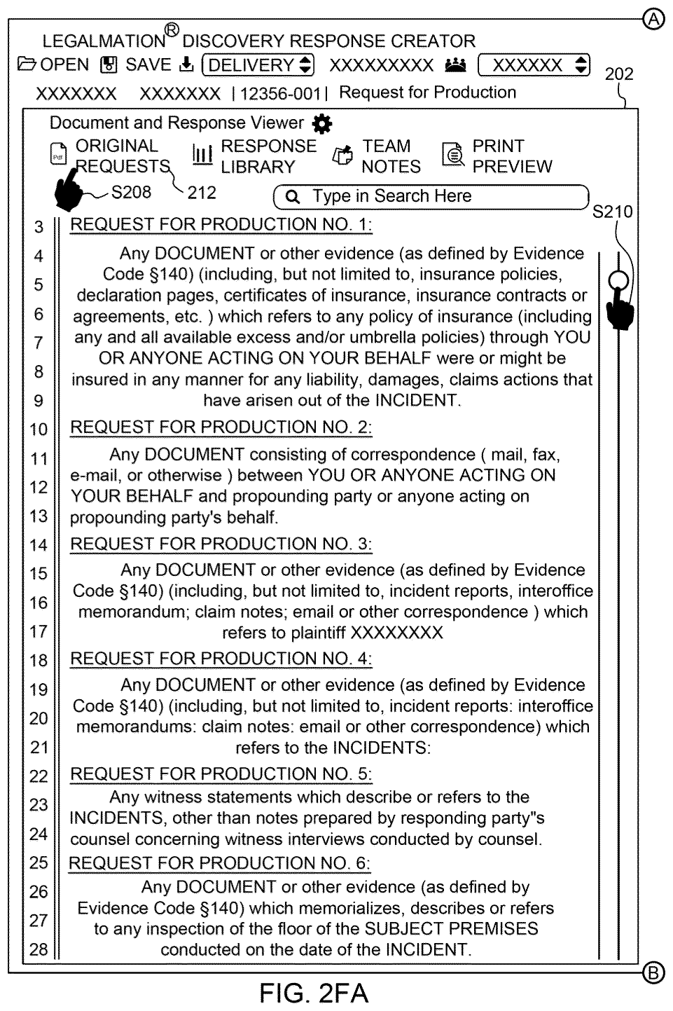

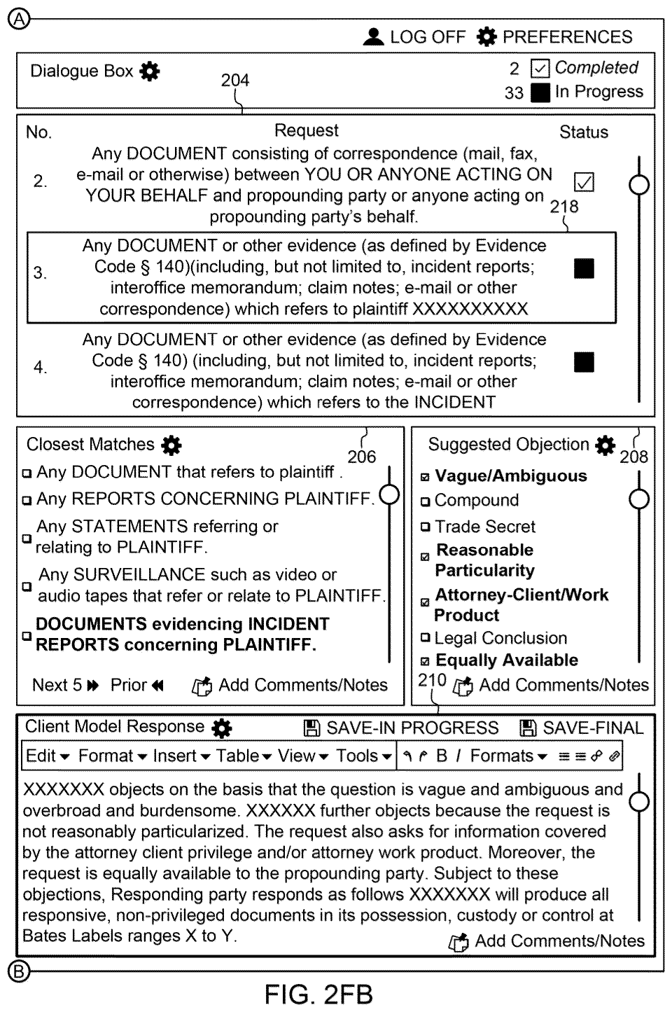

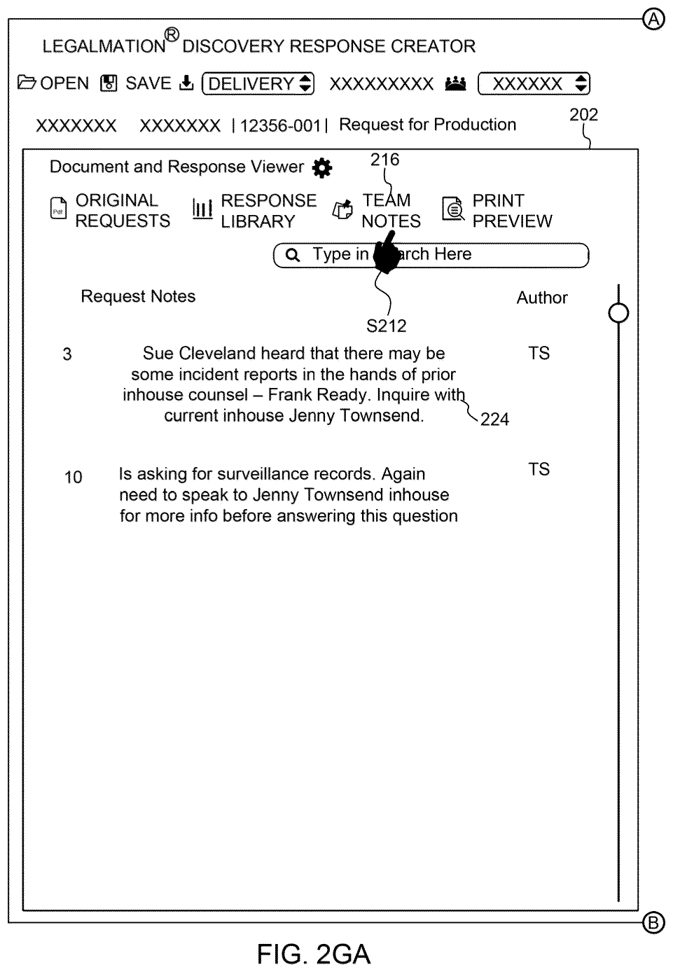

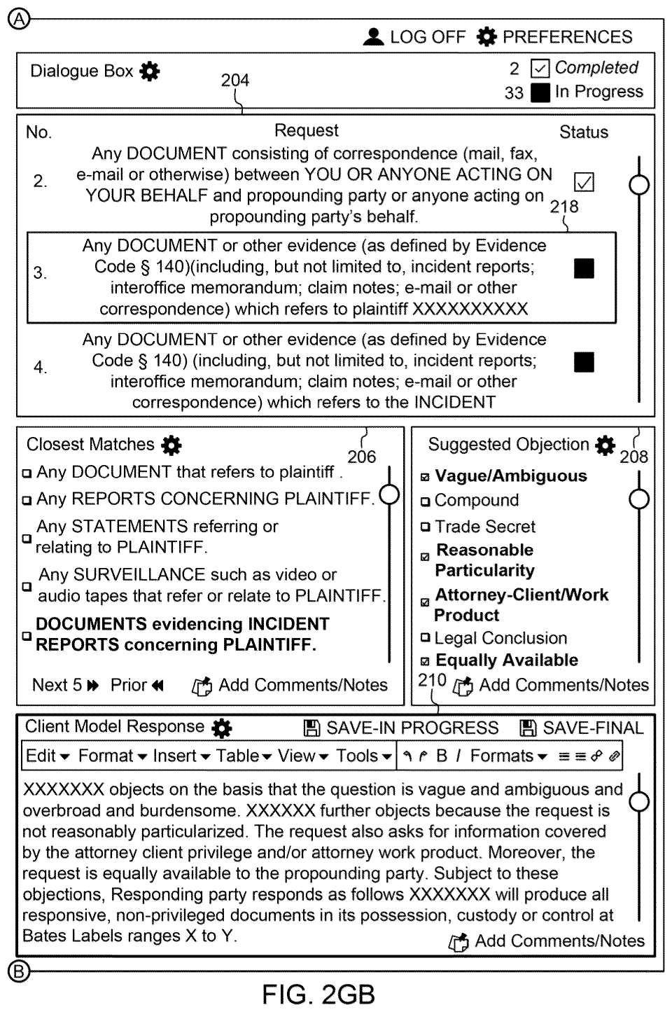

FIGS. 2AA-2GB illustrate a GUI 200 in accordance with exemplary embodiments. In FIGS. 2AA-2AB, in step S200, a user has already answered two requests, and is working on the third request 218. FIGS. 2AA-2AB show several areas of the GUI 200 which include a document and response viewer 202, a request area 204, a closest match area 206, a suggested objections area 208 and a client model response area 210. The document and response viewer 202 includes an “Original Request” tab 212, a “Response Library” tab 214, and a “Team Notes” tab 216 that are similar to the “Original Request” tab 120, a “Response Library” tab 122, and a “Team Notes” tab 124 previously discussed. In FIGS. 2BA-2BB, in step S202, the user is selecting the closest match of the request (Request No. 3) in the closest match area 206. Based on this selection, the suggested objections are displayed in suggested objections area 208, and a response is automatically populated in the client model response area 210.

In FIGS. 2CA-2CB, in step S204, the user is clicking on the “Response Library” tab 214, and the response library 216 is displayed. In FIGS. 2DA-2 DB, in step S206, the user is clicking the save icon to save the prepared response displayed in the client model response area 210. FIG. 2EB shows that a completed request 218 has an associated check box 220 that indicates that a response to the request has been completed. Request 222 is not completed, and does not have an associated check box 220.

In FIGS. 2FA-2FB, in step S208, the user clicks on the “Original Request” tab 212, and the original request is displayed. In step S210, the user can drag an icon to scroll down the original request document. In FIGS. 2GA-2GB, in step S212, the user clicks on the “Team Notes” tab 216 to view any team notes associated with any request. Notes are displayed regarding Request No. 3 and Request No. 10. The initials of the author who created the note is also displayed.

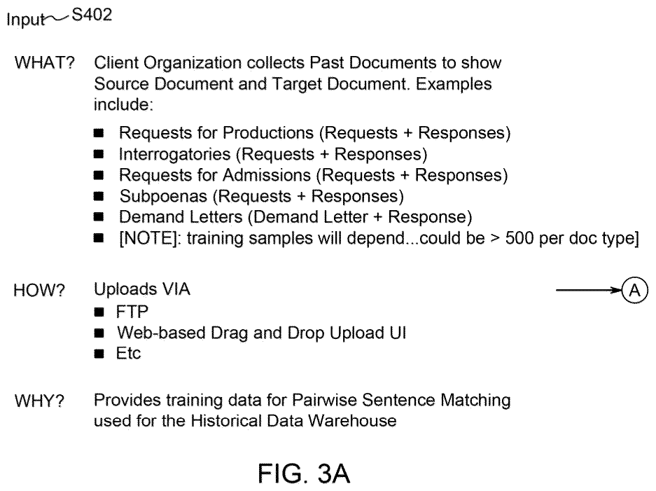

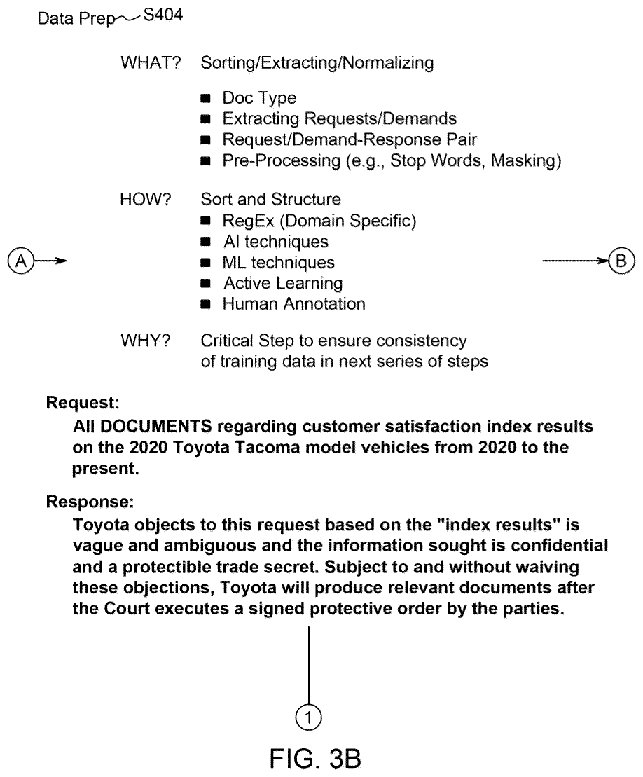

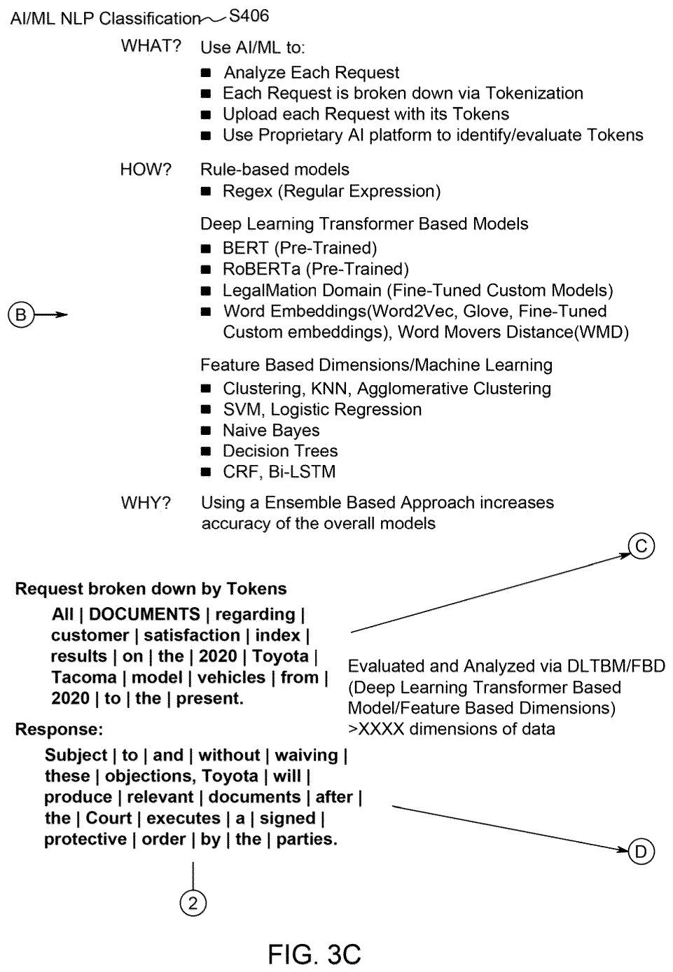

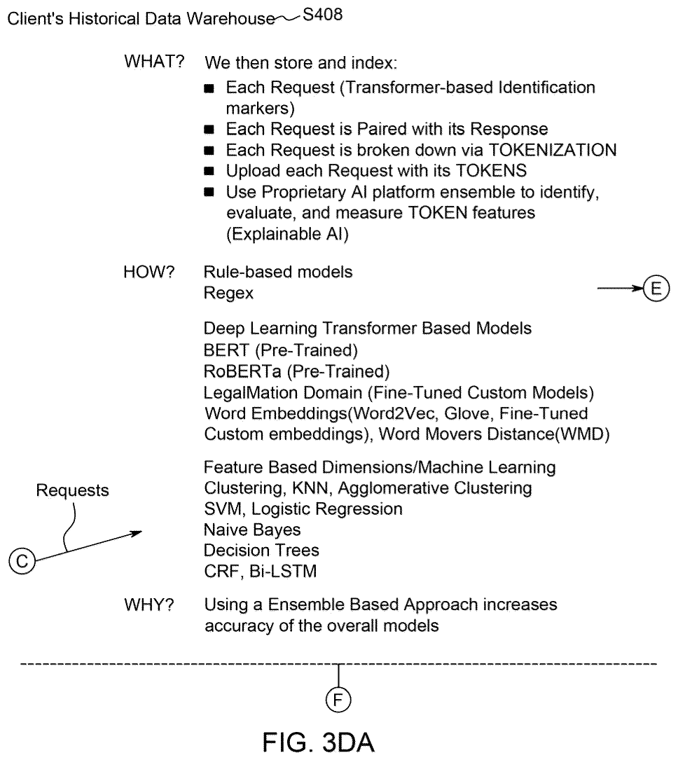

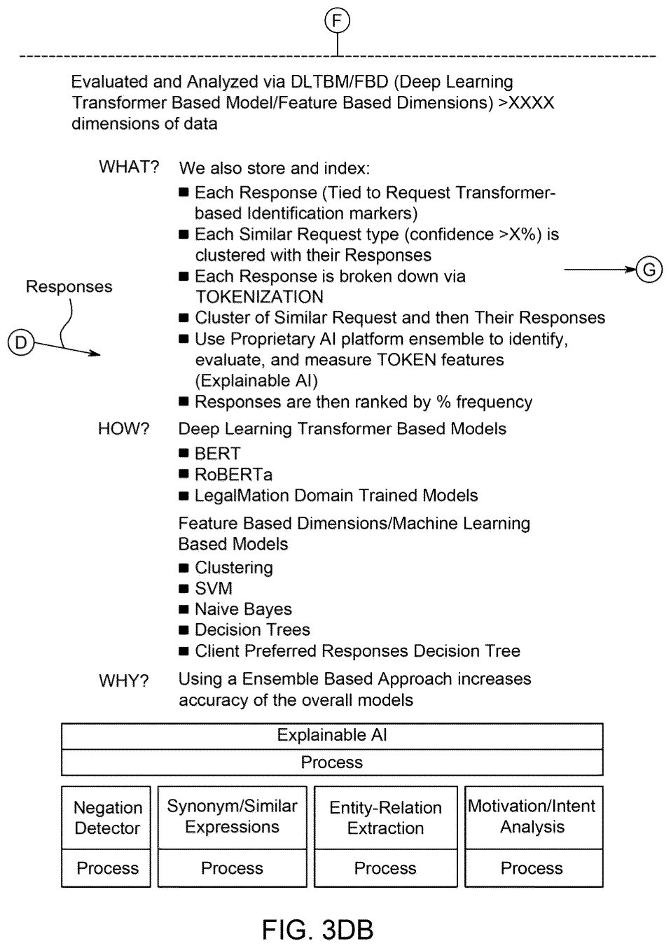

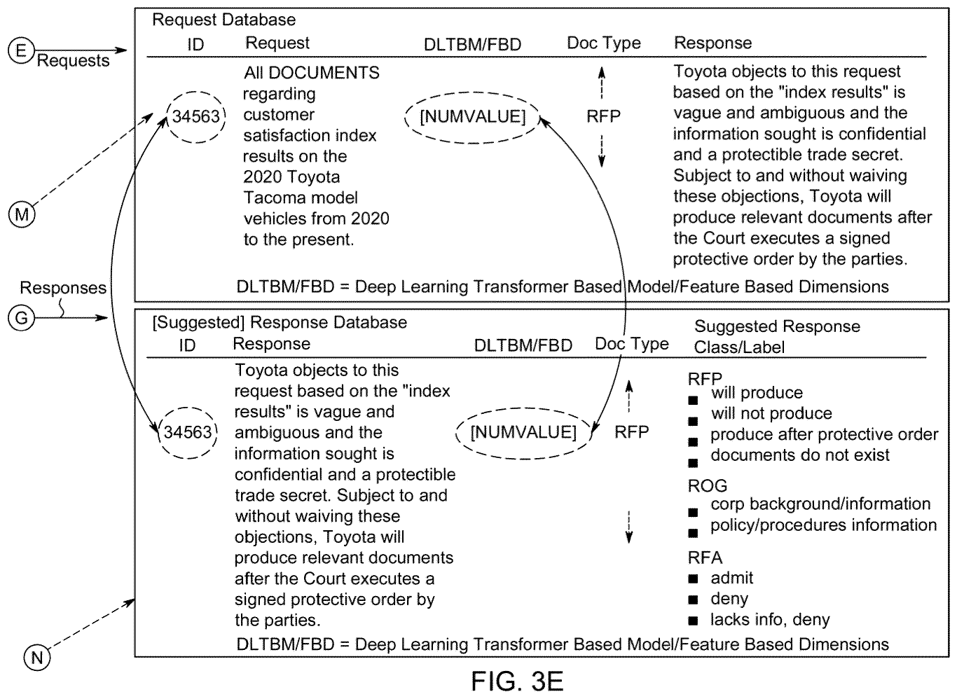

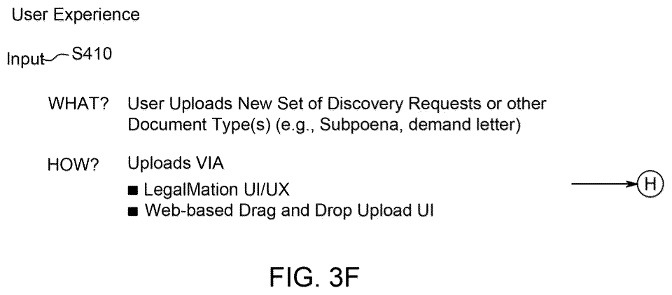

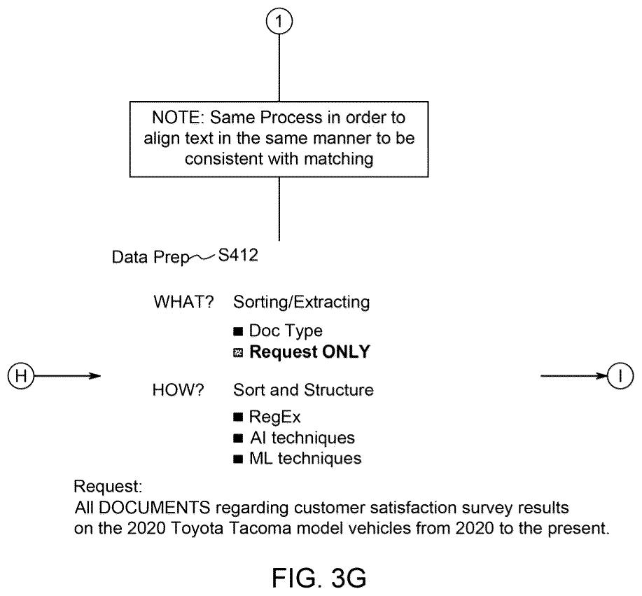

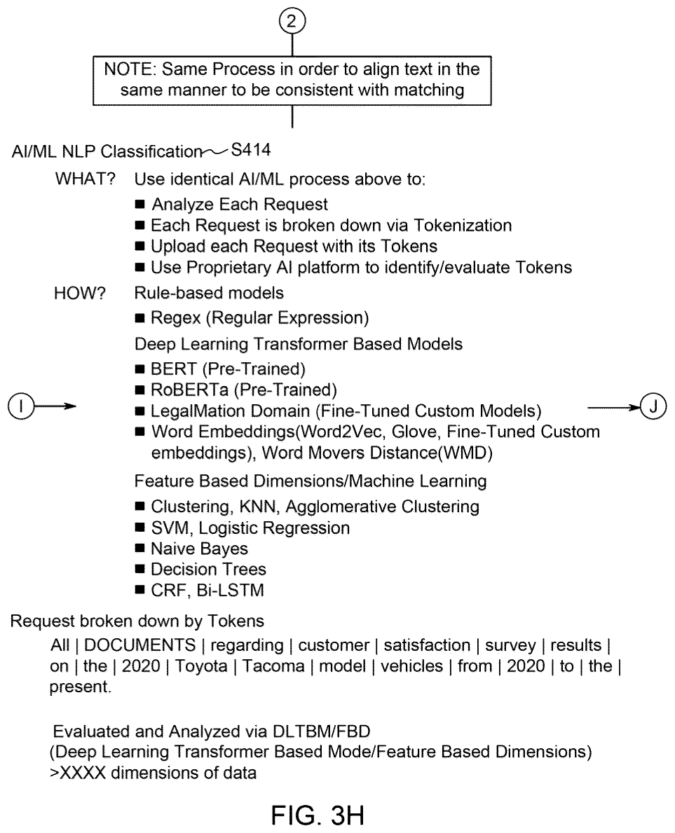

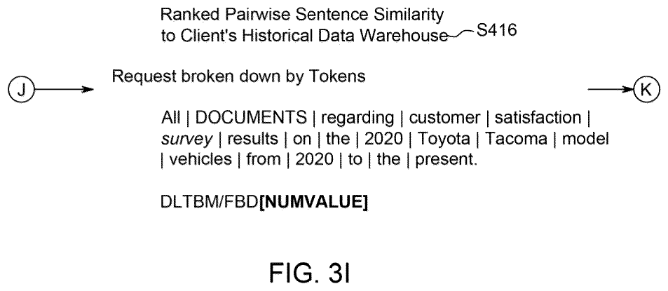

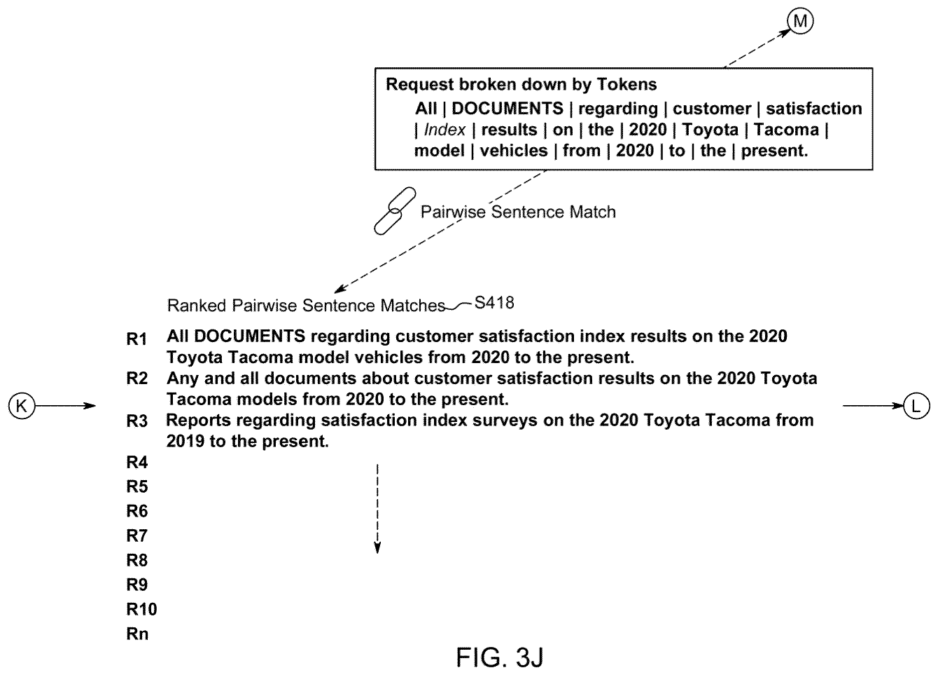

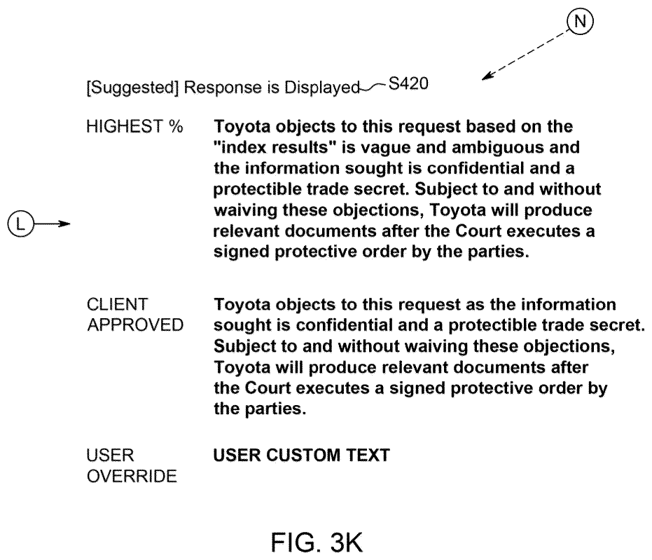

FIGS. 3A-3K illustrate a flow diagram illustrating a document response production method in accordance with exemplary embodiments. Specifically, FIGS. 3A-3E illustrate a training process of the AI/ML engine in accordance with exemplary embodiments. FIGS. 3F-3K illustrate the user's process of uploading a request document and the steps for the system to automatically produce a response document in reply to the request document. In FIGS. 3A-3K, discovery requests/response is used as an example, but any request/demand that has a corresponding response can be used (such as, for example, subpoenas, demand letters, etc.). Step S402 in FIG. 3A illustrates an input process where the user uploads pairs of past/historical documents to train the AI/ML engine. The historical documents are uploaded into the database. Examples of the pairs of documents include: Requests for Productions (Requests and Responses), Interrogatories (Requests and Responses), Requests for Admissions (Requests and Responses), Subpoenas (Requests and Responses), Demand Letters (Demand Letters and Responses), Lawsuit (Allegations and Responses), Administrative Claim (Allegations and Responses), Insurance Coverage Demands (Demand Issues and Responses). The amount of training pairs uploaded can vary depending on the complexity and variance of the subject matter, jurisdiction, issues, responses, etc. In an exemplary embodiment, the training documents are uploaded by File Transfer Protocol (FTP), a web-based drag and drop operation on the GUI, etc. The uploading process is performed in order to provide training data for pairwise sentence matching that is used to create a historical data warehouse. In a non-limiting embodiment, training may also occur via an Active Learning human annotation process with user selecting the labeled checkboxes that link the request to the appropriate response types. The collection of user selected selections can then be used to build and/or supplement training of the AI/ML engine.

Step S404 in FIG. 3B illustrates a data preparation process. During this step, sorting, extracting, and normalizing is performed. For example, extracting information from the historical documents is performed, separating the historical documents is performed, and preprocessing is performed on the historical documents. The historical documents can be sorted by document type. Requests/demands can be extracted. Request/Demand-Response pairs can be sorted. In an exemplary embodiment, the pre-processing that is performed uses stop words and Named Entity Recognition (NER) replacement. A stop word is a word that you can remove from a sentence as it is not necessary for AI/ML training purposes (e.g., on, the, to, from, etc.). An example of NER replacement is switching a specific name such as “Joe Smith” to a generic phrase/label such as “Name.” Labelling a specific number (e.g., an account number, address, telephone number, etc.) that is not necessary to a generic label can also be performed.

In an exemplary embodiment, the data preparation such as sorting can be performed by regular expression (RegEx) boolean searches, AI techniques, Machine Learning (ML) techniques, Active Learning, and human annotation. RegEx can be domain specific, that is for every domain (employment, personal injury, etc.) the rules that the system uses to sort are different based on the domain. Active learning, for example, includes back propagating data and capturing keystrokes. In an exemplary embodiment, the human annotation process can include adding different metadata fields to historical requests, and this is done for normalization of the data. An example of a normalized data set is that there could be a policy number associated with a historical request. In this case, the system can use NER replacement for the specific policy number with a generic label such as “NUMBER” and replace a specific person's name with “NAME.” Also during data preparation, terms can be tagged that are not likely to create false positives in context to the response (e.g., terms such as “attorney work product”, “compound,” overbroad, etc. are used in very precise ways). The data preparation process is important as it ensures consistency of training data in the steps that follow. The lower portion of FIG. 3B shows an example of a paired request and response at this stage of processing.

Step S406 in FIG. 3C illustrates an AI/ML Natural Language Processing (NLP) classification process in which the AI/ML engine is used to analyze each request, each request is broken down by tokenization, each request with its tokens is uploaded, and the AI/ML engine is used to identify/evaluate tokens. This process uses a variety of different models to increase accuracy. For example, if five different AI/ML models are used and the ensemble setup requires the majority of the models to agree on a classification or answer, there is a higher likelihood of a more accurate response than if any single model was being asked to classify the same request. This process takes the strengths of certain processes and combines them together for increased accuracy for an ensemble AI/ML process. In step S406, this is where the AI/ML engine starts analyzing the request. First, the AI/ML engine breaks down the words of the sentence into tokens (i.e. the words, numbers, symbols, etc. are the tokens). Next, one or more Deep Learning Transformer Based Models (e.g., Bidirectional Encoder Representations from Transformers (BERT) by Google®, ROBERTa, LegalMation Domain (which is fine-tuned custom models), word embeddings, and Word Movers Distance (WMD) are applied, for example by the AI/ML engine, on the tokens of the request. In an exemplary embodiment, the word embeddings can be, for example, Word2Vec, Glove, fine-tuned custom embeddings, etc.

In addition to this step using one or more Deep Learning Transformer Based Models described above, this step can also use one or more different types of Feature-Based Dimensions Machine Learning. When the Feature-Based Dimensions Machine Learning is combined with Deep Learning Transformer Models, the results are more accurate than only using one of these. In an exemplary embodiment, the Feature-Based Dimension Machine Learning process includes, for example, one or more of clustering, a k-nearest neighbors (KNN) algorithm, agglomerative clustering, a support vector machine (SVM) method, logistic regression, Naive Bayes, decision trees, conditional random fields (CRF), and bi-directional long-short term memory (Bi-LSTM), etc. Which particular Feature-Based Dimension Machine Learning process that is used depends on what document is being analyzed (subpoena, interrogatory, etc.) In an exemplary embodiment, more than one of the Feature-Based Dimension Machine Learning processes can be used in combination. This is an ensemble based approach which results in greater accuracy due to more than one model being used by the system. The lower portion of FIG. 3C shows an example of a paired request and response at this stage of processing. As can be seen, the request and response are both broken down into tokens (each token separated by “|”). NLP and tokenizing are described in U.S. Pat. No. 10,140,273 by Biegert et al., issued Nov. 27, 2018; U.S. Patent Publication No. 2011/0040553 by Sasivarman, published Feb. 17, 2011; U.S. Pat. No. 9,471,627 by Boyle et al., issued Oct. 18, 2016; U.S. Patent Publication No. 2015/0261745 by Song et al., published on Sep. 17, 2015; and U.S. Pat. No. 10,303,999 by Hertz et al., issued on May 28, 2019, the entire contents of each of which are incorporated herein by reference. ML/AI processing is described in U.S. Patent Publication No. 2018/0268506 by Wodetzki, published on Sep. 20, 2018, the entire contents of which are incorporated herein by reference. Deep learning is described in U.S. Pat. No. 9,552,548 by Brestoff, issued Jan. 24, 2017, the entire contents of which are incorporated herein by reference.

In an exemplary embodiment, the system can also use a negation detector to detect negation cues in the request text. Negation detection is described in U.S. Patent Publication No. 2020/0250381 by Guo, published on Aug. 6, 2020, the entire contents of which are incorporated herein by reference.

Step S408 in FIGS. 3DA and 3DB illustrate a process of storing the data in the user's (i.e. client's) historical data warehouse. In an exemplary embodiment, the historical data warehouse can be, for example, one or more of memory 848, non-volatile storage 845, remote computer 815, web server 820, cloud storage server 825, computer server 830, etc. In step S408, examples of what are stored and indexed include: each request (transformer-based identification markers), each request paired with its corresponding response, each request is broken down via tokenization, each request is uploaded with its tokens. The system performs an explainable AI/ML process as it explains how the result is obtained. This is done by the AI/ML engine using an ensemble process to identify, evaluate, and measure token features. For example, a sentence can be featurized, it can be assigned a class description, a features identification description, and then a unique ID number can be assigned (similar to a unique warehouse part number). If the sentence has a certain feature, then the system assigns it a corresponding part number. For example, the request is assigned an ID number (ID Request, shown in FIG. 3E), it is given a feature ID number, metadata is associated with it that signifies what the document type is (e.g., Request for Production (RFP), Interrogatory (ROG), Request for Admission (RFA), Subpoena Duces Tecum (SDT), etc.), and the request is also associated with its corresponding response. FIG. 3E shows an example of a paired request and response stored in the historical data warehouse (e.g., database, memory, etc.). The suggested response has the same ID number (34563) as the paired request and response stored in the request database. The document type (e.g., RFP) is also associated with the paired request and response.

FIGS. 3F-3K illustrate the user's process (i.e., user experience) of using the system and uploading a new request document and the steps for the system to automatically produce a response document in reply to the request document. This process focuses on the new request document and then matching a new request in the document to all the similar requests in the historical data warehouse, and then for the system to perform computational and statistical approaches to provide suggested responses and next steps.

Step S410 in FIG. 3F illustrates a process of inputting a new request document into the system for analysis. In this step, the user uploads the new request document (Interrogatory, Subpoena, Demand Letter, etc.) into the system by using the GUI 100 to perform a web-based drag and drop operation of the electronic file of the document (PDF, Word Document, etc.) or browsing on the computing device for the file in order to upload it. Next, the process moves on to Step S412.

Step S412 in FIG. 3G illustrates the data preparation process after the new request document has been uploaded. This is the same process as in step S404 of FIG. 3B in order to align text in the same manner to be consistent with matching, except that it is the new request only that undergoes the data preparation (i.e., a response does not undergo data preparation). The lower portion of FIG. 3G shows an example of a request at this stage. Next, the process moves on to Step S414.

Step S414 in FIG. 3H illustrates an AI/ML classification process in which the AI/ML engine is used to analyze the new request. This is the same process as in step S406 of FIG. 3C in order to align text in the same manner to be consistent with matching, except that it is the new request only that undergoes the classification process (i.e., a response does not undergo classification). The lower portion of FIG. 3H shows an example of a request at this stage. For example, the request is broken down by tokens. Next, the process moves on to Step S416.

Step S416 in FIG. 3I illustrates how the system performs pairwise sentence similarity comparisons to historical documents stored in the client's historical data warehouse. FIG. 3I shows how the request is broken down by tokens. Next, the process moves on to Step S418.

In step S418, the system ranks the pairwise sentence matches. In an exemplary embodiment, the closer the match, the higher (i.e., better) the ranking. For example, the closest match could be ranked number one. Next, the process moves on to Step S420.

In step S420, the suggested response determined by the system is output for display on a display screen (e.g., display 870).

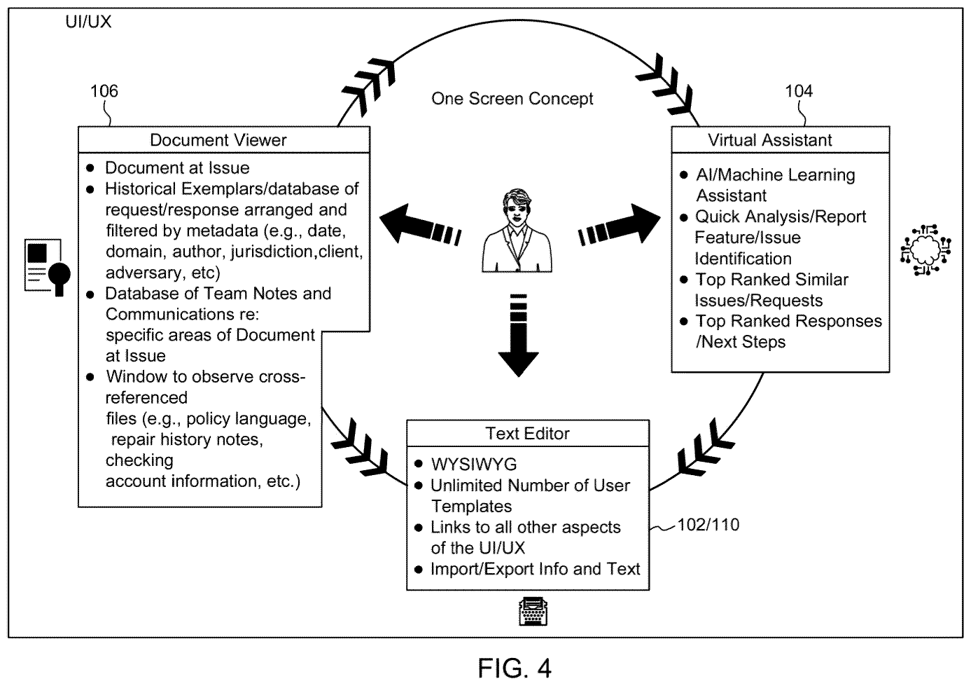

FIG. 4 is a diagram illustrating different parts of a GUI in accordance with exemplary embodiments. This diagram illustrates the one screen concept of the GUI 100 in which one screen simultaneously displays the document viewer area 106, the virtual assistant area 104, and the text editor area 102/110. This diagram also illustrates attributes and features of each of the document viewer area 106, the virtual assistant area 104, and the text editor area 102/110.

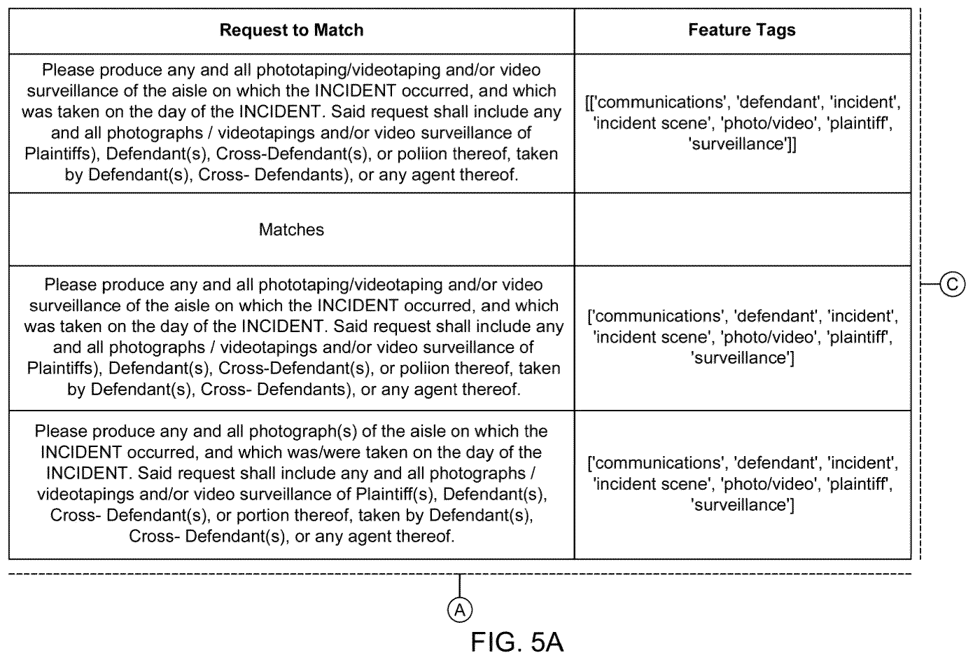

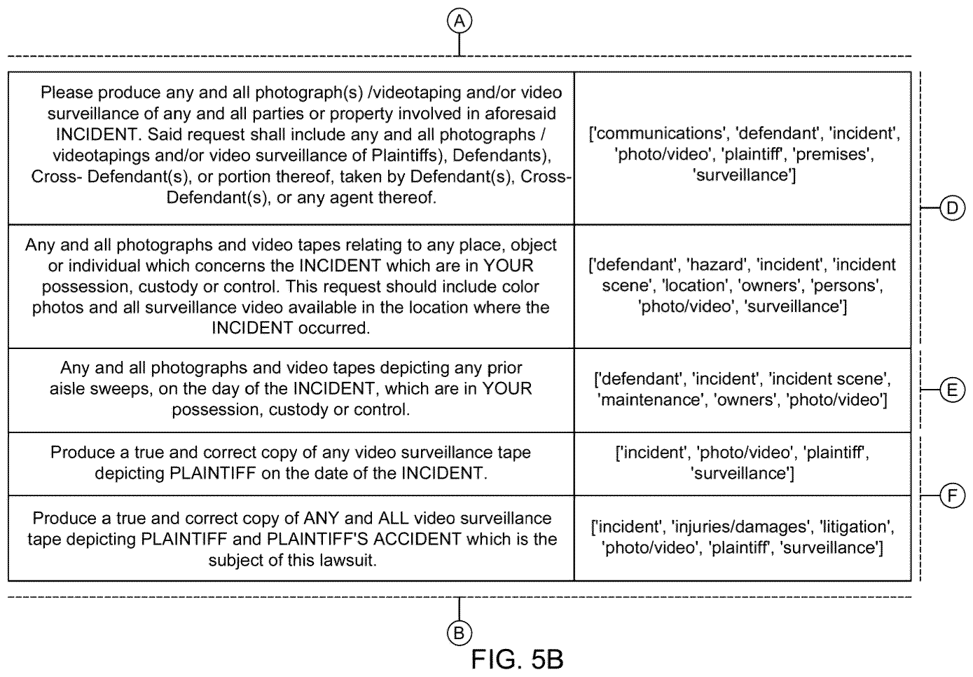

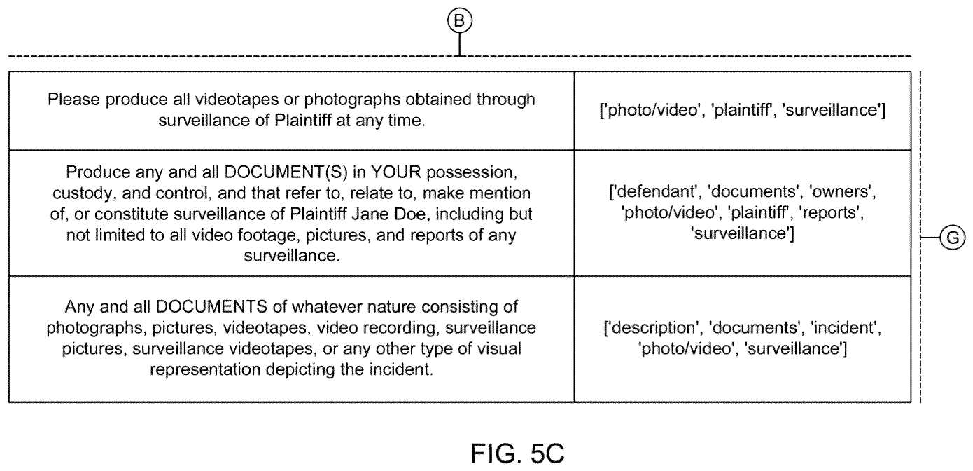

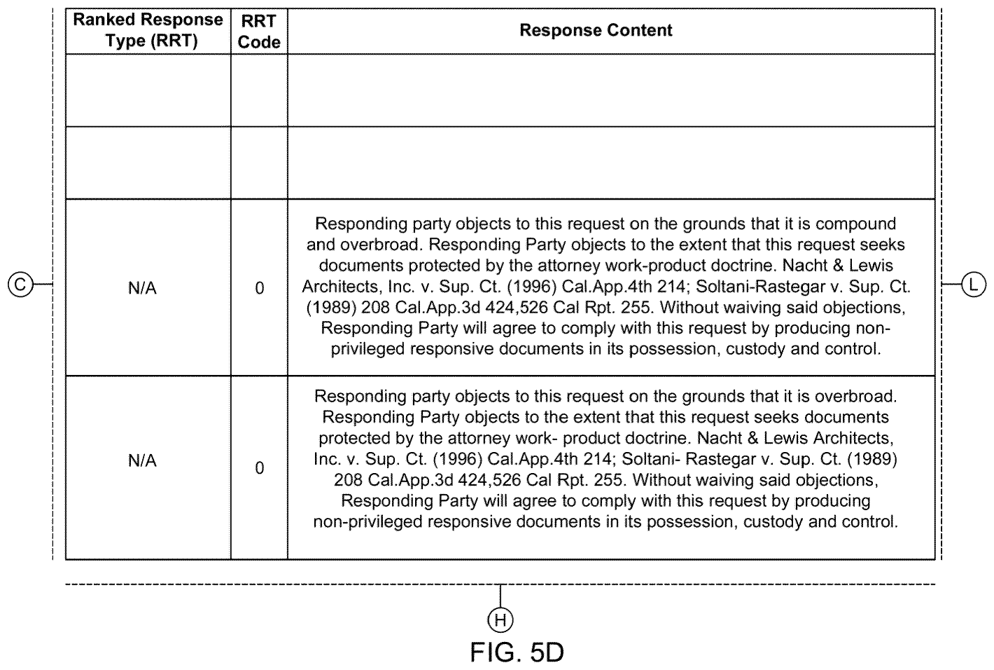

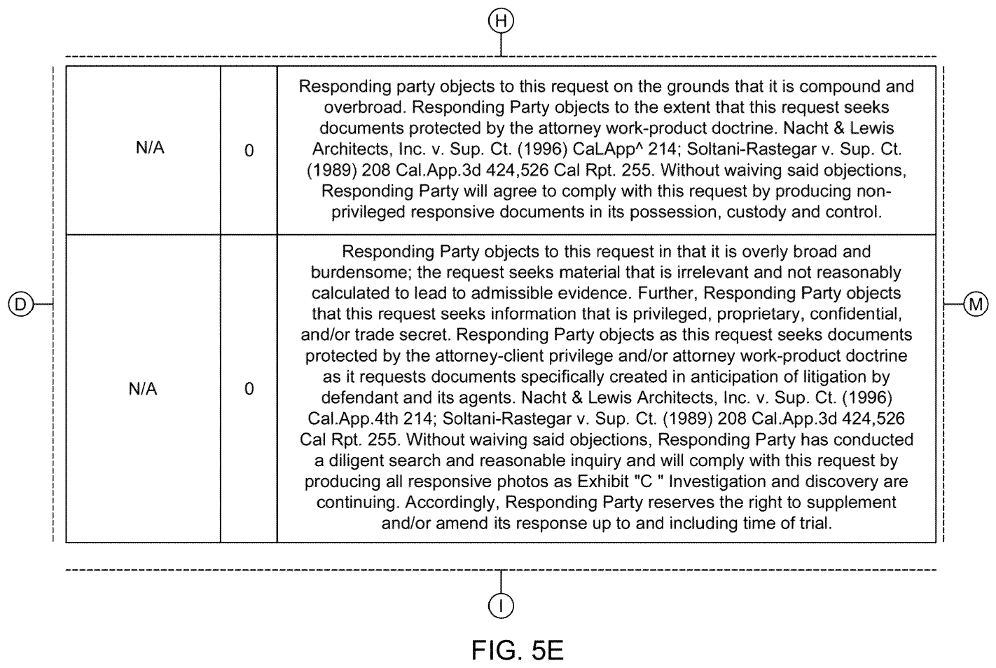

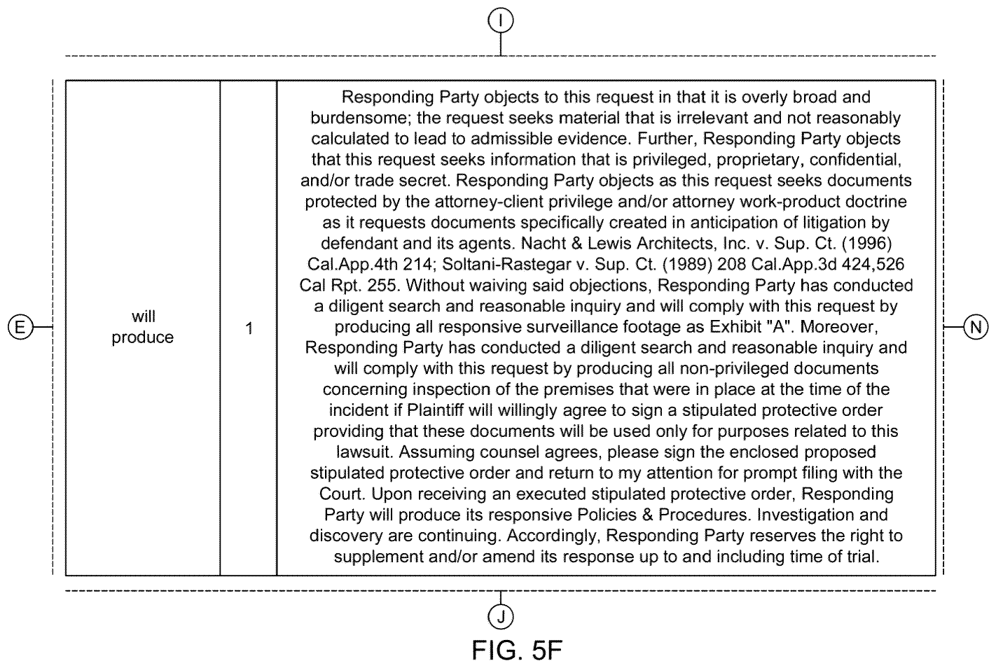

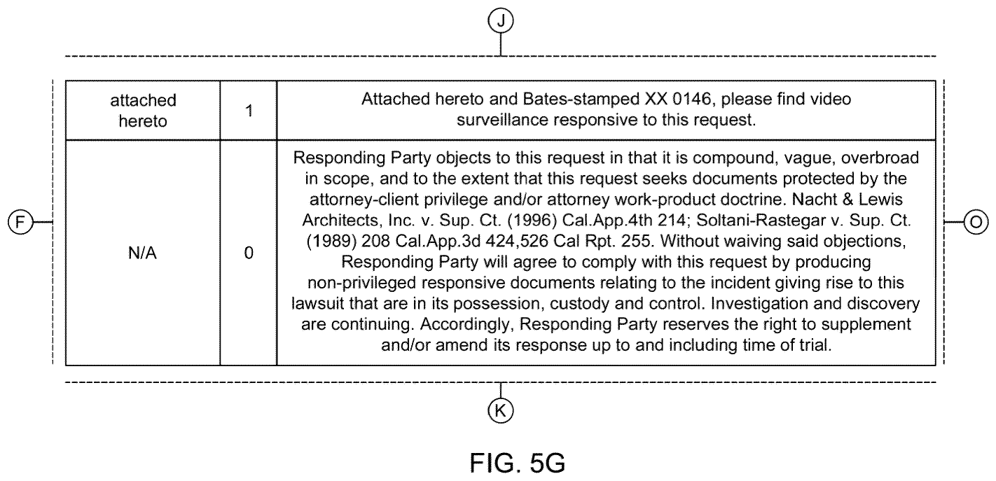

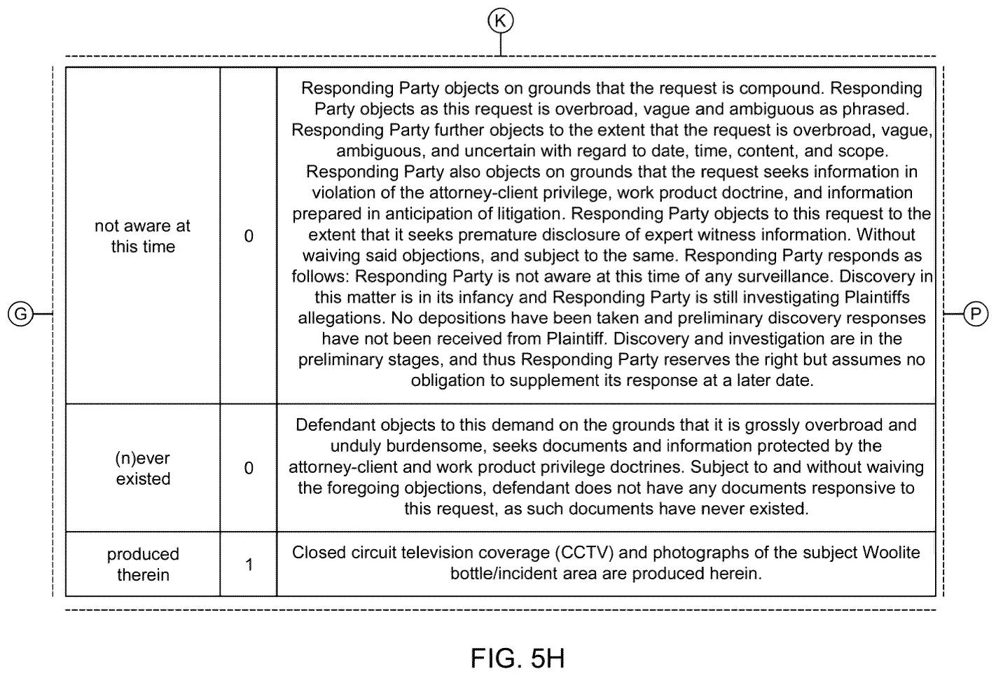

FIGS. 5A-5I illustrate computation of similarity scores in accordance with exemplary embodiments. FIGS. 5A-5I is a chart in which the first column shows the request that the matching is going to be applied to. The second column lists the feature tags that are present in the request. In an exemplary embodiment, the feature tags are mapped to recognized words/tokens present in the request. In the first row of FIG. 5A, the feature tags are the words: “communications,” “defendant,” “incident,” “incident scene,” “photo/video,” “plaintiff,” and “surveillance.” Similar rows of requests and corresponding lists of feature tags are shown in FIGS. 5B-5C. FIGS. 5D-5H show the third, fourth, and fifth columns of the chart. The third column shows the Ranked Response Type (RRT) for an associated request. In an exemplary embodiment, the RRT can be, for example, “N/A”, “will produce”, “attached hereto”, “not aware at this time”, “never existed”, “produced therein”, etc. The fourth column shows a RRT code that can be associated with the RRT, and can be, for example, an integer such as 0, 1, 2, 3, 4, etc. The fifth column of the chart displays the content of the response that corresponds to the request of the same row in the chart. FIG. 5I shows the sixth, seventh, eighth, and ninth columns of the chart. The sixth column of the chart, labelled “Semantic Similarity,” displays a semantic similarity score. In an exemplary embodiment, the semantic similarity score can be a number n, where 0≤n≤1. The seventh column of the chart, labelled “Feature Tag Similarity,” displays a feature tag similarity score that is assigned based on the similarity of the feature tags between the new request and a historical request. Featurization is a process in which tags for words are used to find the best match. In an exemplary embodiment, the feature tag similarity score can be a number m, where 0≤m≤2. The feature tag similarity score can also be normalized to a 0≤m≤1 as well. Thus, for a particular request sentence, there are two similarity scores: (1) a semantic similarity score (1 is the highest score available and that is if it is in the database, and (2) a feature tag similarity score based on featurization of the words in the request (e.g., “documents”, “identification”, “incident” “maintenance”, “persons”, “premises”, “responsible for,” etc.). This score is assigned by the system based on the similarity of the features. The higher the score, the greater the similarity. Thus, the semantic similarity score is based on a first model, and the feature tag similarity score is based on a second model that is different than the first model. Both scores are used by the system to compute a composite score (labelled the “weighted similarity” in FIG. 5I) and then the system performs ranking based on the composite score (the “weighted similarity” score). In an exemplary embodiment, the system computes the composite similarity score by multiplying the semantic similarity score with the feature tag similarity score. The highest composite similarity score is assigned a ranking of “1,” the next highest score assigned a ranking of “2,” and so on. In an exemplary embodiment, user settable thresholds that can be used to weigh the outcomes of the similarity scores. In an exemplary embodiment, if the system gets above a particular certainty threshold (e.g., a set valued for the composite similarity score) based on the comparison with the new request and the saved requests and paired responses in the database, it will provide a suggested response. If it is below the threshold, the system will not make a suggestion. In an exemplary embodiment, the system also learns the responses that the user selects and uses, and uses this information to feed back into the AI/ML engine to suggest future responses to the user.

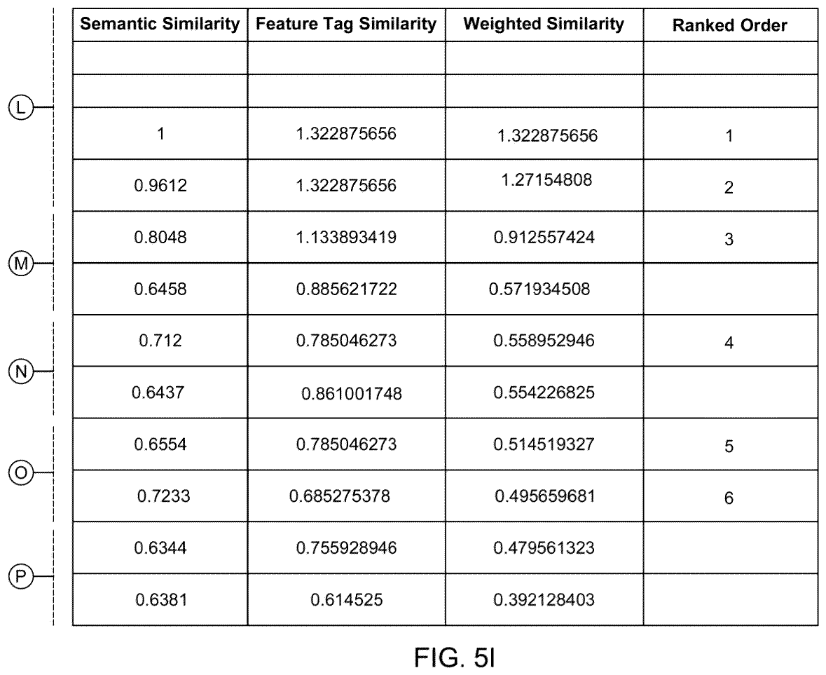

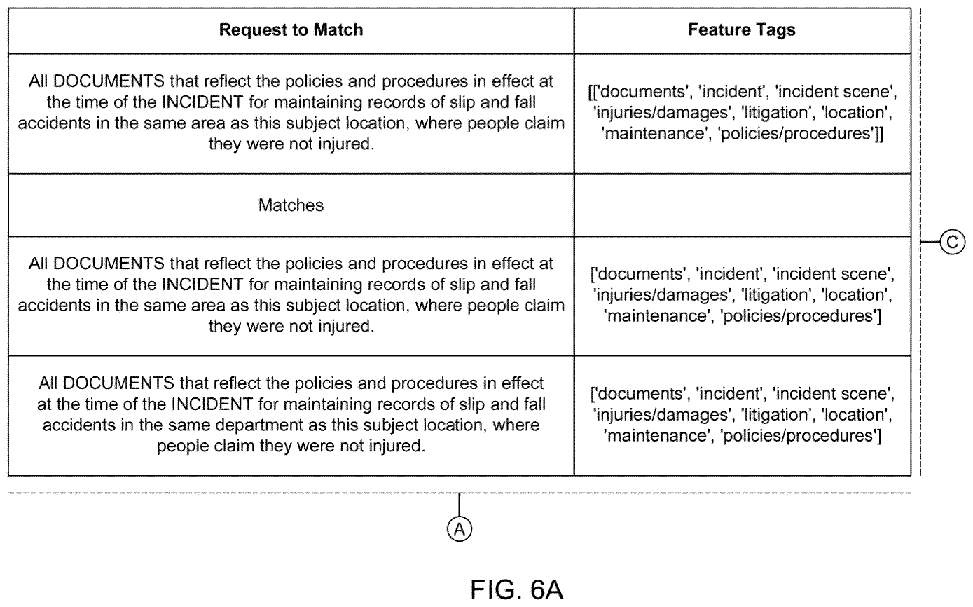

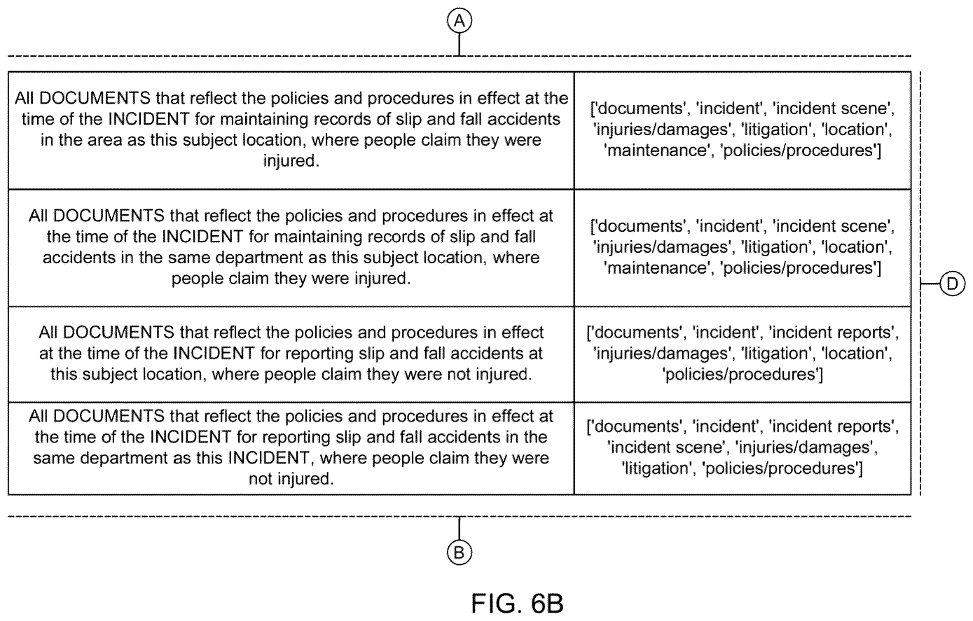

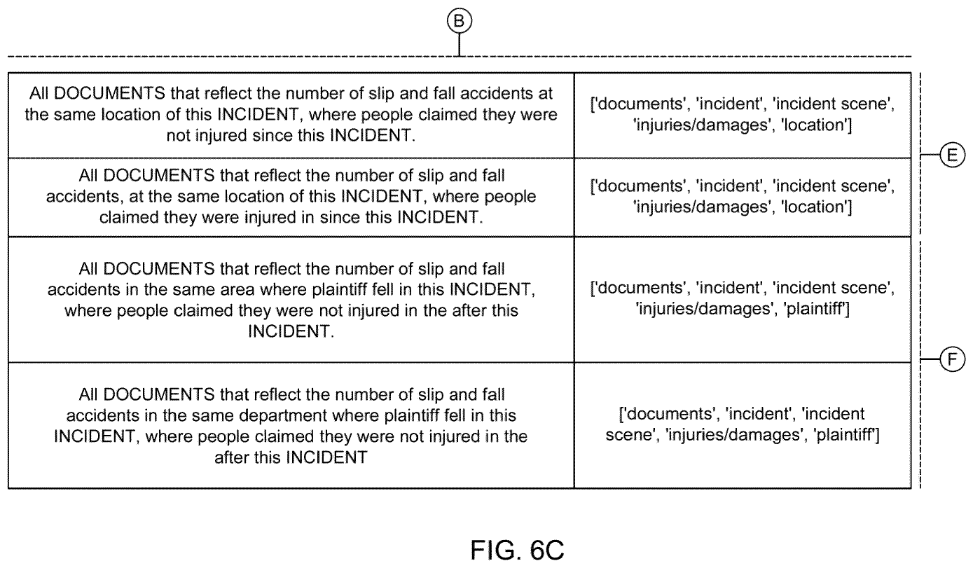

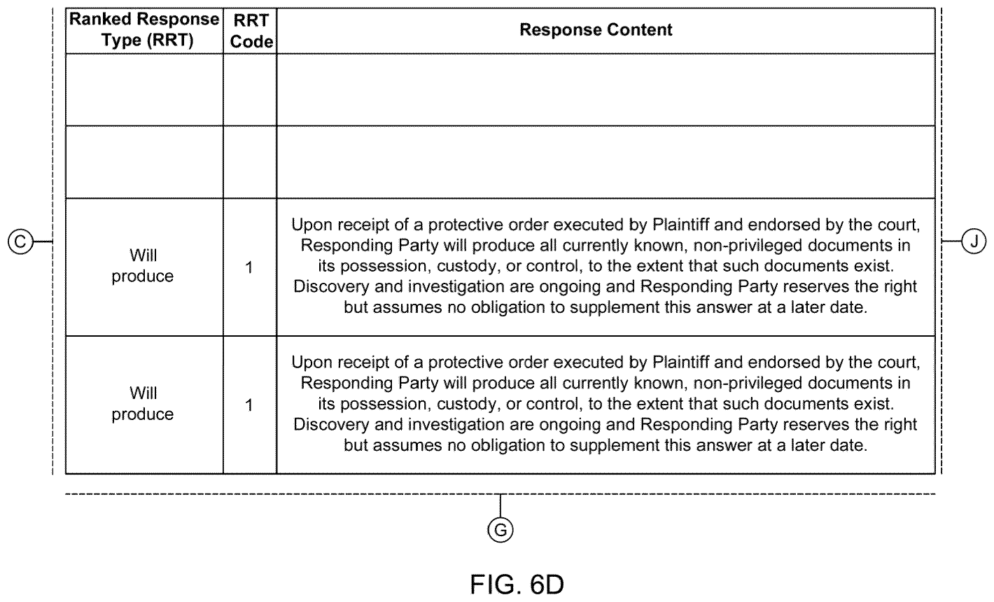

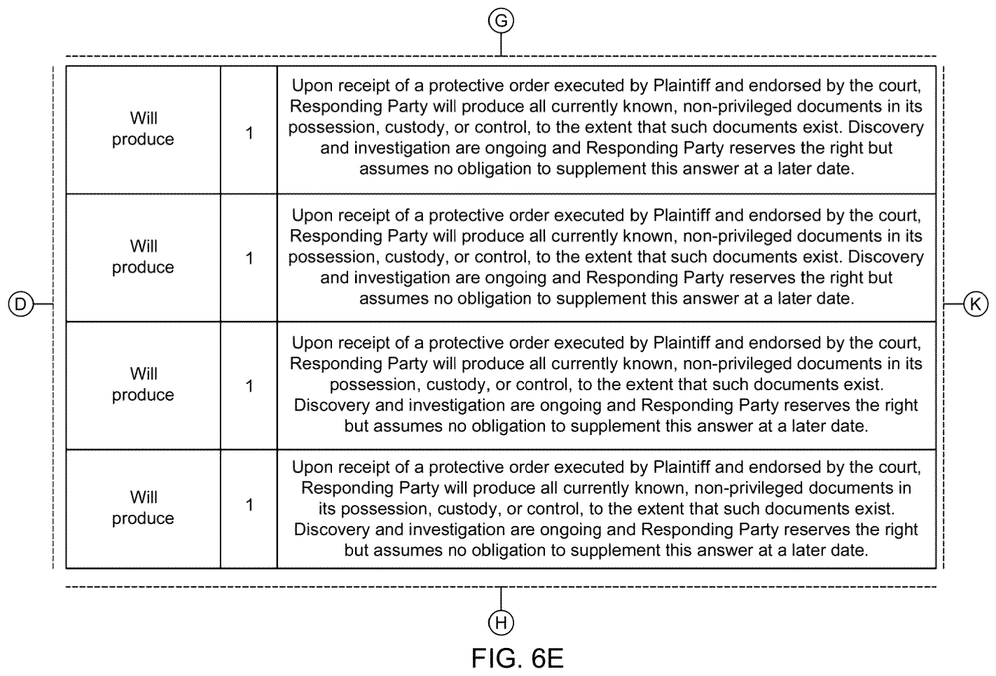

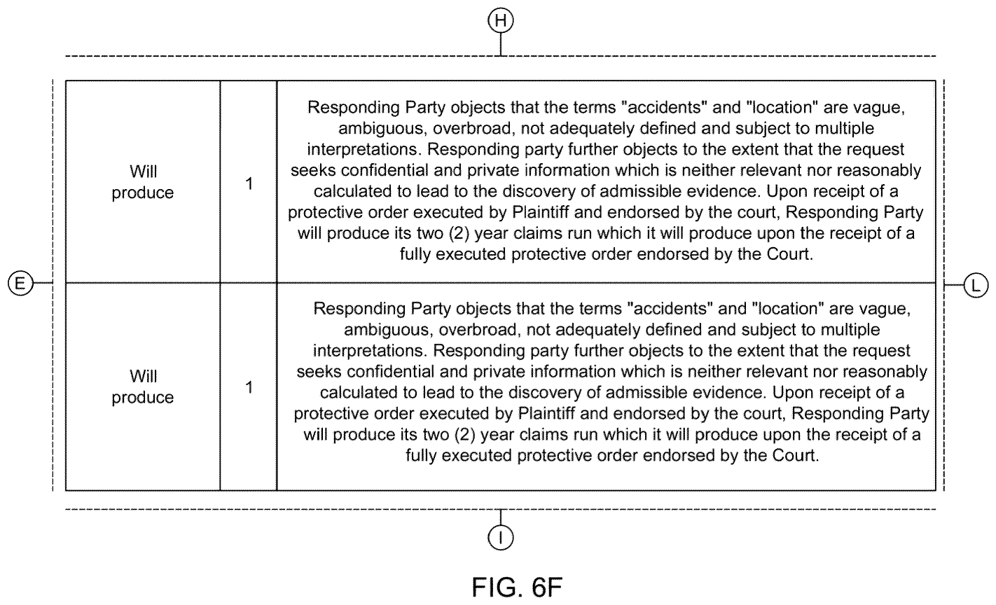

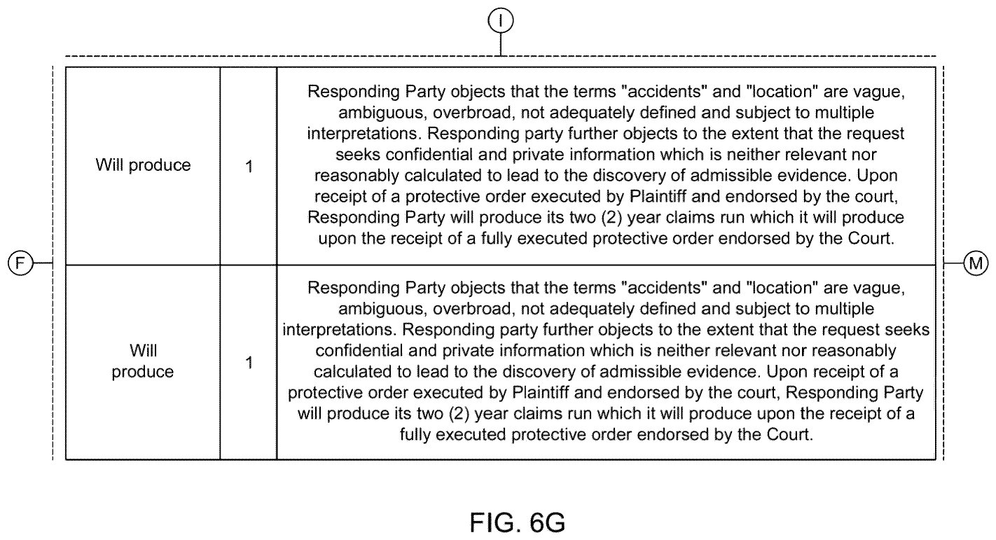

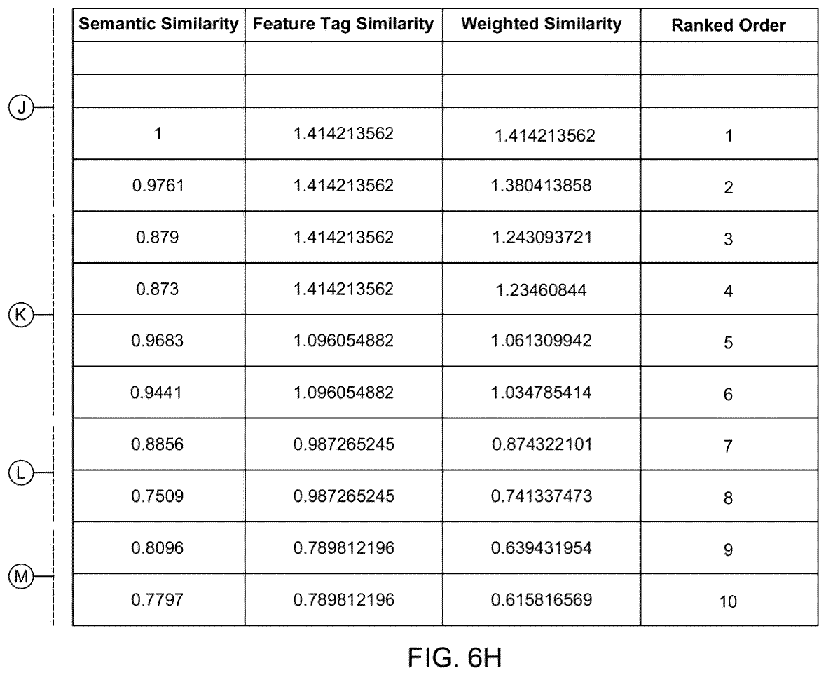

FIGS. 6A-6H illustrate computation of similarity scores in accordance with exemplary embodiments. FIGS. 6A-6H show an exemplary chart similar to the chart in FIGS. 5A-5I, but different contents of the requests are present along with different associated values of the various columns.

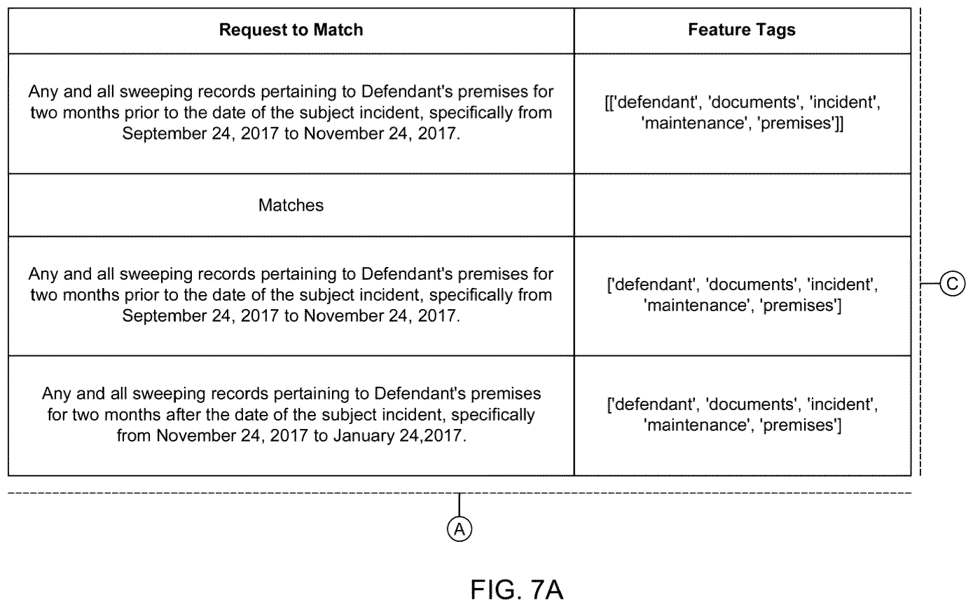

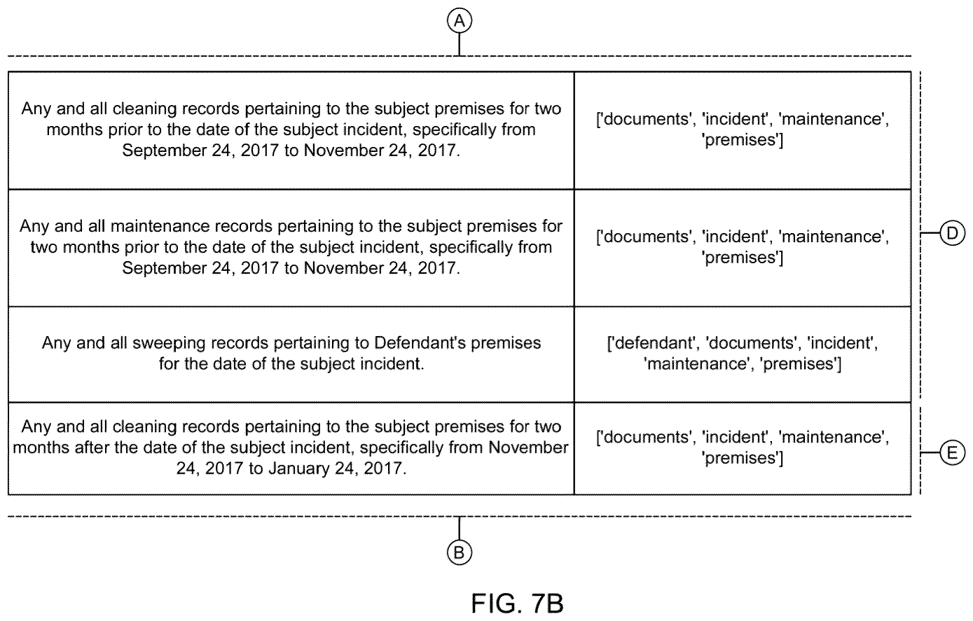

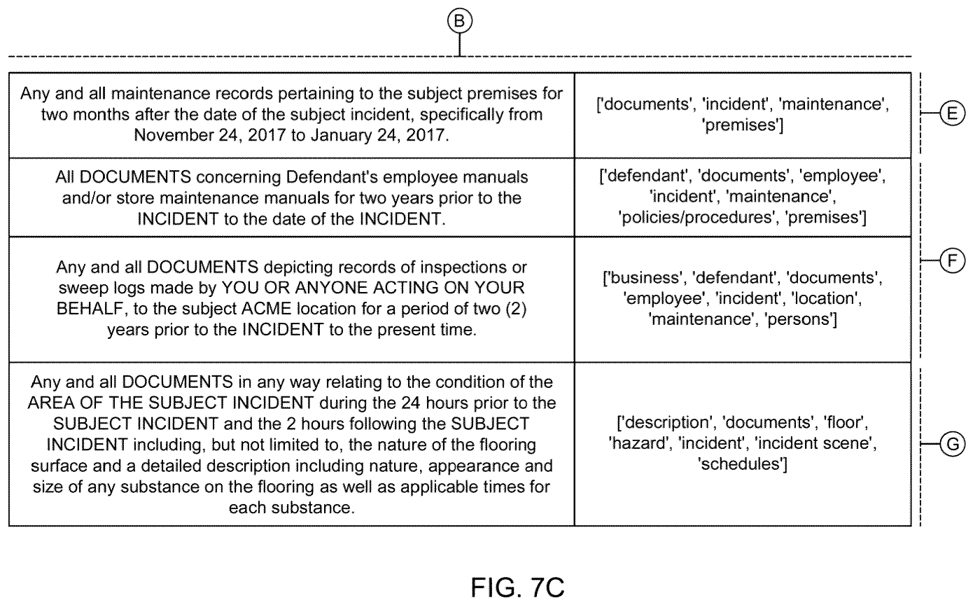

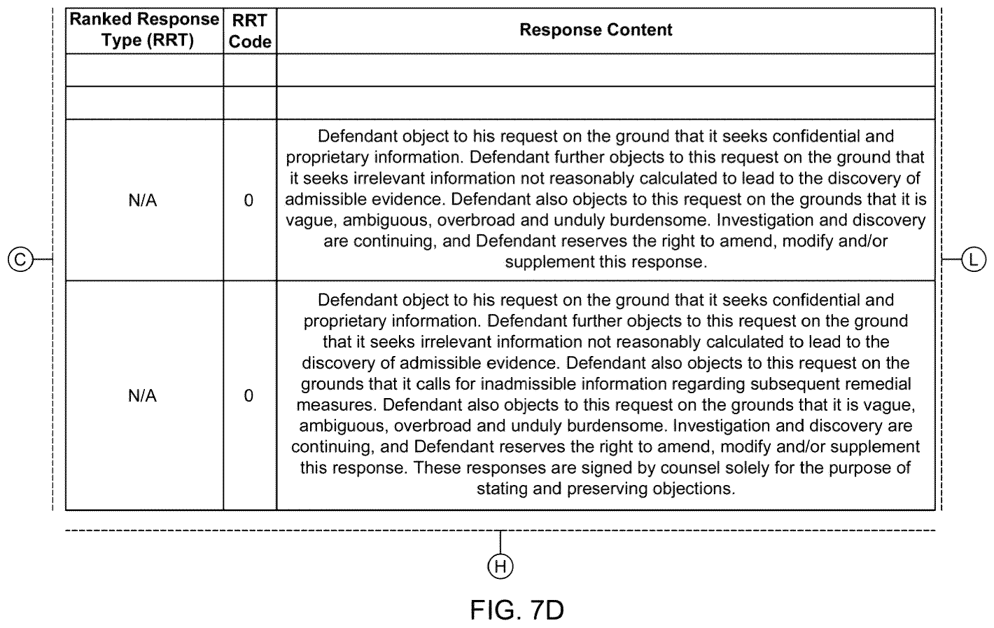

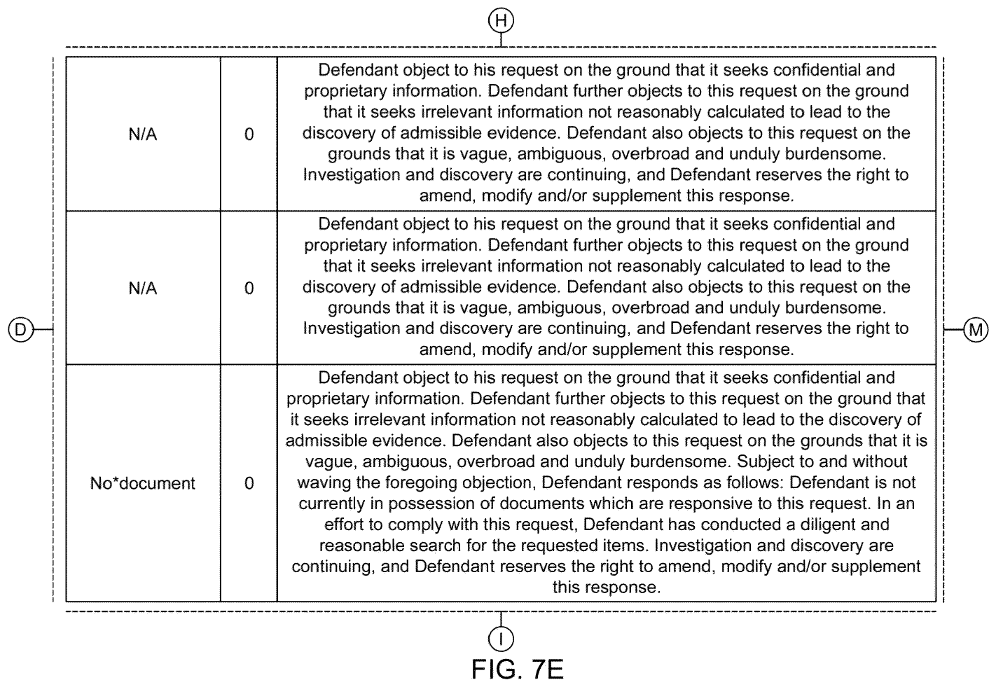

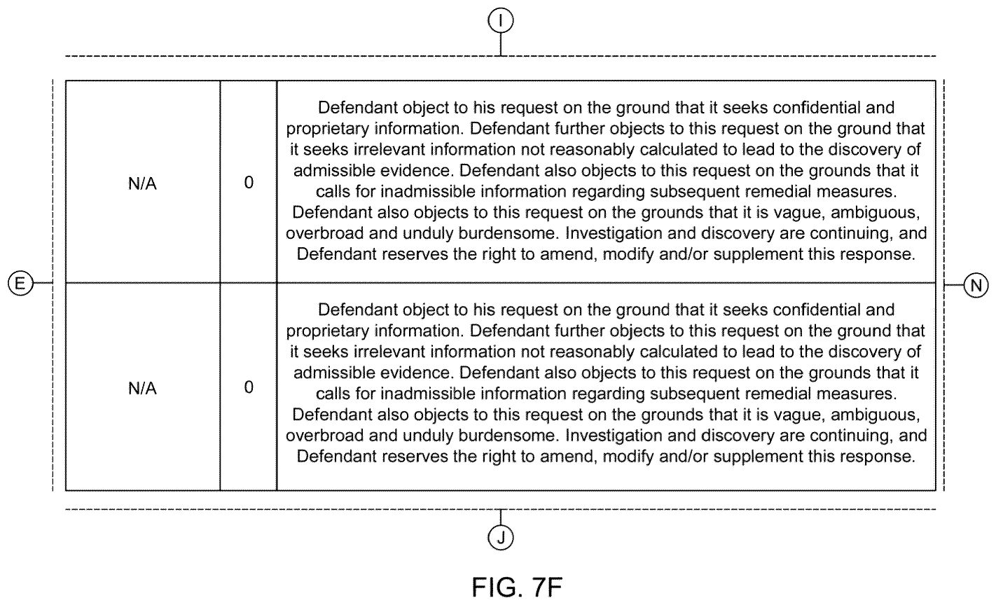

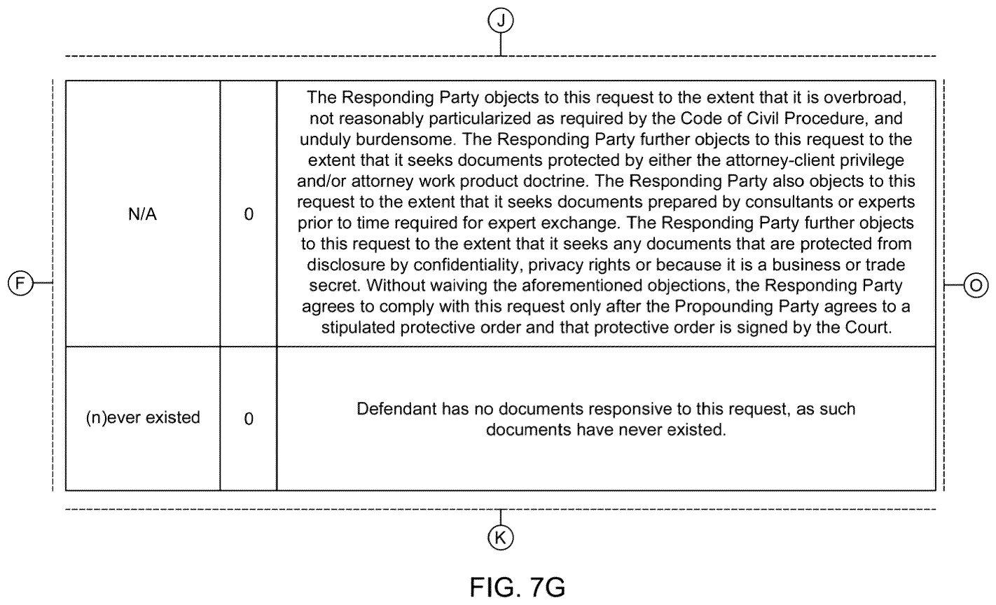

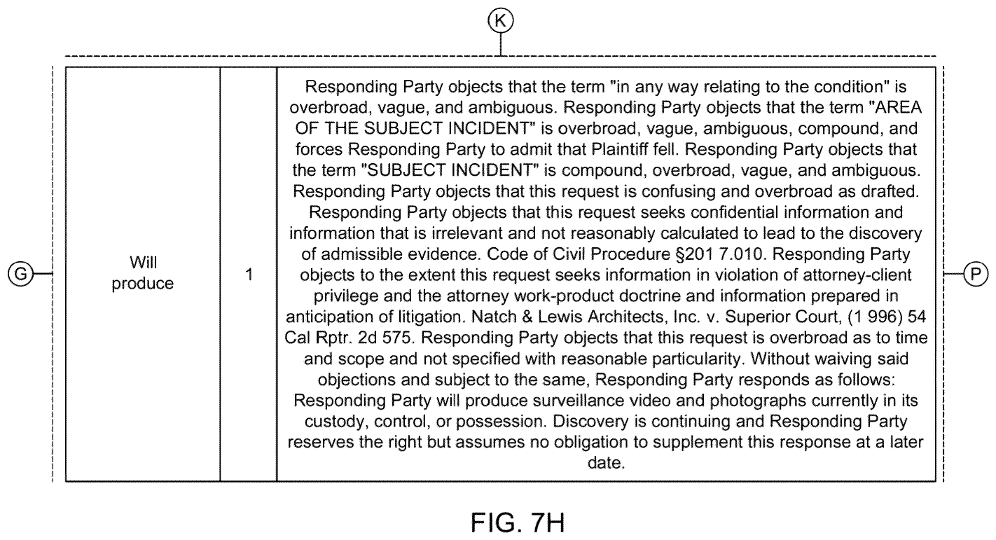

FIGS. 7A-7I illustrate computation of similarity scores in accordance with exemplary embodiments. FIGS. 7A-7I show an exemplary chart similar to the chart in FIGS. 5A-5I, but different contents of the requests are present along with different associated values of the various columns.

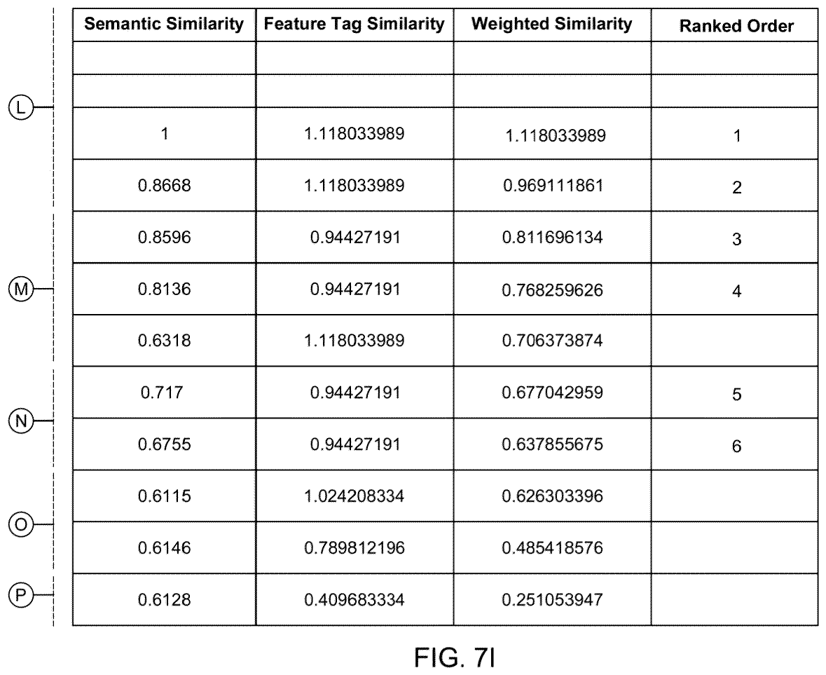

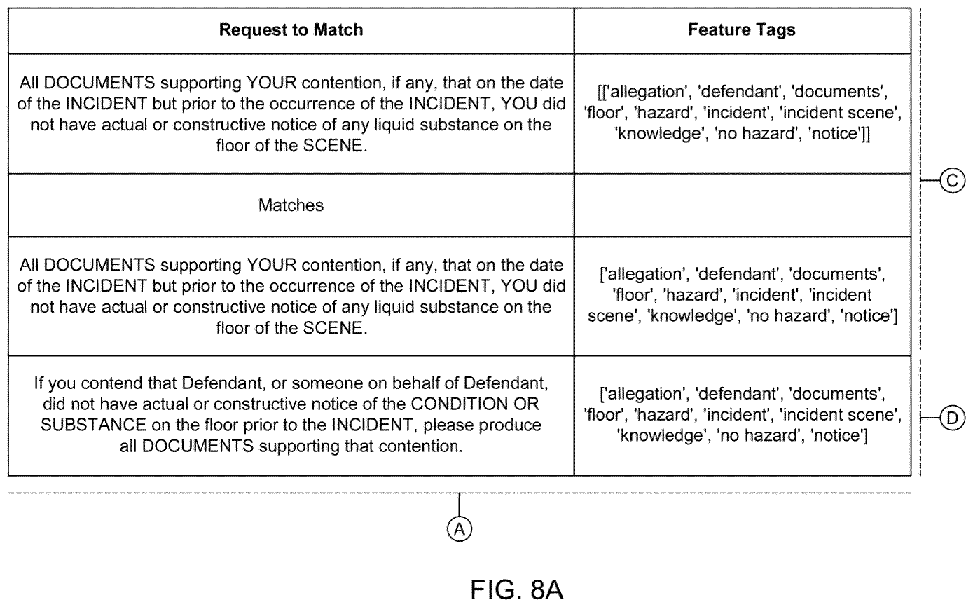

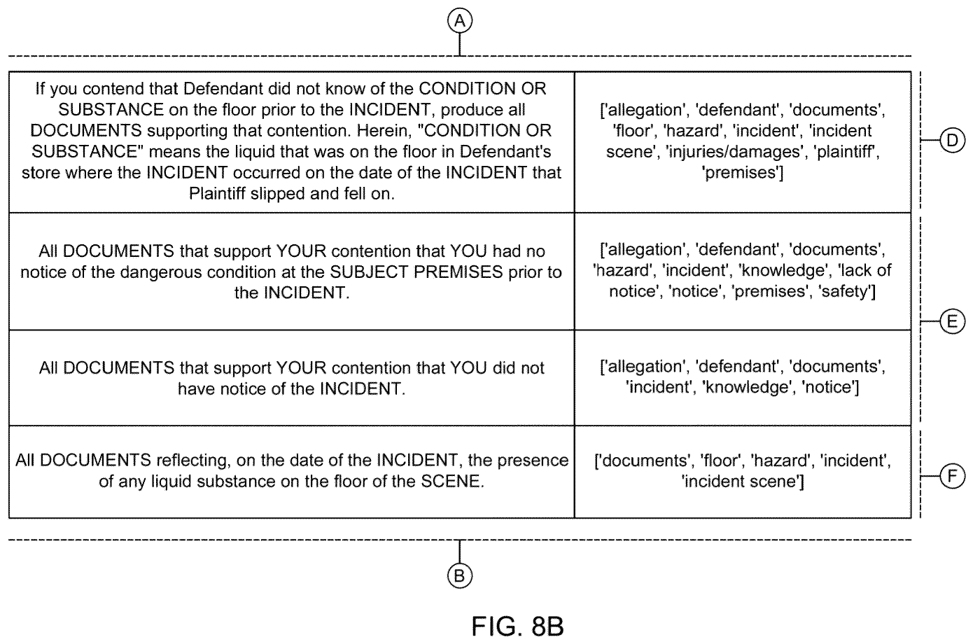

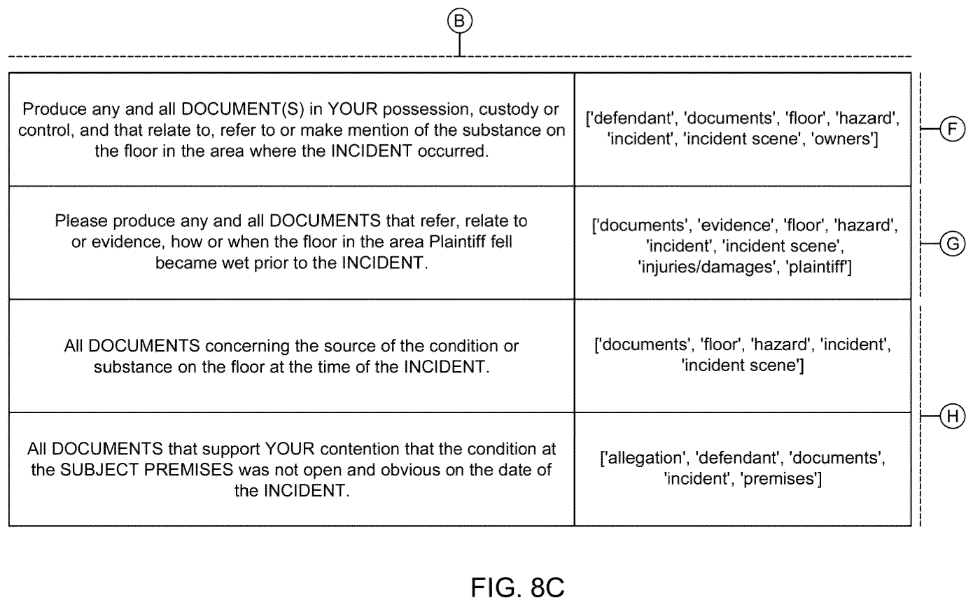

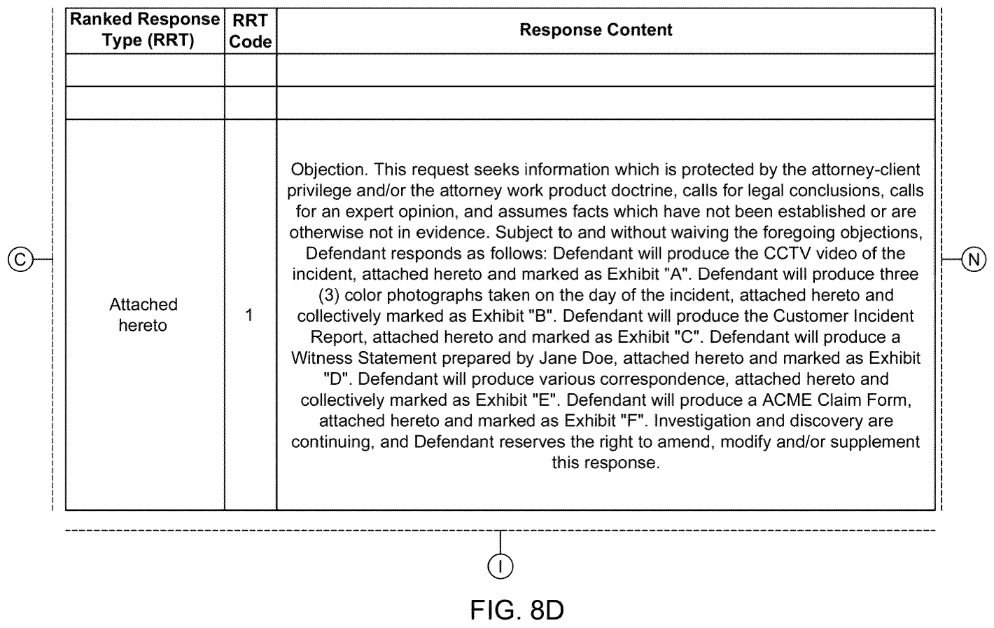

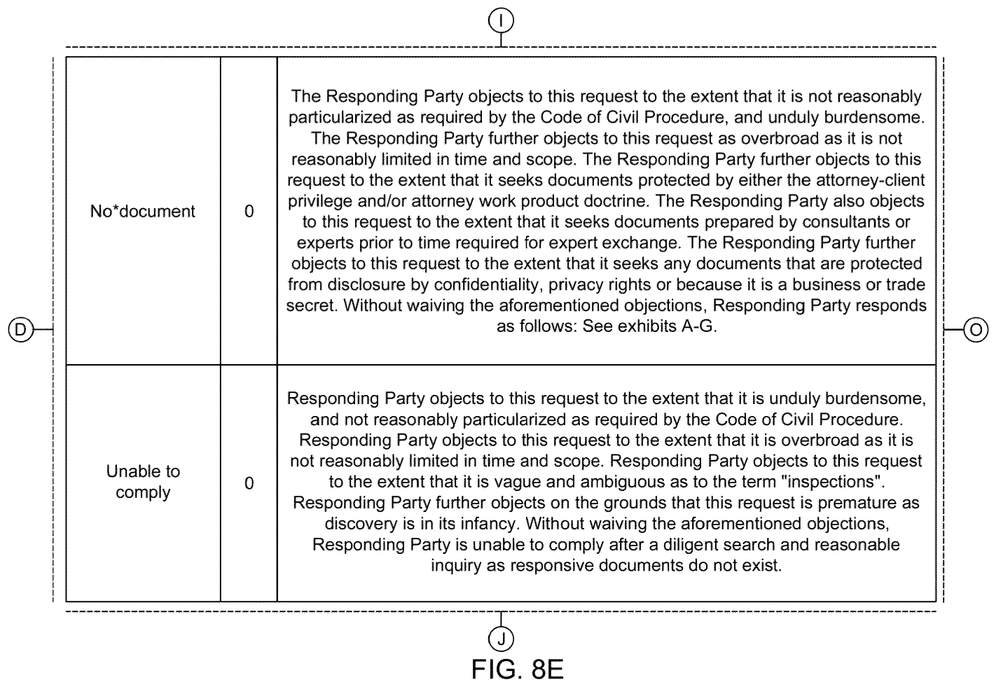

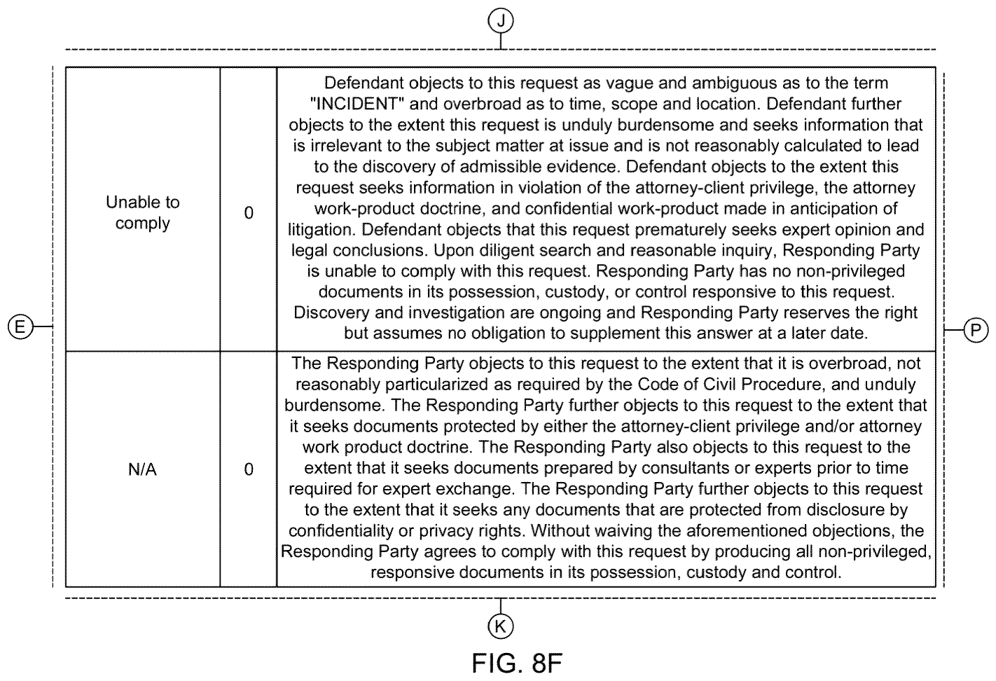

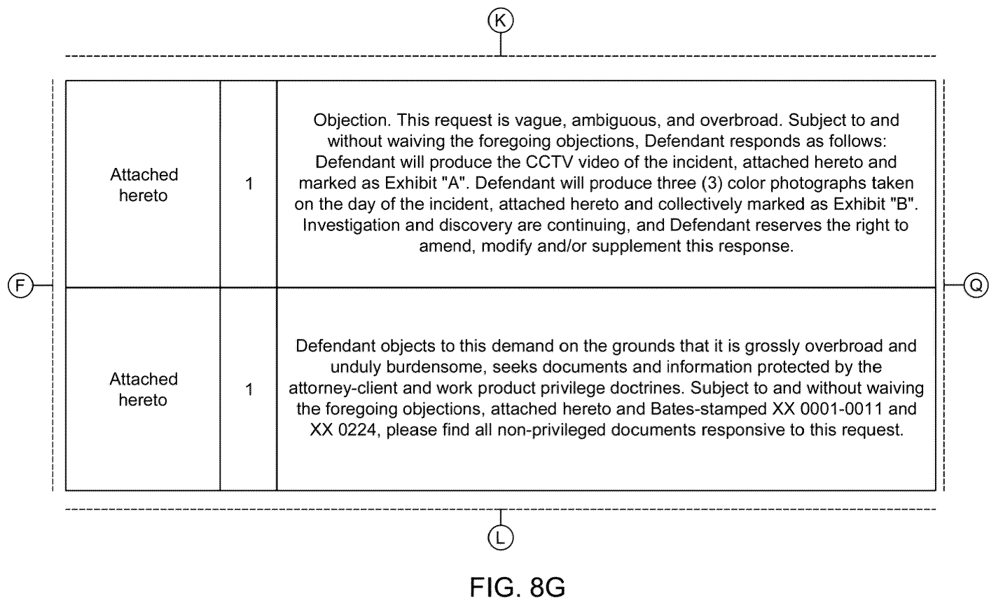

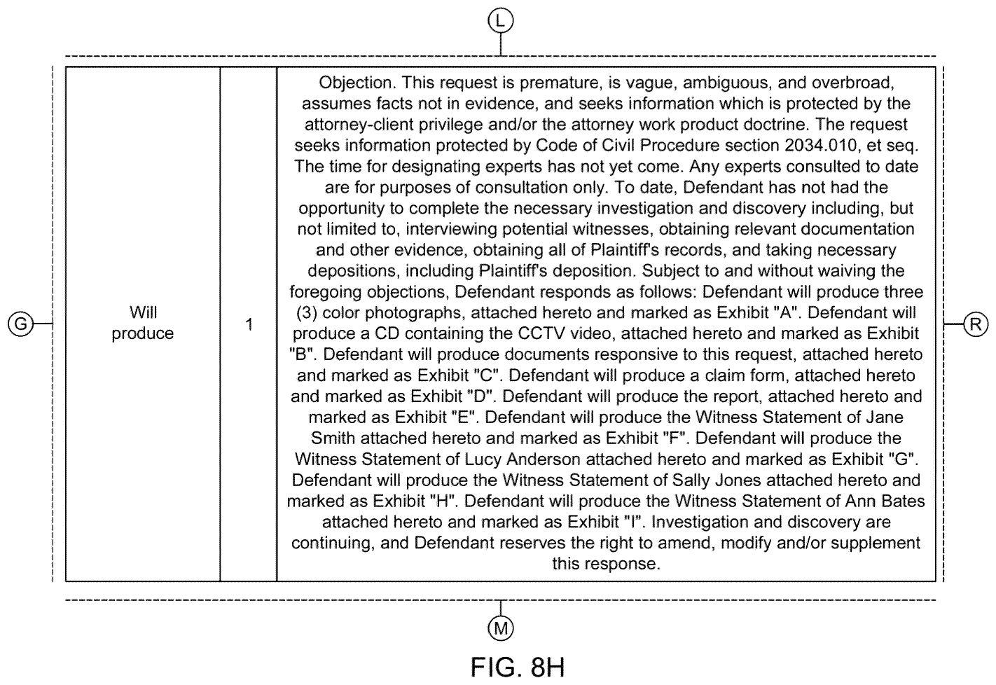

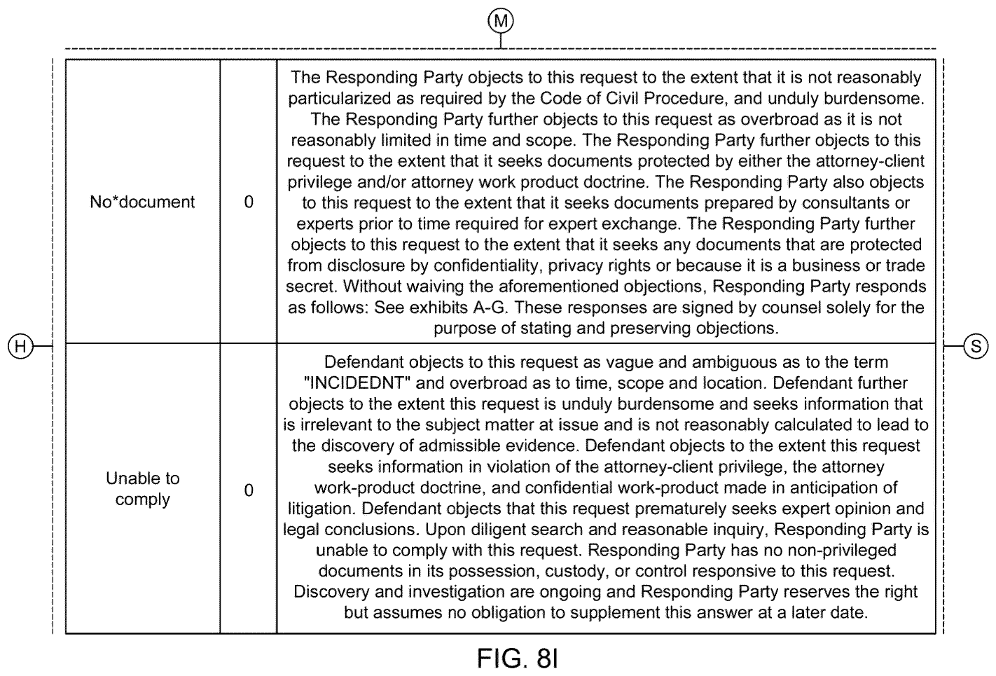

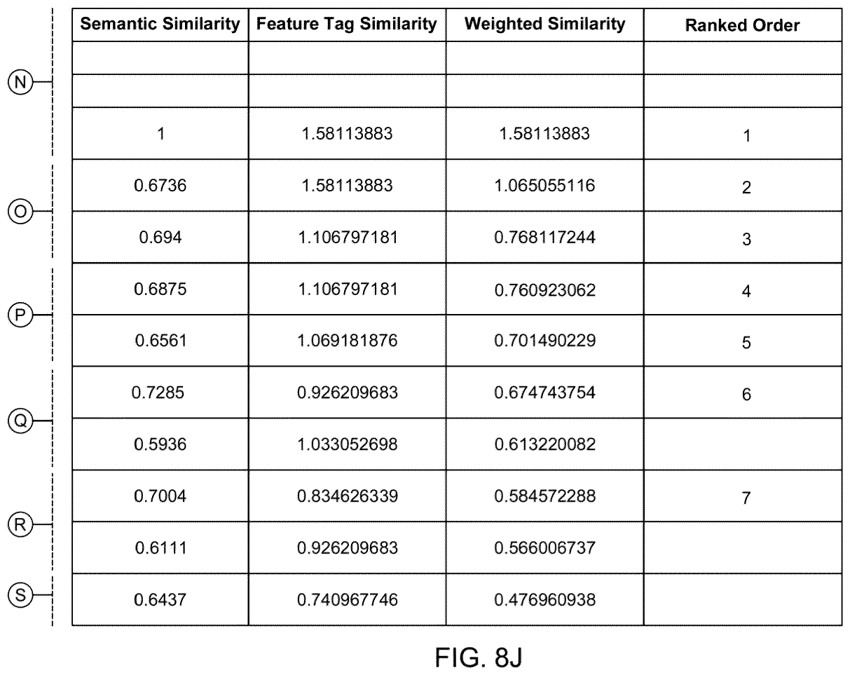

FIGS. 8A-8J illustrate computation of similarity scores in accordance with exemplary embodiments. FIGS. 8A-8J show an exemplary chart similar to the chart in FIGS. 5A-5I, but different contents of the requests are present along with different associated values of the various columns.

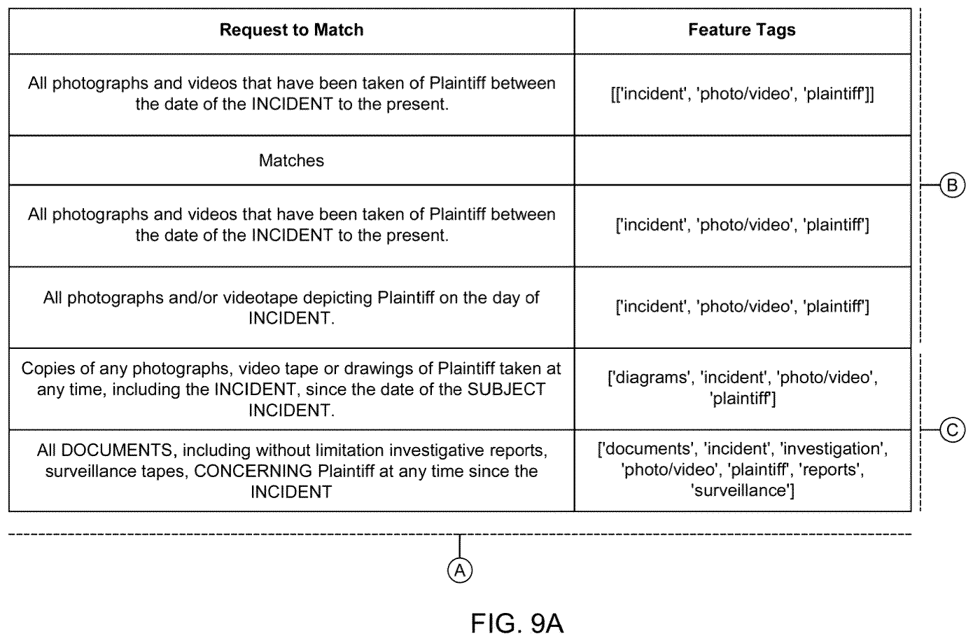

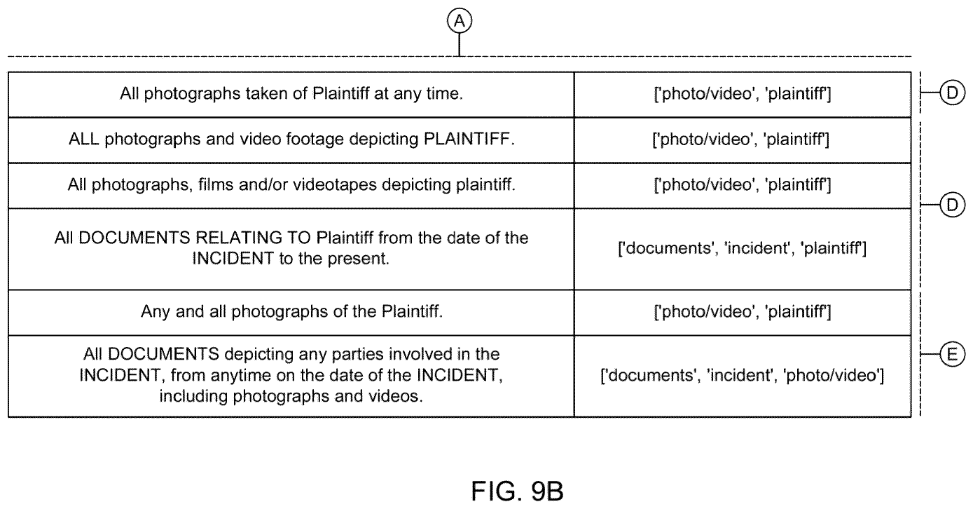

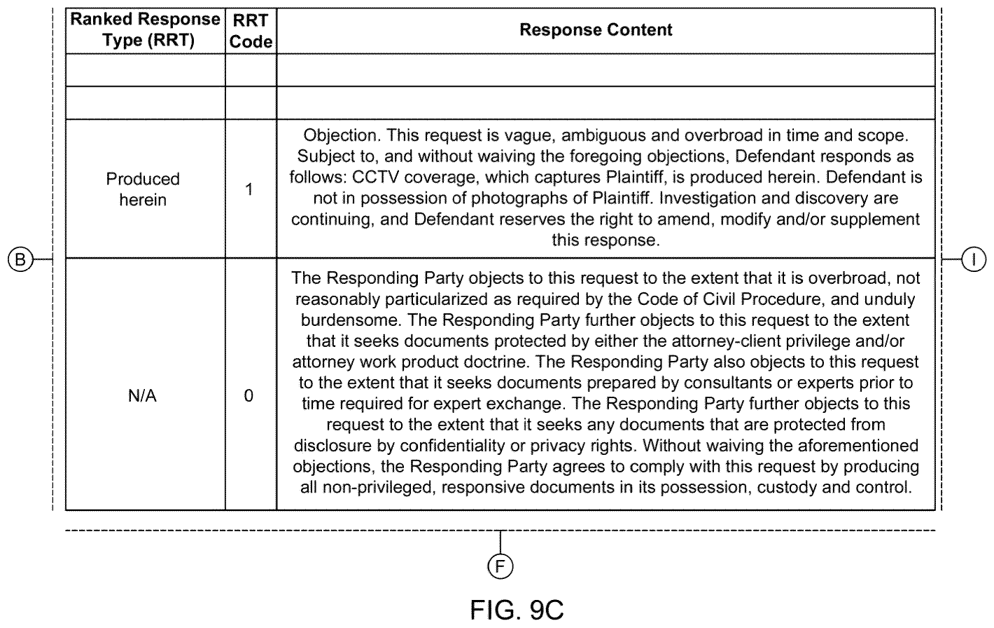

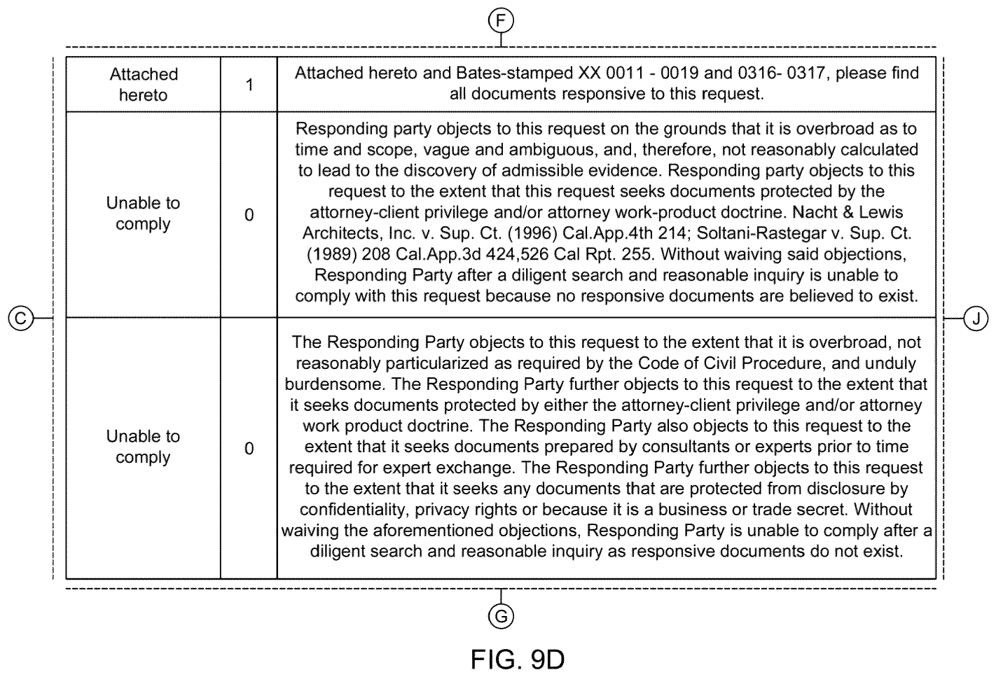

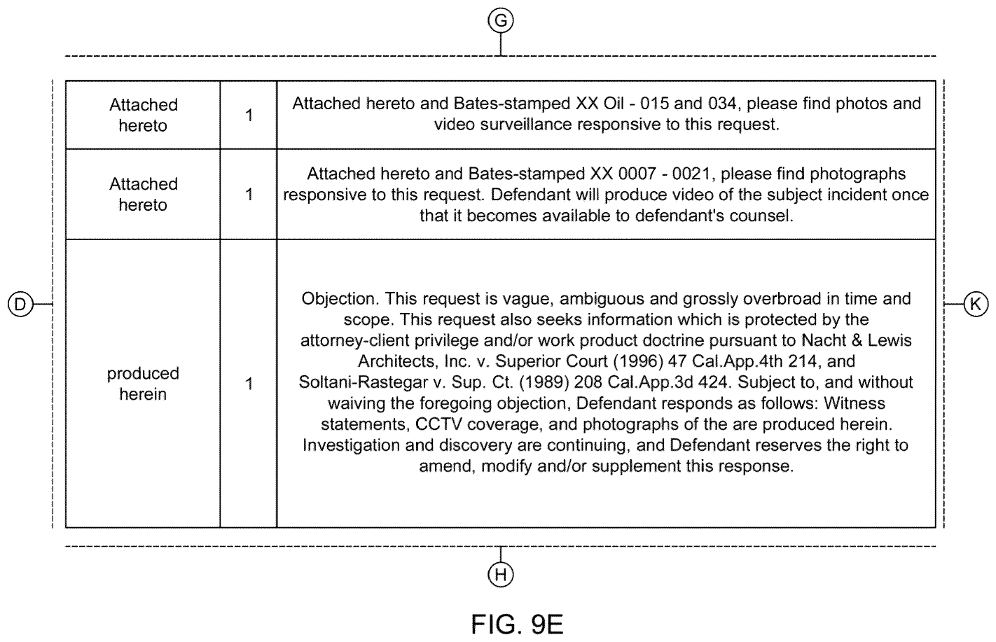

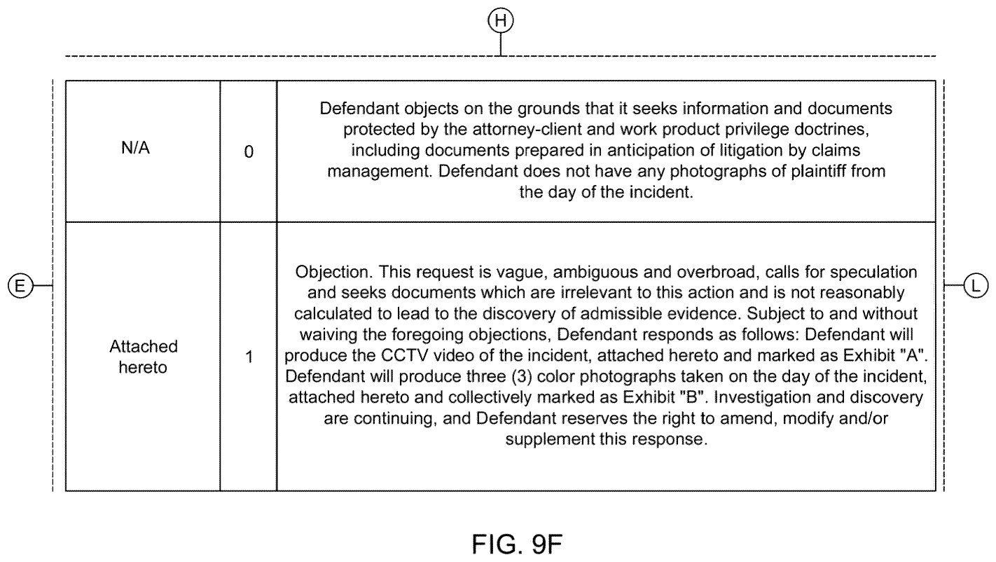

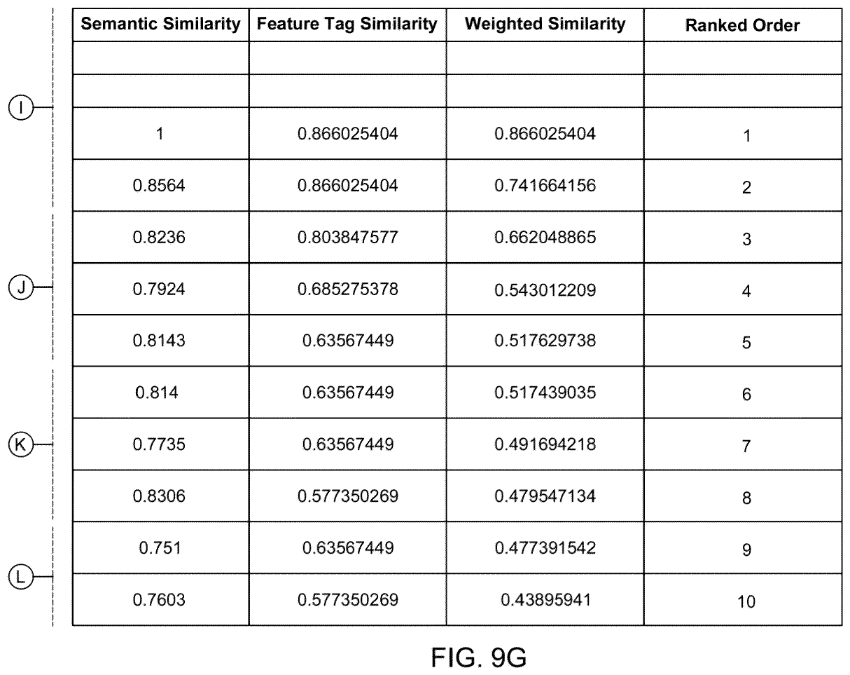

FIGS. 9A-9G illustrate computation of similarity scores in accordance with exemplary embodiments. FIGS. 9A-9G show an exemplary chart similar to the chart in FIGS. 5A-5I, but different contents of the requests are present along with different associated values of the various columns.

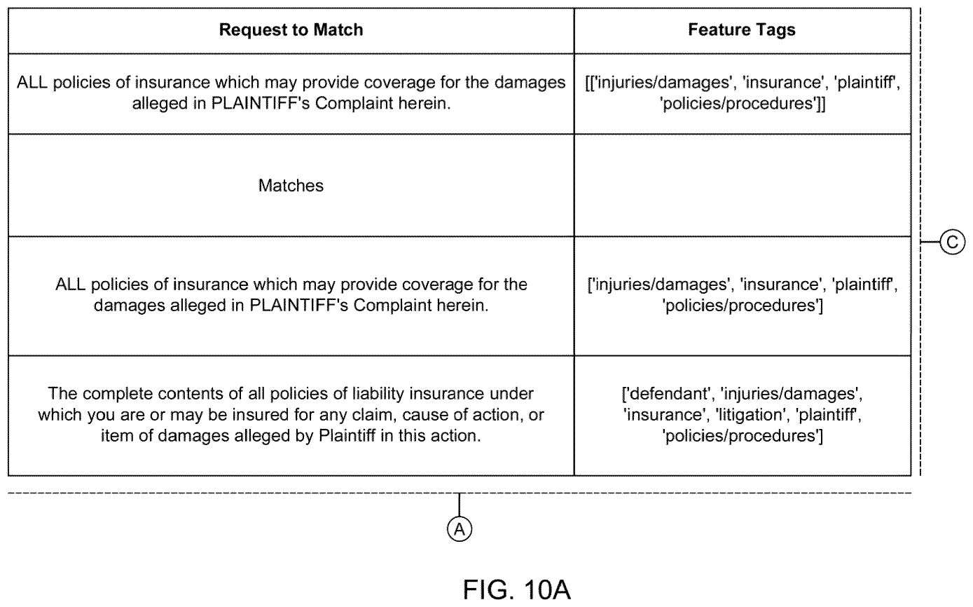

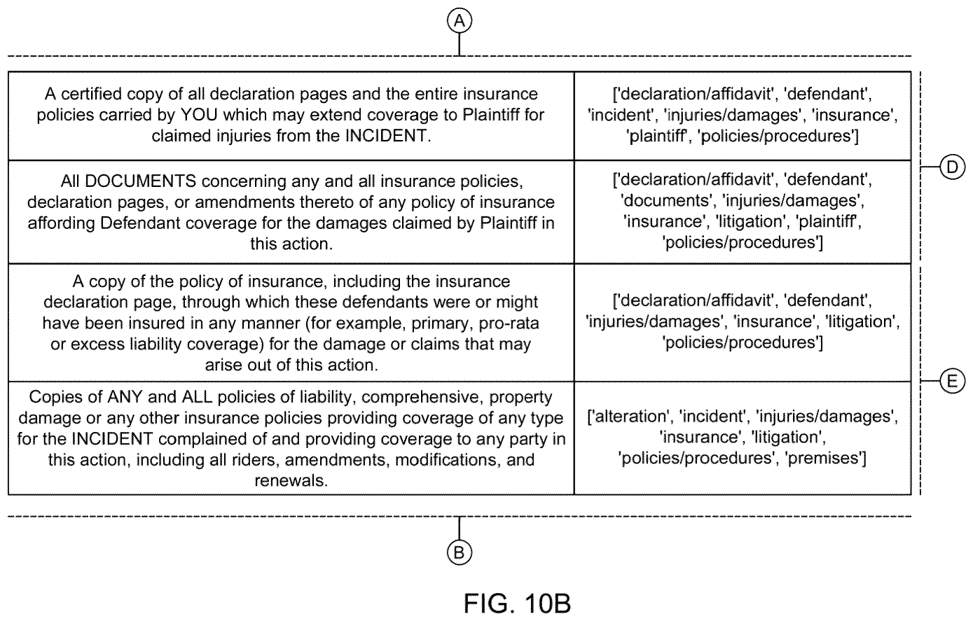

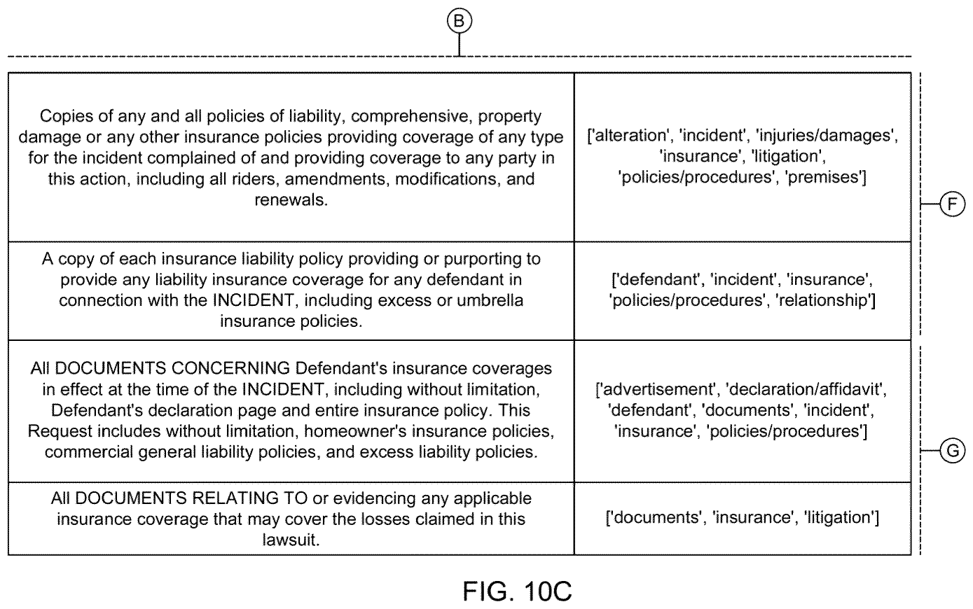

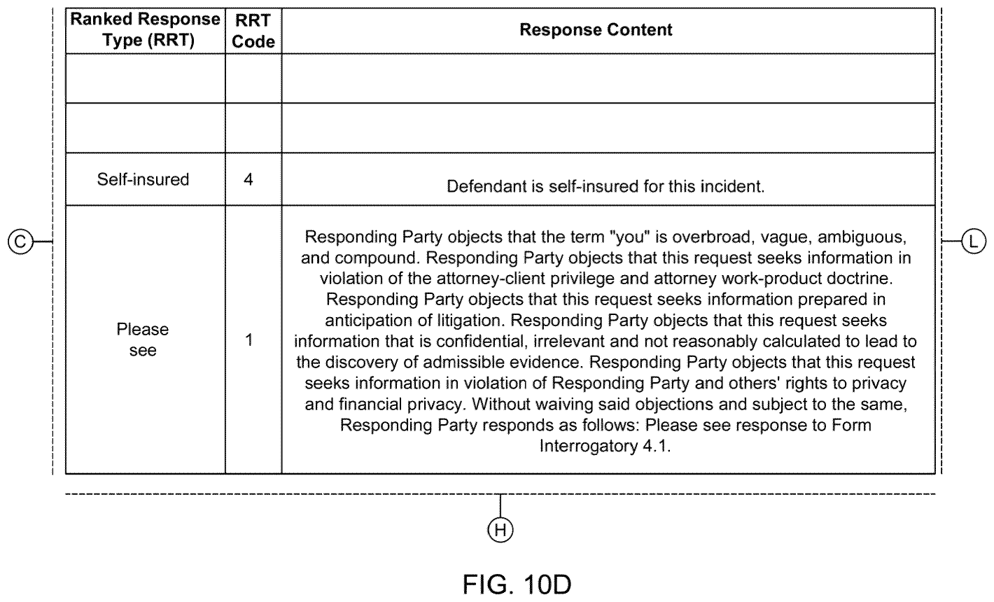

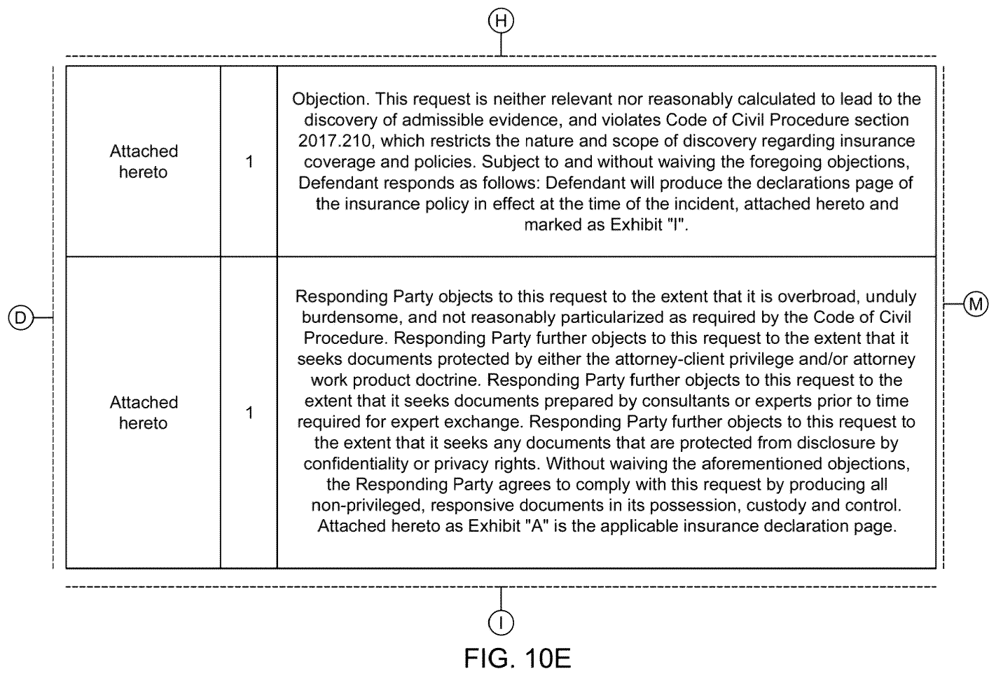

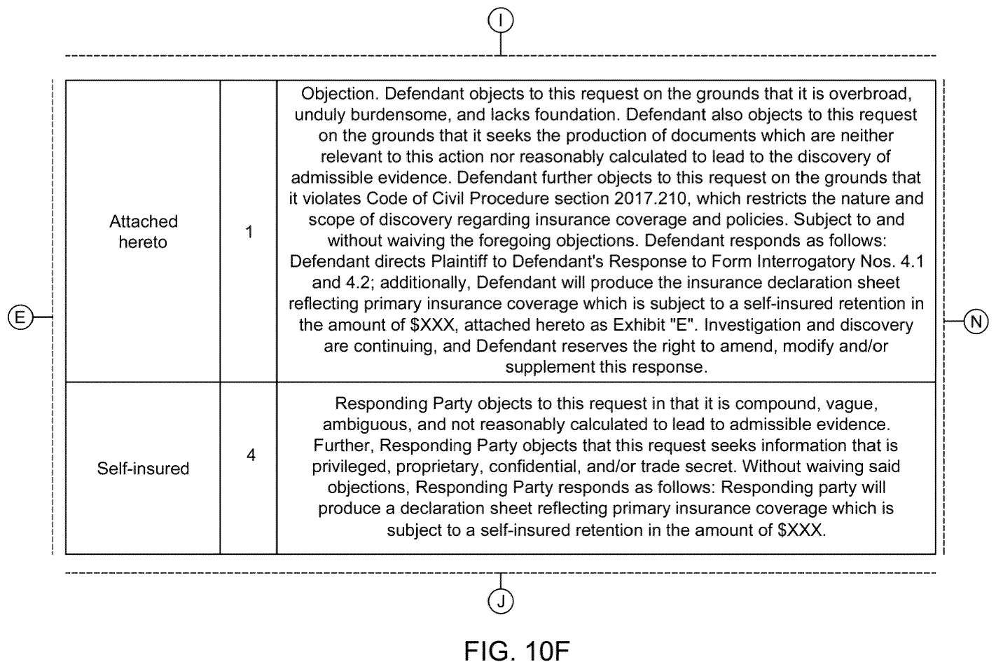

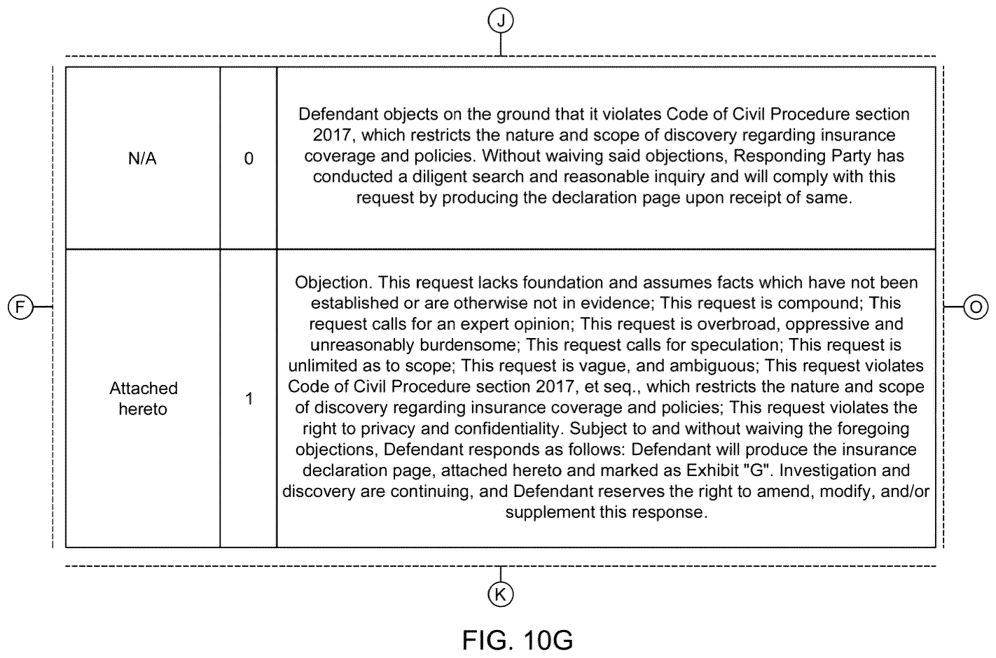

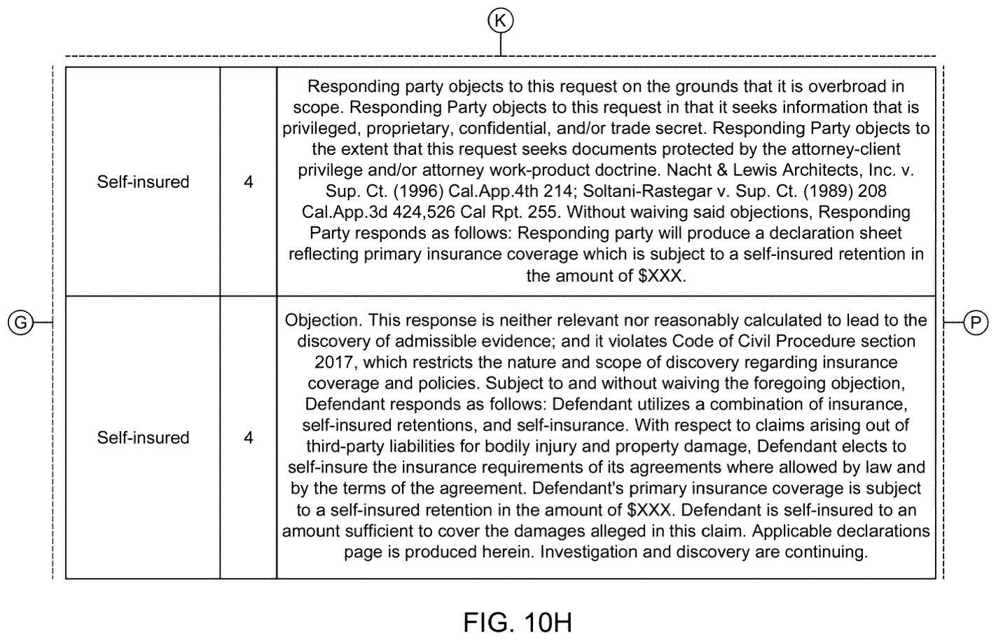

FIGS. 10A-10I illustrate computation of similarity scores in accordance with exemplary embodiments. FIGS. 10A-10I show an exemplary chart similar to the chart in FIGS. 5A-5I, but different contents of the requests are present along with different associated values of the various columns.

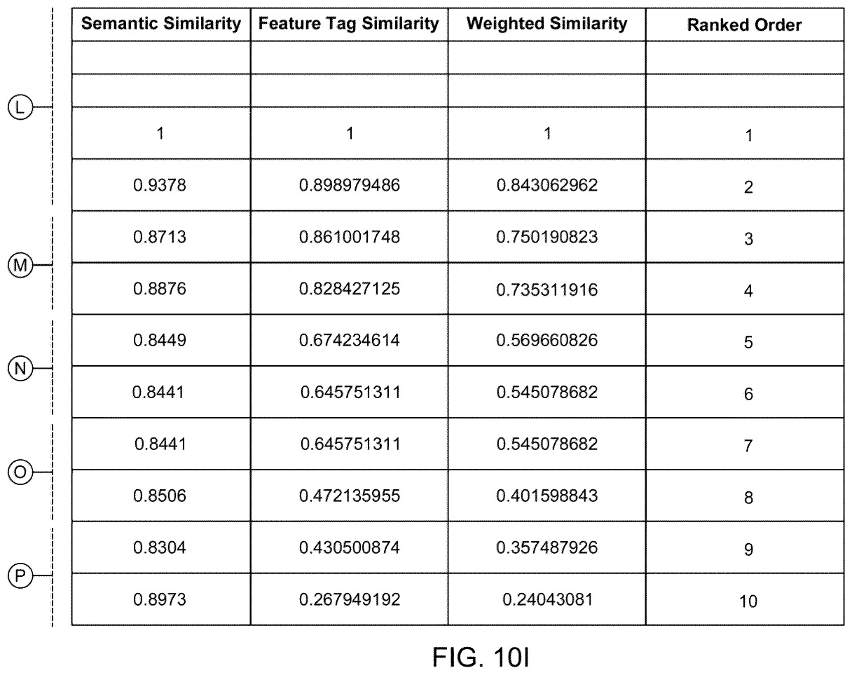

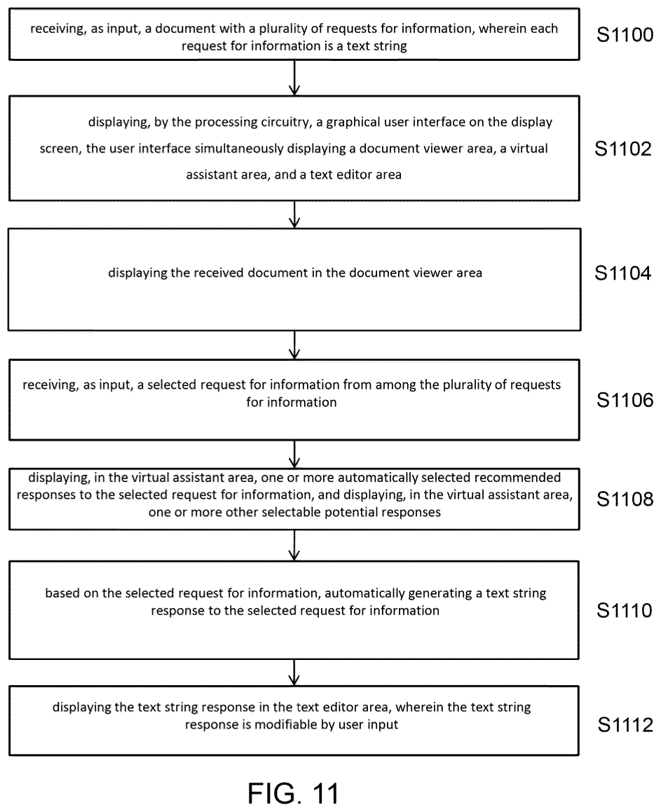

FIG. 11 is a flow diagram illustrating a document response production method in accordance with exemplary embodiments. The document response production method executes on a computing device including processing circuitry, a display screen, and a non-transitory computer-readable medium storing executable instructions which when executed by the processing circuitry perform the method. The method includes, in step S1100, receiving, as input, a document with a plurality of requests for information (e.g., the document can be an interrogatory, subpoena, request for admission, etc. In an exemplary embodiment, each request for information is a text string. For example, the text string can be a sentence made up of words, numbers, symbols, etc. Step S1102 includes displaying, by the processing circuitry, a user interface (e.g., GUI 100) on the display screen. In an exemplary embodiment, the user interface simultaneously displays a document viewer area 106, a virtual assistant area 104, and a text editor area 102/110. Step S1104 includes displaying the received document in the document viewer area 106. Step S1106 includes receiving, as input, a selected request for information from among the plurality of requests for information. For example, the user selects Request for Production No. 3 as in FIG. 1AA. Step S1108 includes displaying, in the virtual assistant area 104, one or more automatically selected recommended responses (e.g., grounds for objection) to the selected request for information. For example, as seen in FIG. 1AB, the recommended responses (e.g., objections) 112 are displayed in the virtual assistant area 104. Step S1108 also includes displaying, in the virtual assistant area 104, one or more other selectable potential responses (e.g., the other seven ground for objection shown in FIG. 1AB that are not currently selected but can be selected by the user). In step S1110, based on the selected request for information, automatically generating (for example, by the AI/ML engine) a text string response to the selected request for information. Step S1112 includes displaying the text string response in the text editor area 102. The text string response is modifiable by user input. FIG. 1AA, for example, shows the generated text string response (e.g., one or more sentences) displayed in text box 110.

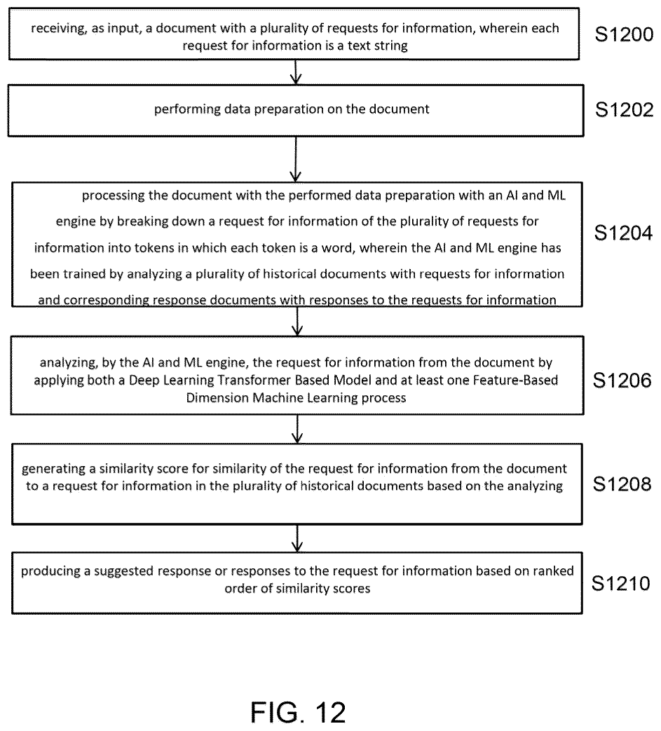

FIG. 12 is a flow diagram illustrating a document response production method in accordance with exemplary embodiments. The document response production method includes, in step S1200, receiving, as input, a document with a plurality of requests for information. For example, see step S410 of FIG. 3F. In an exemplary embodiment, each request for information is a text string. Step S1202 includes performing data preparation on the document. For example, the data preparation described/shown at step S412 of FIG. 3G can be performed on the request document. Step S1204 includes processing the document with the performed data preparation with an AI and ML engine by breaking down a request for information of the plurality of requests for information into tokens in which each token is a word. For example, see step S414 of FIG. 3H. The AI and ML engine has been trained by analyzing a plurality of historical documents with requests for information and corresponding response documents with responses to the requests for information. For example, the training steps of FIGS. 3A-3E. Step S1206 includes analyzing, by the AI and ML engine, the request for information from the document by applying both a Deep Learning Transformer Based Model and a Feature-Based Dimension Machine Learning process. In an exemplar embodiment, the Deep Learning Transformer Based Model and a Feature-Based Dimension Machine Learning process as described/shown in one or more of FIGS. 3H-3I. Step S1208 includes generating a similarity score for similarity of the request for information from the document to a request for information in the plurality of historical documents based on the analyzing. In an exemplary embodiment, a composite similarity score as described/shown in FIGS. 5A-10I can be generated by the system (e.g., the AI and ML engine). It is also possible that one of the semantic similarity scores and the feature tag similarity score can be generated by the system (e.g., the AI and ML engine). Step S1210 includes producing a suggested response or responses to the request for information (e.g., the response in text box 110) based on ranked order of similarity scores. See for example, steps S418 and S420, and FIGS. 5A-5I.

In an exemplary embodiment, the document is a request for production, subpoena, an interrogatory, a demand letter, or a complaint for a legal proceeding.

In an exemplary embodiment, the Deep Learning Transformer Based Model that is applied uses one or more of Bidirectional Encoder Representations from Transformers (BERT), ROBERTa, word embeddings, and Word Movers Distance (WMD).

In an exemplary embodiment, the Feature-Based Dimension Machine Learning process includes one or more of clustering, a k-nearest neighbors (KNN) algorithm, agglomerative clustering, a support vector machine (SVM) method, logistic regression, Naive Bayes, decision trees, conditional random fields (CRF), and bi-directional long-short term memory (Bi-LSTM).

In an exemplary embodiment, the training of the AI/ML engine includes: receiving the plurality of historical documents with requests for information and the corresponding response documents with the responses to the requests for information. See, for example, step S402 of FIG. 3A in which the user uploads pairs of requests and responses. The training of the AI engine can also include sorting the plurality of historical documents with requests for information and the corresponding response documents with the responses to the requests for information by document type (e.g., interrogatory, subpoena, demand letter, etc.); removing stop words (e.g., of, the, etc.) from the plurality of historical documents with requests for information and the corresponding response documents with the responses to the requests for information by document type; NER replacement of certain terms or words in the plurality of historical documents with requests for information and the corresponding response documents with the responses to the requests for information by document type; and performing active learning by the user to backpropagate data regarding the plurality of historical documents with requests for information and sorting the corresponding response documents with the responses to the requests for information by document type. For example, see step S404 of FIG. 3B.

In an exemplary embodiment, the training of the AI/ML engine includes identifying and evaluating the tokens. For example, see step S406 of FIG. 3C.

In an exemplary embodiment, the training of the AI/ML engine includes adding a metadata field to the plurality of historical documents with requests for information and the corresponding response documents.

In an exemplary embodiment, the training of the AI/ML engine includes pairing each historical request for information with its corresponding historical response, and assigning an identifier to each pair. For example, the identifier can be the same or similar to the Request ID of FIG. 3E.

In an exemplary embodiment, a Deep Learning Transformer Based Model similarity score (e.g., the semantic similarity score of FIG. 51) is generated for the Deep Learning Transformer Based Model and a Feature-Based Dimension Machine Learning process similarity score (e.g., the Feature Tag similarity score of FIG. 51) is generated for the Feature-Based Dimension Machine Learning process.

In an exemplary embodiment, the similarity score (e.g., the composite similarity score, third column of FIG. 51) is based on the Deep Learning Transformer Based Model similarity score (e.g., the semantic similarity score of FIG. 51) and the Feature-Based Dimension Machine Learning process similarity score (e.g., the Feature Tag similarity score of FIG. 51).

In an exemplary embodiment, a non-transitory computer-readable storage medium storing thereon executable instructions which when executed by processing circuitry causes the processing circuitry to perform a document response production method. The document response production method includes receiving, as input, a document with a plurality of requests for information, wherein each request for information is a text string; performing data preparation on the document; and processing the document with the performed data preparation with an AI/ML engine by breaking down a request for information of the plurality of requests for information into tokens in which each token is a word. The AI/ML engine has been trained by analyzing a plurality of historical documents with requests for information and corresponding response documents with responses to the requests for information. The method also includes analyzing, by the AI/ML engine, the request for information from the document by applying both a Deep Learning Transformer Based Model and a Feature-Based Dimension Machine Learning process; generating a similarity score for similarity of the request for information from the document to a request for information in the plurality of historical documents based on the analyzing; and producing a suggested response or responses to the request for information based on a highest similarity score.

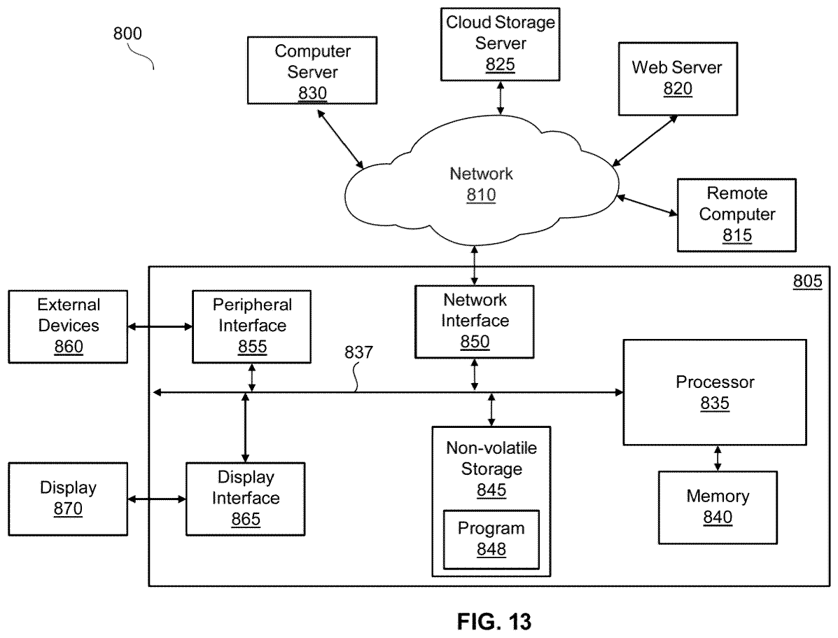

In an exemplary embodiment, a system (e.g., a system including components of FIG. 13) is provided for performing production of a document. The system includes processing circuitry; and a non-transitory computer-readable storage medium. The non-transitory computer-readable storage medium storing thereon executable instructions which when executed by the processing circuitry causes the processing circuitry to: receive, as input, a document with a plurality of requests for information, wherein each request for information is a text string; perform data preparation on the document; process the document with the performed data preparation with an AI/ML engine by breaking down a request for information of the plurality of requests for information into tokens in which each token is a word, wherein the AI/ML engine has been trained by analyzing a plurality of historical documents with requests for information and corresponding response documents with responses to the requests for information; analyze, by the AI/ML engine, the request for information from the document by applying both a Deep Learning Transformer Based Model and a Feature-Based Dimension Machine Learning process; generate a similarity score for similarity of the request for information from the document to a request for information in the plurality of historical documents based on the analyzing; and produce a suggested response or responses to the request for information based on a highest similarity score.

FIG. 13 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C#, Elixir or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 8 is a functional block diagram illustrating a networked system 800 of one or more networked computers and servers. In an embodiment, the hardware and software environment illustrated in FIG. 8 may provide an exemplary platform for implementation of the software and/or methods according to the present disclosure.

Referring to FIG. 8, a networked system 800 may include, but is not limited to, computer 805, network 810, remote computer 815, web server 820, cloud storage server 825 and computer server 830. In some embodiments, multiple instances of one or more of the functional blocks illustrated in FIG. 8 may be employed.

Additional detail of computer 805 is shown in FIG. 8. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

The methods discussed herein can employ deep learning algorithms which are described in academic literature as Recursive Neural Tensor Networks or as Recurrent Neural Networks (RNNs) with either Long Short-Term Memory (LSTM) or Gated Recurrent Units (GRUs). Those of skill in the arts will appreciate that use of other algorithms, including those which are now open-sourced, are contemplated.

Advantages of the disclosed system over the current method of producing legal documents with pre-existing templates includes greater efficiency as the system automatically produces and inserts the response in reply to a request, the automatic production of a response also results in cost savings as the time of an attorney or staff member working on the production of a legal document is reduced. Consistency is improved across an organization as the attorneys and staff are using the same system to create the legal documents. The disclosed system also improves/increases the functioning of the computing device as one user interface is able to simultaneously display all information that is needed for producing the document (e.g., the document viewer area, a virtual assistant area, and a text editor area). As the user interface displays all the information in one screen and the text editor is what you see is what you get, a user does not need to waste time by toggling and opening multiple screens when looking at historical or sample documents. Thus, multiple programs and multiple windows consuming a large amount of the computing device's memory is not required. This also results in less storage space (e.g., hard drive space) being used as well. As a result, the computing device will run more efficiently and use less power and generate less heat.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

Obviously, numerous modifications and variations of the present disclosure are possible in light of the above teachings. It is therefore to be understood that within the scope of the appended claims, the disclosure may be practiced otherwise than as specifically described herein.

What is claimed is:

1. A document response production method executing on a computing device including processing circuitry, a display screen, and a non-transitory computer-readable medium storing executable instructions which when executed by the processing circuitry perform the method, the method comprising:
receiving, as input via upload, a digital file of a document with a plurality of requests for information, wherein each request for information is a text string, and the document is a subpoena, an interrogatory, a demand letter, or a complaint for a legal proceeding;
displaying, by the processing circuitry, a user interface on the display screen;
displaying the received document or other source materials in the user interface;
receiving, as input, a selected request for information from among the plurality of requests for information;
displaying, in the user interface, one or more automatically selected recommended responses to the selected request for information, and displaying, in the user interface, one or more other selectable potential responses;
based on the selected request for information, automatically generating a text string response to the selected request for information by an artificial intelligence and machine learning (AI and ML) engine that has been trained by analyzing a plurality of sets of historical documents with requests for information and corresponding response documents with responses to the requests for information, wherein the historical documents include a subpoena, an interrogatory, a demand letter, or a complaint for a legal proceeding; and
displaying the text string response in the user interface, wherein the text string response is modifiable by user input.

2. The method of claim 1, wherein the one or more automatically selected recommended responses are determined by the AI and ML engine.

3. A non-transitory computer-readable storage medium storing thereon executable instructions which when executed by processing circuitry causes the processing circuitry to perform a document response production method, the document response production method comprising:
receiving, as input via upload, a digital file of a document with a plurality of requests for information, wherein each request for information is a text string, and the document is a subpoena, an interrogatory, a demand letter, or a complaint for a legal proceeding;
displaying a user interface on a display screen;
displaying the received document or other source materials in the user interface;
receiving, as input, a selected request for information from among the plurality of requests for information;
displaying, in the user interface, one or more automatically selected recommended responses to the selected request for information, and displaying, in the user interface, one or more other selectable potential responses;
based on the selected request for information, automatically generating a text string response to the selected request for information by an artificial intelligence and machine learning (AI and ML) engine that has been trained by analyzing a plurality of sets of historical documents with requests for information and corresponding response documents with responses to the requests for information, wherein the historical documents include a subpoena, an interrogatory, a demand letter, or a complaint for a legal proceeding; and
displaying the text string response in the user interface, wherein the text string response is modifiable by user input.

4. A document response production method, the method comprising:
receiving, as input, a digital file of a document with a plurality of requests for information, wherein each request for information is a text string, and the document is a subpoena, an interrogatory, a demand letter, or a complaint for a legal proceeding;
performing data preparation on the document;
processing the document with the performed data preparation with an AI and ML engine by breaking down a request for information of the plurality of requests for information into tokens in which each token is a word, wherein the AI and ML engine has been trained by analyzing a plurality of sets of historical documents with requests for information and corresponding response documents with responses to the requests for information, wherein the historical documents include a subpoena, an interrogatory, a demand letter, or a complaint for a legal proceeding;
analyzing, by the AI and ML engine, the request for information from the document by applying both a Deep Learning Transformer Based Model and at least one Feature-Based Dimension Machine Learning process;
generating a similarity score for similarity of the request for information from the document to a request for information in the plurality of historical documents based on the analyzing; and
producing a suggested response to the request for information based on ranked order of similarity scores.

5. The document response production method of claim 4, wherein the Deep Learning Transformer Based Model that is applied uses one or more of Bidirectional Encoder Representations from Transformers (BERT), ROBERTa, word embeddings, and Word Movers Distance (WMD).

6. The document response production method of claim 4, wherein the Feature-Based Dimension Machine Learning process includes one or more of clustering, a k-nearest neighbors (KNN) algorithm, agglomerative clustering, a support vector machine (SVM) method, logistic regression, Naive Bayes, decision trees, conditional random fields (CRF), and bi-directional long-short term memory (Bi-LSTM).

7. The document response production method of claim 4, wherein the training of the AI and ML engine includes:
receiving the plurality of historical documents with requests for information and the corresponding response documents with the responses to the requests for information;
sorting the plurality of historical documents with requests for information and the corresponding response documents with the responses to the requests for information by document type;
removing stop words from the plurality of historical documents with requests for information and the corresponding response documents with the responses to the requests for information by document type;
replacing Named Entity Recognition (NER) terms or words in the plurality of historical documents with requests for information and the corresponding response documents with the responses to the requests for information by document type; and
performing active learning by a user to backpropagate data regarding the plurality of historical documents with requests for information and sorting the corresponding response documents with the user's responses to the requests for information by document type.

8. The document response production method of claim 4, wherein a semantic Deep Learning Transformer Based Model similarity score is generated for the Deep Learning Transformer Based Model and a Feature-Based Dimension Machine Learning process similarity score is generated for the Feature-Based Dimension Machine Learning process.

9. The document response production method of claim 8, wherein the similarity score is based on the semantic Deep Learning Transformer Based Model similarity score and the Feature-Based Dimension Machine Learning process similarity score.

10. A non-transitory computer-readable storage medium storing thereon executable instructions which when executed by processing circuitry causes the processing circuitry to perform a document response production method, the document response production method comprising:
receiving, as input, a digital file of a document with a plurality of requests for information, wherein each request for information is a text string, and the document is a subpoena, an interrogatory, a demand letter, or a complaint for a legal proceeding;
performing data preparation on the document;
processing the document with the performed data preparation with an AI and ML engine by breaking down a request for information of the plurality of requests for information into tokens in which each token is a word, wherein the AI and ML engine has been trained by analyzing a plurality of sets of historical documents with requests for information and corresponding response documents with responses to the requests for information, wherein the historical documents include a subpoena, an interrogatory, a demand letter, or a complaint for a legal proceeding;
analyzing, by the AI and ML engine, the request for information from the document by applying both a semantic Deep Learning Transformer Based Model and a Feature-Based Dimension Machine Learning process;
generating a similarity score for similarity of the request for information from the document to a request for information in the plurality of historical documents based on the analyzing; and
producing a suggested response to the request for information based on ranked order of similarity scores.

11. A system for performing response production to the requests in a document, comprising:
processing circuitry; and
a non-transitory computer-readable storage medium storing thereon executable instructions which when executed by the processing circuitry causes the processing circuitry to:
receive, as input, a digital file of the document with a plurality of requests for information, wherein each request for information is a text string, and the document is a subpoena, an interrogatory, a demand letter, or a complaint for a legal proceeding;
perform data preparation on the document;
process the document with the performed data preparation with an AI and ML engine by breaking down a request for information of the plurality of requests for information into tokens in which each token is a word, wherein the AI and ML engine has been trained by analyzing a plurality of sets of historical documents with requests for information and corresponding response documents with responses to the requests for information, wherein the historical documents include a subpoena, an interrogatory, a demand letter, or a complaint for a legal proceeding;
analyze, by the AI and ML engine, the request for information from the document by applying both a semantic Deep Learning Transformer Based Model and a Feature-Based Dimension Machine Learning process;
generate a similarity score for similarity of the request for information from the document to a request for information in the plurality of historical documents based on the analyzing; and
suggest or produce a suggested response to the request for information based on ranked order of similarity scores.

12. The non-transitory computer-readable storage medium of claim 3, wherein the one or more automatically selected recommended responses are determined by the AI and ML engine.

13. The document response production method of claim 4, wherein the training of the AI and ML engine includes:
receiving the plurality of historical documents with requests for information and the corresponding response documents with the responses to the requests for information;
sorting the plurality of historical documents with requests for information and the corresponding response documents with the responses to the requests for information by document type;
removing stop words from the plurality of historical documents with requests for information and the corresponding response documents with the responses to the requests for information by document type; and
replacing Named Entity Recognition (NER) terms or words in the plurality of historical documents with requests for information and the corresponding response documents with the responses to the requests for information by document type.

14. The document response production method of claim 4, wherein the training of the AI and ML engine includes:
receiving the plurality of historical documents with requests for information and the corresponding response documents with the responses to the requests for information;
sorting the plurality of historical documents with requests for information and the corresponding response documents with the responses to the requests for information by document type; and
removing stop words from the plurality of historical documents with requests for information and the corresponding response documents with the responses to the requests for information by document type.

15. The document response production method of claim 4, wherein the Deep Learning Transformer Based Model that is applied uses one or more of Bidirectional Encoder Representations from Transformers (BERT), ROBERTa, and word embeddings.

16. The document response production method of claim 4, wherein the Deep Learning Transformer Based Model that is applied uses one or more of Bidirectional Encoder Representations from Transformers (BERT) and ROBERTa.
